(19) United States
(12) Patent Application Publication
(10) Pub. No.: US 2026/0257189 A1
(43) Pub. Date: Sep. 3, 2026

(54) SURFACE PLASMON RESONANCE CATALYST AND CHEMICAL REACTION SYSTEM

(71) Applicant: Modern Value Inc., Seongnam-si (KR)

(72) Inventors: Kyonghoon LEE, New York, NY (US); Hae Rim LEE, Seoul (KR); Sung Ju CHOI, Yongin-si (KR); Ji Hun WOO, Seongnam-si (KR)

(21) Appl. No.: 19/441,627

(22) Filed: Jan. 6, 2026

Related U.S. Application Data
(63) Continuation-in-part of application No. PCT/US24/43772, filed on Aug. 23, 2024.
(60) Provisional application No. 63/534,721, filed on Aug. 25, 2023.

(51) Int. Cl. B01J 19/12; B01J 19/24; B01J 21/08; B01J 31/22; B01J 35/30; B01J 35/39; B01J 35/50; C01B 3/047

(52) U.S. Cl. CPC B01J 19/122; B01J 19/2415; B01J 21/08; B01J 31/226; B01J 35/39; B01J 35/393; B01J 35/50; C01B 3/047; B01J 2219/0875; B01J 2219/0892; B01J 2231/005; B01J 2531/004; B01J 2531/18

(57) ABSTRACT

This discloses a surfaced plasmon resonance catalyst device and a chemical reaction system using the catalyst device. The catalyst device includes metal nanoparticles formed over a supporting body with ligands that are interposed between the supporting body and many of the metal nanoparticles. Many of the ligands are bonded to a surface of the supporting body on one hand and are also bonded to at least part of the metal nanoparticles on the other hand. One chemical reaction system includes a flow reactor that accommodates the catalyst device for use in ammonia cracking.

### INCORPORATION BY REFERENCE TO ANY PRIORITY APPLICATIONS

Any and each application to which a priority claim is made in the Application Data Sheet is hereby incorporated by reference in its entirety.

### BACKGROUND

The present disclosure relates to a catalyst device using metal nanoparticles for chemical reactions and a chemical reaction system using the catalyst device.

### SUMMARY

### Flow Chemical Reaction System

One aspect of the disclosure provides a flow chemical reaction system comprising: a flow reactor comprising an elongated tube with an upstream end and a downstream end; a reactant supply operably connected to the flow reactor and configured to supply ammonia gas into the elongated tube to flow inside the elongated tube in a flow direction from the upstream end toward the downstream end; and glass disc catalyst devices arranged inside the elongated tube and spaced apart from each other in the flow direction, wherein at least part of the glass disc catalyst devices individually comprises a glass disc with multiple through-holes formed therein such that the gas passes through at least part of the multiple through-holes of the individual glass disc catalyst device, wherein at least part of the glass disc catalyst devices individually further comprises a metal nanoparticles bound to the glass disc thereof such that at least part of the metal nanoparticles are bound to surfaces of at least part of the multiple through-holes of the glass disc, wherein the system further comprises at least one light source configured to irradiate light beams for illuminating the at least part of the glass disc catalyst devices, and wherein the glass disc catalyst devices are arranged inside the elongated tube to allow the gas to pass through at least part of the through-holes formed therein such that the gas advances inside the elongated tube in the flow direction and passes by at least part of the metal nanoparticles that are bound to the glass discs and illuminated by at least part of the light beams, which causes surface plasmon resonance in at least part of the metal nanoparticles to facilitate ammonia cracking inside the elongated tube. The system may be further configured to allow the gas to advance in the flow direction via gaps formed between the glass disc catalyst devices and inner surfaces of the elongated tube.

### Glass Disc Catalyst Device

In the foregoing flow chemical reaction system, the glass disc catalyst devices are arranged inside the elongated tube to allow the gas to pass through at least part of the through-holes formed therein such that the gas advances inside the elongated tube in the flow direction and passes by at least part of the metal nanoparticles bound to surfaces of the through-holes of the individual glass discs. In the foregoing flow chemical reaction system, the glass disc catalyst devices are arranged inside the elongated tube to allow the gas to pass through at least part of the through-holes formed therein such that the gas advances inside the elongated tube in the flow direction and passes by at least part of the metal nanoparticles bound to surfaces of the individual glass discs that are not of the through-holes thereof.

### Multiple Glass Disc Catalyst Devices

In the foregoing flow chemical reaction system, at least part of the glass disc catalyst devices individually comprises a plurality of ligands fixed to the glass disc, wherein at least part of the metal nanoparticles is linked to the glass discs via at least part of the plurality of ligands. In the foregoing flow chemical reaction system, the glass disc has a plate-like shape comprising two generally flat surfaces facing away from each other with a thickness defined therebetween, wherein at least part of the multiple through-holes are formed in the glass disc connecting between the two generally flat surfaces, wherein the multiple through-holes comprise inner surfaces thereof other than the two generally flat surfaces, wherein at least part of the metal nanoparticles are bound to at least part of the inner surfaces such that the gas advancing inside the elongated tube to pass by at least part of the metal nanoparticles that are bound to the inner surfaces of the glass disc. In the foregoing flow chemical reaction system, the glass disc catalyst devices may be spaced apart from each other in the flow direction with at least one spacer located between adjacent ones of the glass disc catalyst devices.

### Spacers

In the foregoing flow chemical reaction system, the glass disc catalyst devices may be spaced apart from each other in the flow direction with at least one spacer located between adjacent ones of the glass disc catalyst devices. The at least one spacer comprises a transparent cylinder inserted inside the elongated tube between two adjacent ones of the glass disc catalyst devices. The at least one spacer may comprise transparent particles attached to surfaces of the glass disc that separate two adjacent ones of the glass disc catalyst devices in the flow direction. In the foregoing flow chemical reaction system, the at least one spacer on each glass disc catalyst device may be vertically aligned such that the gas flows in the flow direction through the multiple through-holes form on each glass disc without interruption.

### Light Beams

In the foregoing flow chemical reaction system, the reactant supply is connected to the upstream end of the flow reactor with an airtight adaptor or gasket, and the at least one light source comprises at least one first light source connected to the upstream end of the flow reactor with a transparent airtight seal through which the light beams are transmitted toward the upstream end. In the foregoing flow chemical reaction system, the at least one light source may further comprise at least one second light source located outside the elongated tube for sending light beams into the flow reactor through a wall of the elongated tube such that the light beam is directed to each glass disc catalyst device with the metal nanoparticles. In the foregoing flow chemical reaction system, the system may be configured to perform a chemical reaction of decomposition of ammonia (NH₃) for producing hydrogen (H₂)

### First and Second Flow Reactors

In the foregoing flow chemical reaction system, the flow reactor is referred to as a first flow reactor, the upstream end is referred to as a first upstream end, the downstream end is referred to as a first downstream end, the at least one light source is referred to as a first light source, the flow direction is referred to as a first flow direction, the at least one catalyst device is referred to as a first catalyst device. The system may further comprise: a second flow reactor comprising a second upstream end and a second downstream end; at least one catalyst device comprising a glass disc, a plurality of ligands, and a plurality of metal nanoparticles in the second flow reactor, wherein at least part of the metal nanoparticles may be linked to the glass disc via at least part of the ligands; a connecting adaptor connecting between the first downstream end and the second upstream end to form a fluid communication between the first flow reactor and the second flow reactor such that at least part of the reactant reaching the first downstream end may flow into the second flow reactor through the second upstream end; and a second light source configured to send light beams for illuminating the at least one catalyst device installed inside the second flow reactor; wherein the at least one catalyst device may be installed inside the second flow reactor such that the at least part of the reactant may contact the at least one catalyst device while flowing inside the second flow reactor.

### Ligands

In the foregoing flow chemical reaction system, the plurality of ligands may comprise a first ligand, a second ligand, and a third ligand, wherein the first ligand may comprise a first backbone, a first metal-bonding end connected to the first backbone, and a first other end connected to the first backbone, wherein the second ligand may comprise a second backbone, a second metal-bonding end connected to the second backbone, and a second other end connected to the second backbone, wherein the third ligand may comprise a third backbone, a third metal-bonding end connected to the third backbone, and a third other end connected to the third backbone, wherein the plurality of metal nanoparticles may comprise a first metal nanoparticle, a second metal nanoparticle, and a third metal nanoparticle, and wherein the first metal-bonding end of the first ligand may be bonded to the first metal nanoparticle, and wherein the first other end of the first ligand may be bonded to the glass disc. The second metal-bonding end of the second ligand may be bonded to the second metal nanoparticle and the second other end of the second ligand may be bonded to the glass disc such that the second metal nanoparticle may be linked to the glass disc via the second ligand, wherein the first ligand and the second ligand may be an identical chemical entity.

### Metal Nanoparticles

In the foregoing flow chemical reaction system, the at least part of the metal nanoparticles may form an interconnected network of metal nanoparticles via at least part of the ligands, wherein at least one metal nanoparticle of the interconnected network may be bonded to the glass disc via at least part of the ligands. The interconnected network may extend horizontally along a surface of the glass disc and also vertically from the surface of the glass disc. The second metal-bonding end of the second ligand may be bonded to the first metal nanoparticle, and the second other end of the second ligand may be bonded to the second metal nanoparticle such that the second metal nanoparticle may be linked to the first metal nanoparticle via the second ligand, wherein the first and second ligands may be an identical chemical entity or different chemical entities. The third metal-bonding end of the third ligand may be bonded to the second metal nanoparticle, and the third other end of the third ligand may be bonded to the third metal nanoparticle such that the third metal nanoparticle may be connected to the glass disc, wherein the first and third ligands may be an identical chemical entity or different chemical entities. The second metal-bonding end of the second ligand may be bonded to the first metal nanoparticle, wherein the third metal-bonding end of the third ligand may be bonded to the second metal nanoparticle, wherein the second other end of the second ligand and the third other end of the third ligand may form a bonding or interact therebetween such that the first and second metal nanoparticles may be interconnected via the second and third ligands, wherein the first and second ligands may be an identical chemical entity or different chemical entities, wherein the second and third ligands may be an identical chemical entity or different chemical entities. The metal nanoparticles may have an average diameter ranging between about 50 nm and about 100 nm.

### Running Chemical Reaction

One aspect of the disclosure provides a method of running a chemical reaction comprising providing the foregoing flow chemical reaction system; supplying ammonia (NH₃) gas from the reactant supply into the flow reactor through the upstream end such that the ammonia gas may flow inside the flow reactor in the flow direction from the upstream end toward the downstream end; and sending light beams from the light source into the flow reactor such that the light beams may illuminate the at least one catalyst device inside the flow reactor, wherein illuminating at least one catalyst devices may cause surface plasmon resonance with at least part of the metal nanoparticles, which may facilitate decomposing ammonia molecules for production of hydrogen (H₂). The foregoing method may further comprise heating the flow reactor for running the chemical reaction within a temperature range from about 200° and about 500°.

### Another Flow Chemical Reaction System

One aspect of the disclosure provides a flow chemical reaction system comprising: a flow reactor comprising an upstream end and a downstream end; a reactant supply operably connected to the flow reactor and configured to supply at least one reactant into the flow reactor and to flow inside the flow reactor in a flow direction from the upstream end toward the downstream end; and at least one catalyst device comprising a glass body, a plurality of ligands, and a plurality of metal nanoparticles, wherein at least part of the metal nanoparticles may be linked to the glass body via at least part of the ligands; at least one light source configured to send light beams for illuminating the at least one catalyst device installed inside the flow reactor, wherein the at least one catalyst device may be installed inside the flow reactor such that the reactant may contact the at least one catalyst device while flowing inside the flow reactor along the flow direction and further such that at least part of the light beams reaching the at least one catalyst device may cause surface plasmon resonance in at least part of the metal nanoparticles, which may facilitate a chemical reaction of the at least one reactant flowing inside the flow reactor, wherein the glass body may comprise a glass disc with a first surface, a second surface facing away from the first surface, and a plurality of through holes formed through a thickness of the glass disc defined between the first surface and the second surface, wherein the glass disc may further comprise inner surfaces defining the through holes, wherein at least part of the metal nanoparticles may be linked to at least part of the first surface, the second surface and the inner surfaces via the at least part of the ligands, wherein the flow reactor may comprise an elongated tube extending between the upstream end and the downstream end, wherein the at least one catalyst device may comprise a plurality of catalyst devices each comprising the glass disc, wherein the plurality of glass discs may be arranged inside the elongated tube such that adjacent ones of the plurality of glass discs may be spaced from each other along the flow direction with at least one spacer interposed therebetween.

### Catalyst Device

One aspect of the disclosure provides a catalyst device comprising: a plurality of glass beads with an average diameter within a range from about 100 μm to about 1000 μm; a plurality of ligands; a plurality of metal nanoparticles bound to at least part of the glass beads via at least part of the ligands; wherein a first one of the ligands comprises a first backbone, a first metal-bonding end connected to the first backbone, and a first other end connected to the first backbone, wherein a second one of the ligands comprises a second backbone, a second metal-bonding end connected to the second backbone, and a second other end connected to the second backbone, wherein a third one of the ligands comprises a third backbone, a third metal-bonding end connected to the third backbone, and a third other end connected to the third backbone; and wherein the first metal-bonding end of the first ligand may be bonded to a first one of the metal nanoparticles and the first other end of the first ligand may be bonded to a first one of the glass beads such that the first metal nanoparticle is linked to the first glass bead via the first ligand.

### Metal Nanoparticles

In the foregoing catalyst device, the metal nanoparticles may have an average diameter ranging between about 50 nm and about 100 nm. Many or substantially all of the metal nanoparticles may have a diameter smaller than about 100 nm. The metal nanoparticles may contain at least one metal selected from the group consisting of old (Au), silver (Ag), platinum (Pt), copper (Cu), aluminum (Al), magnesium (Mg), rhodium (Rh), palladium (Pd), cobalt (Co), nickel (Ni), and alloys containing at least one of the foregoing metals. At least part of the metal nanoparticles may be decorated with one or more metal deposits on their surfaces. The metal deposits do not form an alloy with the metal nanoparticle surfaces. The metal deposits may comprise at least one selected from the group consisting of ruthenium (Ru), iron (Fe), nickel (Ni), cobalt (Co), platinum (Pt), rhodium (Rh), rhenium (Re), palladium (Pd), iridium (Ir), indium (In), osmium (Os), titanium (Ti), vanadium (V), and an alloy of any of the foregoing.

### Layer of Metal Nanoparticles

In the foregoing catalyst device, at least part of the metal nanoparticles may form a layer of metal nanoparticles over the first glass bead. The second metal-bonding end of the second ligand may be bonded to a second one of the metal nanoparticles and the second other end of the second ligand may be bonded to the first glass bead such that the second metal nanoparticle may be linked to the first glass bead via the second ligand. The first ligand and the second ligand may be an identical chemical entity.

### Interconnected Network of Metal Nanoparticles

In the foregoing catalyst device, at least part of the metal nanoparticles may form an interconnected network of metal nanoparticles via at least part of the ligands. At least one metal nanoparticles of the interconnected network may be bonded to the first glass bead via at least part of the ligands. The interconnected network may extend horizontally along a surface of the first glass bead and also vertically from the surface of the first glass bead. The interconnected network of metal nanoparticles may cover via at least part of the ligands, in which at least part of the interconnected networks extends horizontally along a surface of the first glass bead and also vertically from the surface of the first glass bead.

### Ligands

In the foregoing devices, the second metal-bonding end of the second ligand may be bonded to the first metal nanoparticle, and the second other end of the second ligand may be bonded to a second one of the metal nanoparticles such that the second metal nanoparticle may be linked to the first metal nanoparticle via the second ligand. The first and second ligands may be an identical chemical entity or different chemical entities. The third metal-bonding end of the third ligand may be bonded to the second metal nanoparticle, and the third other end of the third ligand may be bonded to a third one of the metal nanoparticles such that the third metal nanoparticle may be connected to the first glass bead, wherein the first and third ligands may be an identical chemical entity or different chemical entities. The second metal-bonding end of the second ligand may be bonded to the first metal nanoparticle, wherein the third metal-bonding end of the third ligand may be bonded to a second one of the metal nanoparticles. The second other end of the second ligand and the third other end of the third ligand may form a bonding or interact therebetween such that the first and second metal nanoparticles may be interconnected by the second and third ligands. The first and second ligands may be an identical chemical entity or different chemical entities. The second and third ligands may be an identical chemical entity or different chemical entities. In the foregoing catalyst device, at least part of the ligands originates from at least one compound selected from the group consisting of the compounds listed in Table 2 of this disclosure.

### Flow Reaction System

One aspect of the disclosure provides a flow chemical reaction system comprising one or more of: a form of the foregoing catalyst device described above; a flow reactor comprising an upstream end and a downstream end; a reactant supply operably connected to the flow reactor for supplying at least one reactant into the flow reactor to flow inside the flow reactor in a flow direction from the upstream end toward the downstream end; and at least one light source configured to send light beams into the flow reactor. The at least one catalyst device may be installed inside the flow reactor for contacting the at least one reactant flowing along the flow direction. Illuminating the at least one of catalyst device with at least part of the light beams may cause surface plasmon resonance in at least part of the metal nanoparticles, which facilitates a chemical reaction of the at least one reactant flowing inside the flow reactor along the flow direction. In the foregoing flow chemical reaction system, the flow reactor may comprise an elongated tube extending between the upstream end and the downstream end. The reactant supply may be connected to the upstream end of the flow reactor with an airtight adaptor or gasket. The at least one light source may comprise at least one first light source connected to the upstream end of the flow reactor with a transparent airtight seal through which the light beams are transmitted toward the upstream end. In the foregoing flow chemical reaction system, the at least one light source may further comprise at least one second light source located outside the flow reactor for sending light beams into the flow reactor through a wall of the flow reactor. The foregoing flow chemical reaction system may further comprise at least one heat source for applying heat to the flow reactor. The chemical reaction may comprise decomposition of ammonia (NH₃) for producing hydrogen (H₂).

### Multiple Flow Reactors

In the foregoing flow chemical reaction system, the flow reactor may be referred to as a first flow reactor, the upstream end may be referred to as a first upstream end, the downstream end may be referred to as a first downstream end, the at least one light source may be referred to as a first light source, the flow direction may be referred to as a first flow direction, the at least one catalyst device may be referred to as a first catalyst device. The system further comprises one or more of: a second flow reactor comprising a second upstream end and a second downstream end; a connecting adaptor connecting between the first downstream end and the second upstream end to form a fluid communication between the first flow reactor and the second flow reactor such that the at least one reactant reaching the first downstream end flows into the second flow reactor through the second upstream end; a second light source configured to send light beams into the second flow reactor; and at least one catalyst device installed inside the second flow reactor to be contacted by the at least one reactant flowing into the second flow reactor.

In the foregoing flow chemical reaction system, the at least one reactant may comprise ammonia.

### Running Chemical Reaction

One aspect of the disclosure provides a method of running a chemical reaction in a flow chemical reaction system. The method may comprise one or more of: providing a form of the foregoing flow chemical reaction systems describe above; supplying ammonia (NH₃) gas from the reactant supply into the flow reactor through the upstream end such that the ammonia gas flows inside the flow reactor in the flow direction from the upstream end toward the downstream end; and sending light beams from the light source into the flow reactor such that the light beams illuminate the at least one catalyst device inside the flow reactor. Illuminating at least one catalyst devices may cause surface plasmon resonance with at least part of the metal nanoparticles, which facilitates decomposing ammonia molecules for production of hydrogen (H₂). The foregoing method may further comprise heating the flow reactor for running the chemical reaction within a temperature range from about 200° and about 500°. The foregoing method may further comprise heating the flow reactor for running the chemical reaction within a temperature range from about 400° and about 800°.

### Making Catalyst Device

One aspect of the disclosure provides a method of making the foregoing catalyst device described above. The method may comprises one or more of: providing a liquid composition comprising the ligands; providing metal nanoparticles; providing glass bead with an average diameter within a range from about 100 μm to about 1000 μm; and blending the metal nanoparticles, glass beads and the liquid composition to cause at least part of the ligands to contact at least part of the metal nanoparticles and at least part of the glass beads, which forms interconnected networks of metal nanoparticles connected to at least part of the glass beads.

### BRIEF DESCRIPTION OF THE DRAWINGS

This present disclosure contains at least one drawing in color or photographic image.

FIGS. 1A-1E conceptually illustrates metal nanoparticles formed over a substrate via ligands according to various embodiments.

FIG. 2A conceptually illustrates a core-shell configuration of a metal nanoparticle according to an embodiment.

FIG. 2B conceptually illustrates a metal-decorated metal nanoparticle according to an embodiment.

FIGS. 3A and 3B conceptually illustrate connection between two metal nanoparticles via ligands, according to an embodiment.

FIG. 3C illustrates an example connection of FIG. 3B according to an embodiment.

FIGS. 4A-4B illustrate ligands bonding to metal nanoparticles and substrate according to various embodiments.

FIG. 4E is a photograph taken from above nanoparticles viewing in a direction toward the substrate, i.e., the substrate underlies the nanoparticles according to an embodiment.

FIGS. 5A and 5B conceptually illustrates LSPR electric field generated by metal nanoparticles according to embodiments.

FIG. 6A is a flowchart for bonding metal nanoparticles to ligands formed over a substrate according to an embodiment.

FIG. 6B illustrates a process of forming metal nanoparticles over a substrate according to an embodiment.

FIG. 6C illustrates a process of forming a layer of metal nanoparticles on water according to an embodiment.

FIG. 7A is a flowchart for bonding metal nanoparticles to ligands formed over a substrate according to an embodiment.

FIG. 7B illustrates a process of forming metal nanoparticles with ligands over a substrate according to an embodiment.

FIG. 8A is a photograph of multiple glass fiber filters.

FIG. 8B is a microscopic view of the interior of one of the glass fiber filters of FIG. 8A according to an embodiment.

FIG. 8C conceptually illustrates metal nanoparticles formed over glass fiber circumferences inside a glass fiber filter according to an embodiment.

FIGS. 8D and 8E are photographs of metal nanoparticles formed over glass fiber circumferences according to embodiments.

FIGS. 9A and 9B are photographs of glass bead catalysts in which metal nanoparticles are formed in some portions of the bead surfaces according to an embodiment.

FIGS. 10A-10C conceptually illustrates glass beads according to an embodiment.

FIGS. 11A and 11B are photographs during the synthesis of glass bead catalysts according to an embodiment.

FIGS. 12A and 12B are photographs of glass rod catalysts according to an embodiment.

FIGS. 13A and 13B are photographs of glass chip catalysts according to an embodiment.

FIG. 14 illustrates a flow reaction system with a cross-sectional view of a single flow reactor according to an embodiment.

FIG. 15 illustrates a flow reaction system with multiple flow reactors according to an embodiment.

FIG. 16A illustrates a cross-sectional view of a glass rod catalyst device including a single glass rod catalyst according to an embodiment.

FIGS. 16B and 16C illustrate cross-sectional views of a flow reactor including the glass rod catalyst device of FIG. 16A.

FIG. 16D illustrates a cross-sectional view of a glass rod device including a single glass rod catalyst according to another embodiment.

FIG. 16E illustrates a cross-sectional view of a glass rod device including a single glass rod catalyst according to still another embodiment.

FIG. 17A illustrates a cross-sectional view of a glass rod catalyst device including a plurality of glass rod catalysts according to an embodiment.

FIGS. 17B and 17C illustrate cross-sectional views of a flow reactor including the glass rod catalyst device of FIG. 17A.

FIG. 18A illustrates a cross-sectional view of a glass rod catalyst device including multiple glass rod catalysts and uncoated glass rods according to an embodiment.

FIGS. 18B and 18C illustrate cross-sectional views of a flow reactor including the glass rod catalyst device of FIG. 18A.

FIG. 19A illustrates a cross-sectional view of a glass bead catalyst device including a container containing a number of glass bead catalysts according to an embodiment.

FIGS. 19B and 19C illustrate cross-sectional views of a flow reactor including the glass bead catalyst device of FIG. 19A.

FIG. 20 illustrates a cross-sectional view of a flow reactor with two opposing covers to keep a number of glass bead catalysts therebetween according to another embodiment.

FIGS. 21A and 21B illustrate cross-sectional views of a flow reactor in which a plurality of glass fiber filter catalyst devices installed inside the flow reactor according to an embodiment.

FIG. 22 illustrates a flow reaction system with a cleaning fluid supply and a cleaning fluid collector according to an embodiment.

FIG. 23 illustrates a liquid phase chemical reaction system according to an embodiment. Figure according to an embodiment.

FIG. 24 conceptually illustrates metal nanoparticles formed on a glass rod that generates a large LSPR energy with constructive interference of electric LSPR fields according to an embodiment.

FIGS. 25A-25F are photographs of metal nanoparticles formed over a glass surface according to embodiments.

FIG. 26 illustrates a liquid phase reaction system for ammonia borane decomposition and hydrogen measurement according to an embodiment.

FIG. 27A shows a reaction vessel, a glass chip catalyst device and a cover for the reaction vessel with an opening for the glass chip catalyst device according to an embodiment.

FIG. 27B shows a reaction vessel, a glass rod catalyst device and a cover for the reaction vessel with an opening for the glass rod catalyst device according to an embodiment.

FIGS. 28-34 show SEM photographs from Examples 9.1-9.7.

FIGS. 35A and 35B are hole-treated glass chip catalyst supports according to embodiments.

FIG. 35C is a mesh type glass chip catalyst support according to embodiments

FIGS. 36A and 36B illustrate side views of surface-treated glass surfaces according to an embodiment.

FIGS. 36C and 36D illustrate top views of various surface-treated glass surfaces.

FIG. 37A illustrates a flow reactor in which surface-treated glass catalyst devices installed inside the flow reactor according to an embodiment.

FIG. 37B illustrates a cross-sectional view of a flow reactor in which surface-treated glass catalyst devices installed inside the flow reactor according to an embodiment.

FIGS. 38A and 38B illustrate oxide layers formed on a metal nanoparticle according to an embodiment.

### DETAILED DESCRIPTION OF EMBODIMENTS

Various aspects of the subject matter now will be described and discussed in more detail in terms of some specific embodiments and examples with reference to the accompanying drawings, in which some, but not all embodiments of the invention are shown. Like numbers refer to like elements or parts throughout. The presently disclosed subject matter may be embodied in many different forms and should not be construed as limited to the specific embodiments set forth herein. Rather, these embodiments are provided so that this disclosure will satisfy applicable legal requirements. Indeed, many modifications and other embodiments of the presently disclosed subject matter will come to the mind of one skilled in the art to which the presently disclosed subject matter pertains. Therefore, it is to be understood that the presently disclosed subject matter is not to be limited to the specific embodiments disclosed and that modifications and other embodiments are intended to be included within the scope of the appended claims.

### Localized Surface Plasmon Resonance for Chemical Reaction

### Surface Plasmon Effect

Surface plasmon effect (SPE) is a phenomenon that occurs when an electromagnetic wave interacts with a metal surface. The electromagnetic wave causes the conduction electrons in the metal to oscillate in a coherent manner, creating a surface plasmon. When the frequency of the incident light matches the frequency of the electron oscillations, a phenomenon called surface plasmon resonance (SPR) occurs. This causes the metal to absorb more light.

### Localized Surface Plasmon Resonance

Localized surface plasmon resonance (LSPR) occurs when the metal surface is in the form of a nanoparticle. When the size of the nanoparticle is comparable to the wavelength of the electromagnetic wave, the surface plasmon is localized to the surface of the metal nanoparticle. The resonance is more pronounced in smaller nanoparticles because the conduction electrons are closer together in smaller nanoparticles.

### Electric Field of Surface Plasmon

The surface plasmon in LSPR is a charge density wave that propagates along the surface of the metal nanoparticle. It is characterized by enhanced electric field, a wavelength of which is much shorter than the wavelength of the incident electromagnetic wave. The electric field of the surface plasmon is confined to the metal surface. It is very strong at the surface, but it decays rapidly away from the surface.

### Facilitating Chemical Reactions

LSPR can facilitate or catalyze chemical reactions. The enhanced electric field of LSPR can reduce activation energy of chemical reactions. The activation energy of a chemical reaction is the minimum amount of energy that the reactant(s) need to have to proceed with the reaction. If the activation energy is too high, the reaction will not occur. However, if the activation energy is reduced, the reaction will be more likely to occur. The electric field of LSPR can excite electrons in the reactant(s), which can reduce the activation energy of the reaction. The electric field of LSPR can create hot spots, which are regions where the electric field is very intense. The spots can provide even more energy to the reactant(s) for facilitate the chemical reaction.

### LSPR Catalyst

### LSPR Catalyst

One aspect of the present disclosure and its embodiments provide an LSPR catalyst including metal nanoparticles formed over a substrate. The LSPR catalyst includes a supporting body that provides and/or works as the substrate. At least part of the metal nanoparticles formed over the substrate are connected to a surface of the supporting body via ligands. The LSPR catalyst can reduce the activation energy for certain endothermic chemical reactions with the LSPR energy.

### Individual Nanoparticles Connected to Substrate

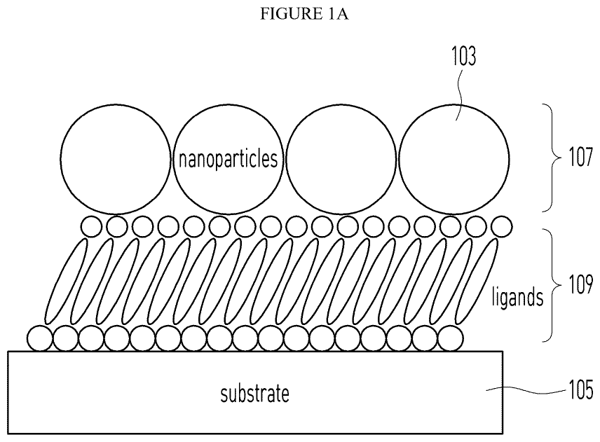

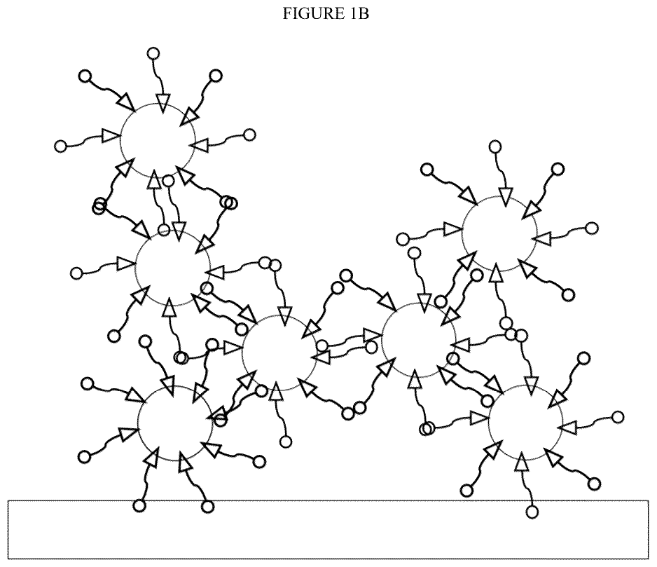

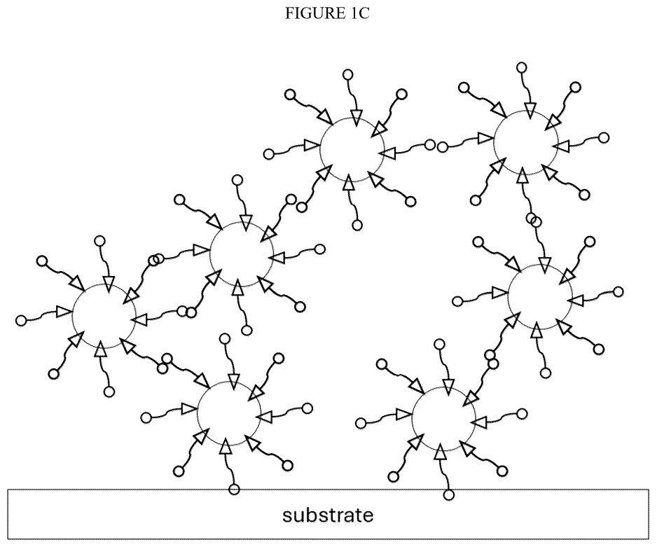

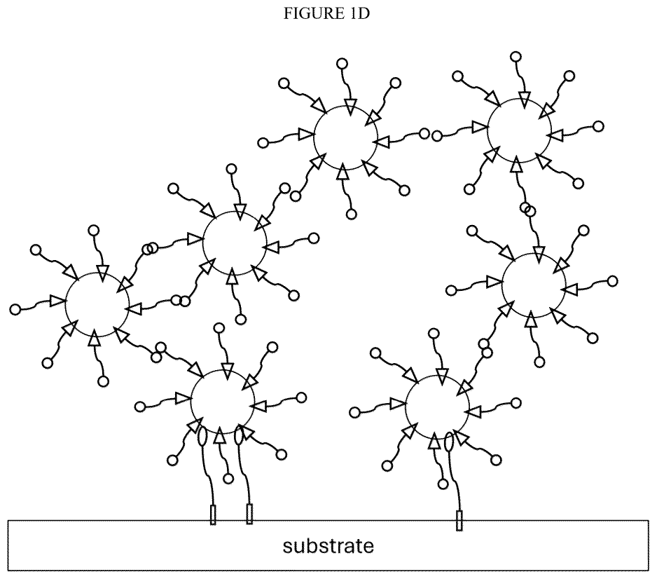

Referring to FIG. 1A, individual metal nanoparticles 103 are bound to a substrate 105 via linkers or ligands 109 that intervene and connect between the individual metal nanoparticles and the underlying surface of the substrate. In the illustration of FIG. 1A, many of the metal nanoparticles 103 contact immediately neighboring metal nanoparticles, although not limited thereto. In the illustrated embodiment, metal nanoparticles are arranged horizontally to form a layer over the substrate. Although not illustrated, some metal nanoparticles may be formed over the layer with or without ligands.

### Networked Nanoparticles Connected to Substrate

FIGS. 1B through 1E illustrate nanoparticle networks in which individual metal nanoparticles 103 are bonded or connected to other metal nanoparticles 103 via ligands. Also, some metal nanoparticles of the network are bonded or connected to the substrate 105 via ligands, by which the metal nanoparticles of the network are connected to the substrate. These nanoparticle networks extend horizontally along the substrate surface and also extend vertically from the substrate surface. As discussed below, each ligand bonds to a metal nanoparticle and may also bonds to or interact with another metal nanoparticle, other ligands connected to other metal nanoparticles, or substate surface.

### Metal Nanoparticles

### Nanoparticles—Metal

The metal nanoparticles 103 are made of or contain a metal (plasmonic metal) that is able to generate LSPR. In embodiments, the plasmonic metal is, for example, gold (Au), silver (Ag), platinum (Pt), copper (Cu), aluminum (Al), magnesium (Mg), rhodium (Rh), palladium (Pd), cobalt (Co), or nickel (Ni). These nanoparticles are referred to simply “nanoparticles,” “metal nanoparticles,” “plasmonic metal nanoparticles,” or “plasmonic nanoparticles” in this disclosure. Approximate surface plasmon resonance wavelengths for these metals are listed in the following table.

TABLE

| | |
|---|---|
| Gold | 500-600 nm |
| Silver | 350-500 nm |
| Copper | 550-650 nm |
| Aluminum | 150-400 nm |
| Platinum | 200-400 nm |
| Palladium | 200-400 nm |
| Nickel | 200-400 nm |
| Cobalt | 200-400 nm |

### Nanoparticles—Metal Alloy

The metal nanoparticles 103 for LSPR may contain an alloy containing at least one plasmonic metal. For example, the metal nanoparticles contain a gold-silver-copper alloy, a gold-silver alloy, a gold-copper alloy, a silver-copper alloy, a silver-copper-aluminum alloy, etc., although not limited thereto.

### Nanoparticles—Core-Shell

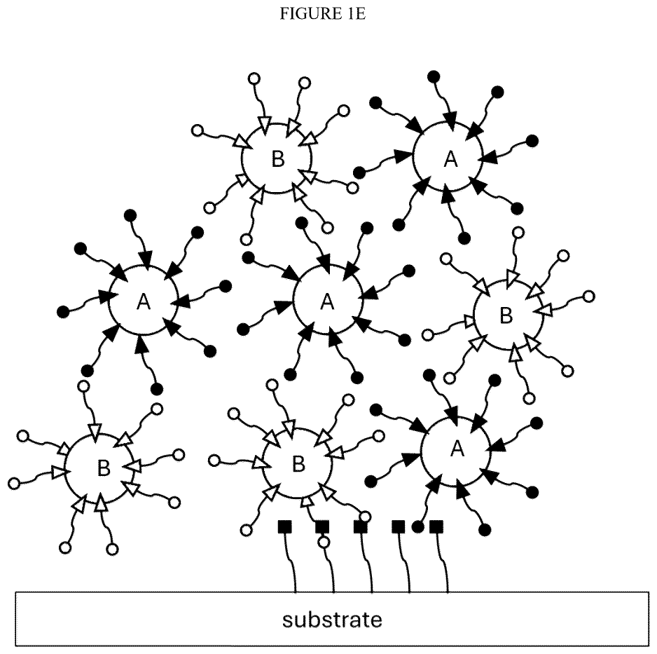

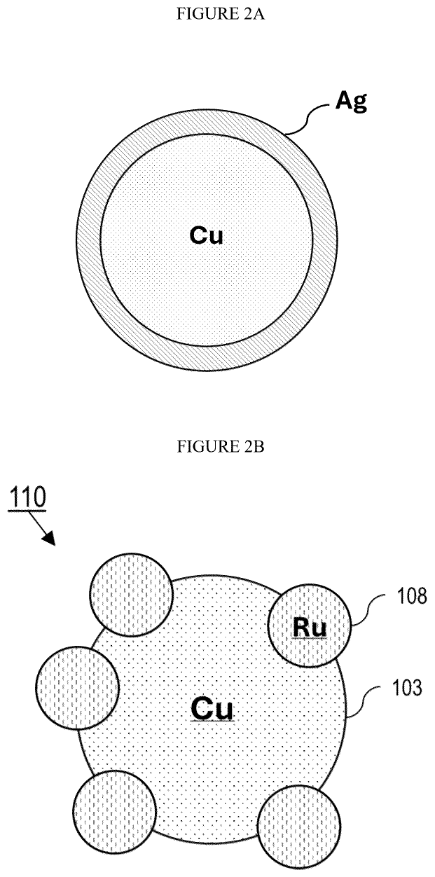

The metal nanoparticles 103 may have a core-shell configuration as illustrated in FIG. 2A. The core-shell configuration includes a core and a shell that entirely or at least in part encloses the core. In one embodiment, either or both of the core and shell are made of or contains a plasmonic metal. In another embodiment, either or both of the core and shell are made of a metal alloy containing a plasmonic metal. In another embodiment, one of the core and shell does not contain a plasmonic metal. Further in another embodiment, the core-shell configuration may include one or more additional shells (not illustrated) over the core-shell configuration of FIG. 2A.

### Nanoparticles—Metal Oxide

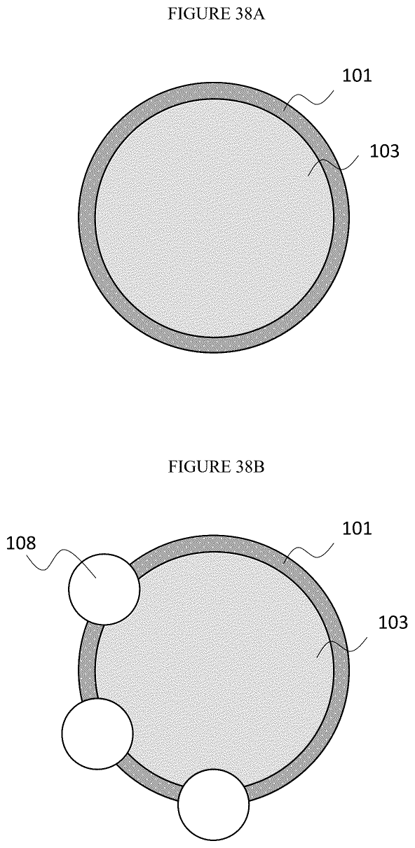

In embodiments, the nanoparticle may include metal oxides on its outer surface. The metal oxides may cover the entire surface of the metal nanoparticle or only part of the surface of metal nanoparticle. FIG. 38A illustrates another core-shell structure, in which a metal oxide layer is formed on the outer surface of a metal nanoparticle. For the sake of convenience, the present disclosure may refer to those with or without a metal oxide layer simply as “metal nanoparticles” or “nanoparticles.” For the sake of convenience, the core-shell structure or core-shell nanoparticle refers to a nanoparticle with a metal layer (FIG. 2A) and/or a metal oxide layer (FIG. 38A) regardless of whether the metal or metal oxide layer covers the entire surface of the metal nanoparticle. The nanoparticles including a metal oxide layer may be applicable to any embodiments together with or in replacement of other nanoparticles that does not include a metal oxide layer.

### Metal Oxide Layer by Oxidation of Nanoparticle Surface

The metal oxide layer may be formed when the outer surface of the nanoparticles contact or are exposed to air or other oxidative material(s), whether the nanoparticles are made of metal, metal alloy or in the core-shell configuration. When freshly prepared Cu nanoparticles are exposed to oxygen (air) or oxidizing agents, oxygen molecules adsorb on the metal surface. A metal oxide shell forms spontaneously on a metal nanoparticle when it is exposed to air, moisture, or mild oxidizing conditions. The extent of metal oxides may vary depending on the metal material forming the outer surface and also the extent of its exposure to the air or other oxidative material(s).

### Metal Oxide Layer Deliberately Formed Over Nanoparticle Surface

In certain embodiments, a metal oxide layer may be affirmatively formed on a metal nanoparticle rather than by oxidation of metal nanoparticle surface. The resulting nanoparticle has a core-shell structure as illustrated in FIG. 38A. The metal oxide to form this core-shell structure is at least one selected from the group consisting of Al₂O₃, CeO₂, SiO₂, ZrO₂, TiO₂, Ti(O—R)₄, and Zr(O—R)₄, in which R is an C1-C5, substituted or unsubstituted, liner or branched alkyl. Here, the metal of the metal oxide layer may differ from the metal of the nanoparticle surface although not limited thereto. For example, the core-shell metal nanoparticle may include an SiO₂ layer on a gold nanoparticle core or a copper nanoparticle core. In some embodiments, the core-shell metal nanoparticle may include two or more oxide layers over the metal nanoparticle core. For example, the core-shell metal nanoparticle may include an Al₂O₃ layer formed over the SiO₂ layer that is formed over the gold nanoparticle core.

### Forming Metal Oxide Layer Over Nanoparticle Surface

There are various techniques to form a metal oxide layer over metal nanoparticles. It is well known to form an oxide shell layer of Al₂O₃, CeO₂, SiO₂, ZrO₂, TiO₂, Ti(O—R)₄, and Zr(O—R)₄, on or over metal nanoparticles. For examples, a SiO₂ shell layer may be formed on a metal nanoparticle core using Stoeber's method which involves mixing metal nanoparticles with tetraethoxyorthosilicate (TEOS) or sodiumorthosilicate (SOS) to form an SiO₂ layer on the metal nanoparticle surfaces. For example, an Al₂O₃ shell layer may be formed on a metal nanoparticle core primed with polyvinylpyrrolidone (PVP) by a sol-gel method using aluminum isopropoxide (AIP).

### Thickness of Metal Nanoparticles

The metal oxide layer of the core-shell nanoparticle (FIG. 38A) has a thickness about 1.0, 1.2, 1.4, 1.6, 1.8, 2.0, 2.2, 2.4, 2.6, 2.8, 3.0, 3.2, 3.4, 3.6, 3.8, 4.0, 4.2, 4.4, 4.6, 4.8, 5.0, 5.5, 6.0, 6.5, 7.0, 7.5, 8.0, 8.5, 9.0, 9.5, 10.0, 11.0, 12.0, 13.0, 14.0, 15.0, 16.0, 17.0, 18.0, 19.0, or 20.0 nm. In embodiments, the thickness may be within a range formed by any two numbers listed in the immediately previous sentence. For example, the thickness is between about 2 nm and about 2.5 nm, between about 3.1 nm and about 3.6 nm, between about 4.2 nm and about 4.7 nm, between about 1.5 nm and about 5.0 nm, between about 4.4 nm and about 18.0 nm, etc.

### Nanoparticles—Shape

The metal nanoparticles 103 for LSPR are generally round, circular, spherical or spheroidal, although not limited thereto. In terms of their shapes, the metal nanoparticles are generally homogenous. However, some of the metal nanoparticles may be in different shapes.

### Nanoparticles—Size

The metal nanoparticles 103 for LSPR are in various nano-sizes. At any size, the metal nanoparticles are generally homogenous with a standard deviation of less than about 10 nm, although not limited thereto. The diameter of the nanoparticles is about 5, 10, 15, 20, 25, 30, 35, 40, 45, 50, 55, 60, 65, 70, 75, 80, 85, 90, 95, 100, 105, 110, 115, 120, 125, 130, 135, 140, 145, 150, 160, 170, 180, or 200 nm. In embodiments, the diameter may be within a range formed by any two numbers listed in the immediately previous sentence. For example, the diameter is between about 10 nm and about 30 nm, between about 40 nm and about 70 nm, between about 35 nm and about 55 nm, etc.

### Catalytic Metal-Decorated Metal Nanoparticles

To further facilitate a chemical reaction, the metal nanoparticles of the LSPR catalyst may optionally contain at least one catalytic metal for the chemical reaction. The catalytic metal lumps 108 may be attached or deposited onto surface(s) of the metal nanoparticles, which provides “catalytic metal-decorated metal nanoparticles” 110 as illustrated in FIG. 2B. The catalytic metal-decorated metal nanoparticles may also be referred to as metal-decorated metal nanoparticles, catalytic metal-decorated plasmonic nanoparticles, metal-decorated plasmonic nanoparticles, decorated metal nanoparticles or decorated nanoparticles. In the catalytic metal-decorated nanoparticles, the metal nanoparticles may be in single metal nanoparticles, metal alloy nanoparticles, core-shell nanoparticles or a mixture of any of the foregoing nanoparticles.

### Catalytic Metal

In embodiments, the catalytic metal for the catalytic metal-decorated metal nanoparticles is ruthenium (Ru), iron (Fe), nickel (Ni), cobalt (Co), platinum (Pt), rhodium (Rh), rhenium (Re), palladium (Pd), iridium (Ir), indium (In), osmium (Os), titanium (Ti), vanadium (V), or an alloy of any of the foregoing catalytic metal. Some of the catalytic metals are also a plasmonic metal. In some embodiments, the catalytic metal deposited on the metal nanoparticles is the same metal contained in the metal nanoparticles. In other embodiments, the catalytic metal deposited on the metal nanoparticles is different from a metal or metals contained in the metal nanoparticles.

### Catalytic Chemical Reactions

The catalytic metal formed on the metal nanoparticles may catalyze and facilitate certain chemical reactions in addition to the facilitation of the reaction by LSPR with the plasmonic metal nanoparticles. For example, a gas phase ammonia cracking reaction (Formula 1) may be facilitated and enhanced by a catalyst. Formulae 2-7 are reactions occurring in the overall ammonia cracking reaction of Formula 1. IN these formulae, “*” refers to the catalyst which is either or both of the catalytic metal and LSPR catalyst. Any other appropriate catalyst may be added.

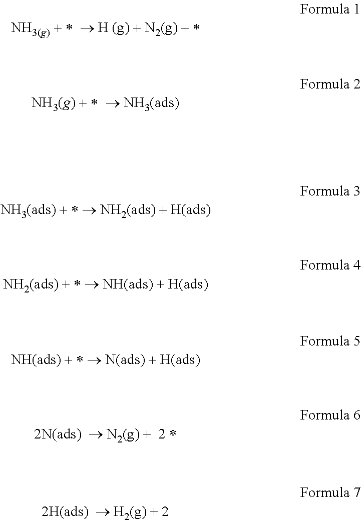

Nano-Sized Lumps Smaller than Metal Nanoparticles

The catalytic metal formed on the metal nanoparticles may be nano-sized masses or lumps 108 that are smaller than the metal nanoparticles, although not limited thereto. The metal lumps have a size of about 0.1, 0.2, 0.3, 04, 0.5, 0.5, 0.7, 0.8, 0.9, 1, 1.2, 1.4, 1.6, 1.8, 2, 2.2, 2.4, 2.6, 2.8, 3, 3.2, 3.4, 3.6, 3.8, 4, 4.2, 4.4, 4.6, 4.8, 5, 5.2, 5.4, 5.6, 5.8, 6, 6.2, 6.4, 6.6, 6.8, 7, 7.2, 7.4, 7.6, 7.8, 8, 8.2, 8.4, 8.6, 8.8, 9, 9.2, 9.4, 9.6, 9.8, 10, 10.2, 10.4, 10.6, 10.8, 11, 11.2, 11.4, 11.6, 11.8 or 12 nm, although not limited thereto. In embodiments, the metal lumps have a size within a range formed by any two numbers listed in the immediately previous sentence. For example, the size is between about 0.1 nm and about 0.7 nm, between about 0.3 nm and about 0.6 nm, about 0.5 nm and about 1 nm, etc.

### No Fusion or Alloy Between Metal Nanoparticle and Catalyst Metal Deposits Thereon

In embodiments, while the catalyst metal lumps are formed on surfaces of the metal nanoparticles, the catalytic metal and plasmonic metal of the nanoparticles do not fuse together or form an alloy of the two metals. The resulting nanoparticles do not contain a fusion material or alloy of the catalytic metal and the plasmonic metal along the interface therebetween.

### Alternative Design

The catalytic metal and the plasmonic metal of the nanoparticles may fuse together or form an alloy. The resulting nanoparticles may contain a fusion material or alloy of the catalytic metal and the plasmonic metal where the catalytic metal lumps contact the plasmonic metal nanoparticle.

### Ligands

### Ligand

The ligand for an LSPR catalyst is a compound for connecting between two metal nanoparticles or between a metal nanoparticle and the substrate. The ligand compound has a backbone including two functional ends (first and second substituent groups) although it may have one or more additional functional ends. The first substituent group of the ligand compound is metal-bonding to form a bond to a metal nanoparticle. The second substituent group of the ligand compound is to form a bond to or interact with another metal nanoparticle and/or substrate.

### Backbone

The ligand compound's backbone is flexible and configured to bend. The ligand may be an organic backbone although not limited thereto. The ligand may have a polymer backbone or a non-polymer backbone although not limited thereto. The backbone does not have to be in a particular shape or size although the shape or size of the backbone may determine the density of nanoparticles in the nanoparticle network or near the supporting body.

### First Substituent Group for Bonding to Metal

The ligand has at least one metal-bonding substituent group to bond to a metal nanoparticle. The metal-bonding substituent group may be reactive or to form a bonding with a metal surface. The metal-bonding substituent group of the ligand may be an amino, thiol, carboxyl, phosphonic, biphosphate, triphosphate, sulfonate, perchlorate group, etc. Also, an electron-rich organic moiety such as an aromatic ring may work as the metal-bonding substituent group of the ligand.

### Two or More Metal-Bonding Substituent Groups

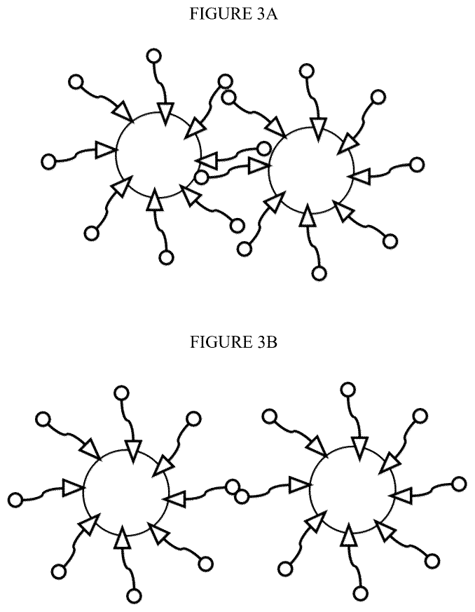

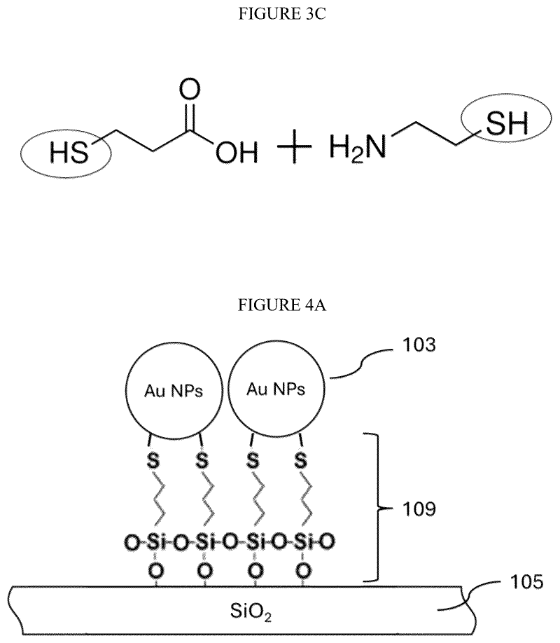

With two metal-bonding substituent groups, the ligand may be inserted and link between two metal nanoparticles as illustrated in FIG. 3A. Here, each ligand has a triangle end and a circle end representing two metal-bonding substituent groups. Multiple ligands are attached to each metal nanoparticle by the triangle metal-bonding substituent group. Among these ligands, the free end (circle end) of two ligands is also attached to the other metal nanoparticle. Thus, the two ligands are interposed between the two metal nanoparticles. The circle end and triangle end may be the same or different substituent groups. For example, the ligand has two thiol ends or two amine ends as two metal-bonding substituent groups. Still for example, the ligand has at least one thiol and at least one amine as two metal-bonding substituent groups. Although not illustrated, the ligand may include more than two metal-bonding substituent groups, which may bond to and interconnect three or more metal nanoparticles. The ligands including two or more metal nanoparticle-bonding substituent groups are useful to form a network of more metal nanoparticles as in FIG. 1B.

Second Substituent Group for Interacting/Bonding with Other Ligands

Referring to FIG. 3B, in addition to at least one metal-bonding substituent group (triangle end), the ligand may include at least one substituent group (circle end) that is configured to interact with or bond to at least one substituent group of another ligand attached to another nanoparticle. As a result, the two metal nanoparticles are linked and interconnected by a chemical bond or interaction between the two circle end substituent groups. The two circle ends may be the same or different substituent groups for making a covalent bond, ionic bond or hydrogen bond between them. Alternatively, the two circle ends are charged in opposite polarities for electrostatic interactions or traction therebetween. For example, in FIG. 1E, ligands labeled “A” are positively charged and ligands labeled “B” are negatively charged.

### Example Ligands for Interacting/Bonding with Other Ligands

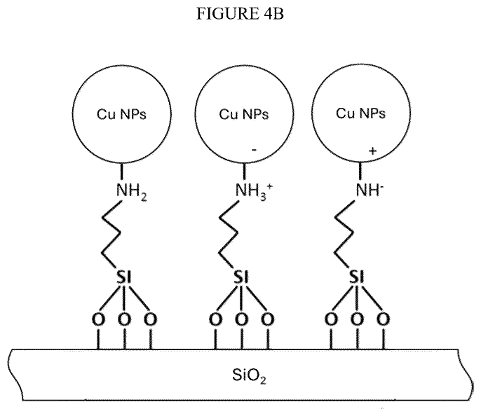

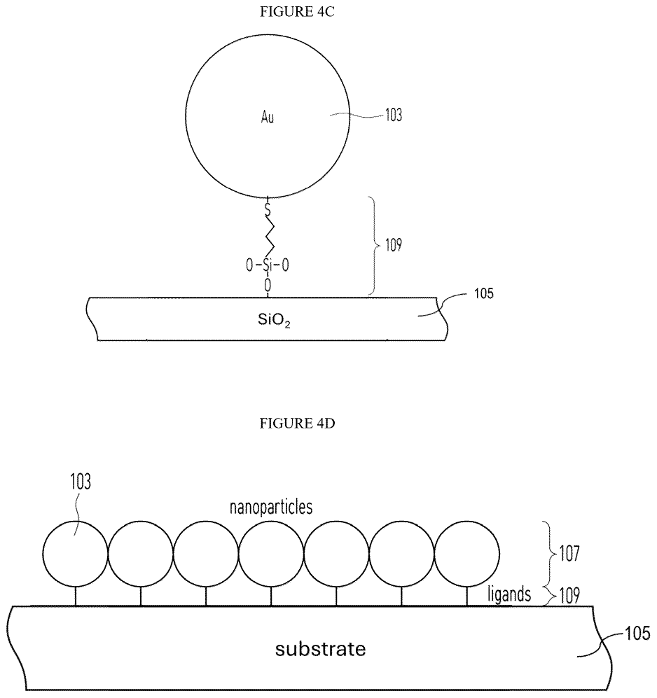

Referring to FIG. 3C, for example, one ligand has a mercapto end (first substituent group) and a carboxyl end (second substituent group), and the other ligand has a mercapto end (first substituent group) and an amino end (second substituent group). Although not illustrated, the first substituent group (mercapto end) of each ligand react with and bond to a metal nanoparticle surface (FIG. 4A). The carboxyl end (second substituent group) of one ligand and the amino end (second substituent group) of the other ligand may react and form a peptide bond, which interconnects the two metal nanoparticles (not illustrated) via the peptide bond of the two ligands of FIG. 3C.

### Two or More Second Substituent Groups

Although not illustrated, the ligand may include two or more substituent groups for forming a chemical bond or electrostatic interaction. The connection between two metal nanoparticles as in FIG. 3B would be useful to a form a network of more metal nanoparticles. FIGS. 1C-1E illustrate networked metal nanoparticles via chemical bonds between ligands as in FIG. 3B. In FIG. 1C, metal nanoparticles belonging to the network directly bond to the substrate. On the other hand, FIG. 1D includes additional ligands that are different from the ligands connecting between nanoparticles, which interconnect between the networked nanoparticles and the substrate. FIG. 1E illustrates networked metal nanoparticles via electrostatic interactions between ligands (A) and ligands (B).

### Substrate-Bonding Substituent Group

In addition to at least one metal-bonding substituent group, the ligand may include at least one substrate-bonding substituent group that is reactive or prone to bond to a surface of the substrate or supporting body. As illustrated in FIG. 1A, such a ligand is capable of bonding to a metal nanoparticle via the at least one metal-bonding substituent group and also capable of bonding to the substate via the at least one substrate-bonding substituent group. If the metal nanoparticle bonded to the ligand is part of a nanoparticle network, the networked nanoparticles are connected to the substrate via the ligand.

### Ligand Compounds

Table 2 below lists some candidate ligand compounds for LSPR, although not limited thereto.

TABLE 2

| | | | |
|---|---|---|---|
| No | Name | Formula | 2D Structure |

trimethoxysilane

| | | | |
|---|---|---|---|
| 1 | (3-lodopropyl)trimethoxysilane | C₆H₁₅IO₃Si | 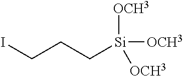 [SMILES: CO[Si](CCCI)(OC)OC] |
| 2 | (3-Chloropropyl)trimethoxysilane/CPTMS | C₆H₁₅ClO₃Si | 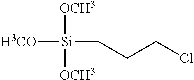 [SMILES: CO[Si](CCCCl)(OC)OC] |
| 3 | (N,N-Dimethylaminopropyl)trimethoxysilane | C₈H₂₁NO₃Si | 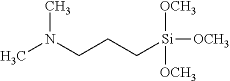 |
| 4 | (3-Aminopropyl)trimethoxysilane/APTMS | C₆H₁₇NO₃Si | 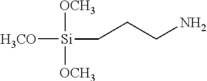 [SMILES: CO[Si](CCCN)(OC)OC] |
| 5 | (3-Mercaptopropyl)trimethoxysilane/MPS or MPTMS | C₆H₁₆O₃SSi | 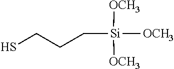 [SMILES: CO[Si](CCCS)(OC)OC] |
| 6 | [3-(2-Aminoethylamino)propyl]trimethoxysilane | C₈H₂₂N₂O₃Si | 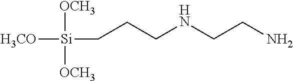 [SMILES: CO[Si](CCCNCCN)(OC)OC] |
| 7 | (3-Glycidyloxypropyl)trimethoxysilane GPTMS | C₉H₂₀O₅Si | 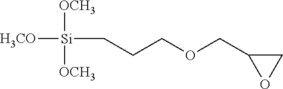 [SMILES: CO[Si](CCCOCC1CO1)(OC)OC] |
| 8 | Isooctyl trimethoxysilane | C₁₁H₂₆O₃Si | 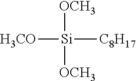 |
| 9 | (3-Bromopropyl)trimethoxysilane/BPTS | C₆H₁₅BrO₃Si | 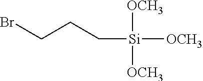 [SMILES: CO[Si](CCCBr)(OC)OC] |
| 10 | [3-(Diethylamino)propyl]trimethoxysilane | C₁₀H₂₅NO₃Si | 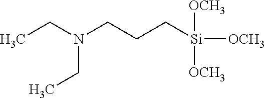 |
| 11 | (3-Glycidyl-¹³C3-oxypropyl)trimethoxysilane | ¹³C₃C₆H₂₀O₅Si | 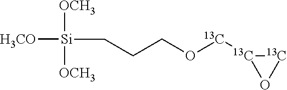 [SMILES: CO[Si](CCCO[13CH2][13CH]1[13CH2]O1)(OC)OC] |
| 12 | (3-Glycidyl-2-¹³C-oxypropyl)trimethoxysilane | ¹³CC₈H₂₀O₅Si | 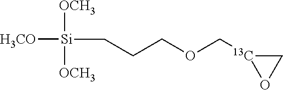 [SMILES: CO[Si](CCCOC[13CH]1CO1)(OC)OC] |
| 13 | 3-(Trimethoxysilyl)propyl acrylate | C₉H₁₈O₅Si | 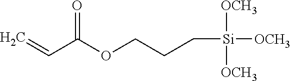 |
| 14 | Trimethoxy(2-phenylethyl)silane/TMPES | C₁₁H₁₈O₃Si | 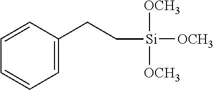 [SMILES: CO[Si](CCc1ccccc1)(OC)OC] |
| 15 | Trimethoxy(3,3,3-trifluoropropyl)silane | C₆H₁₃F₃O₃Si | 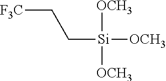 [SMILES: CO[Si](CCC(F)(F)F)(OC)OC] |
| 16 | 3-(Trimethoxysilyl)propyl methacrylate/TMSPMA | C₁₀H₂₀O₅Si | 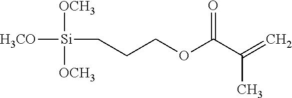 [SMILES: C=C(C)C(=O)OCCC[Si](OC)(OC)OC] |
| 17 | Trimethoxy[3-(methylamino)propyl]silane/ MAPTMS | C₇H₁₉NO₃Si | 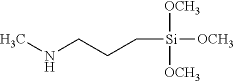 |
| 18 | N-[3-(Trimethoxysilyl)propyl]aniline/TMSPA | C₁₂H₂₁NO₃Si | 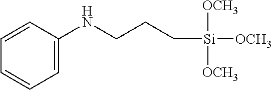 [SMILES: CO[Si](CCCNc1ccccc1)(OC)OC] |
| 19 | N-[3-(Trimethoxysilyl)propyl]ethylenediamine | C₈H₂₂N₂O₃Si | 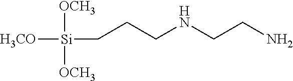 [SMILES: CO[Si](CCCNCCN)(OC)OC] |
| 20 | Trimethoxy[2-(7-oxabicyclo[4.1.0]hept-3- yl)ethyl]silane | C₁₁H₂₂O₄Si | 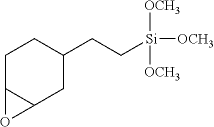 [SMILES: CO[Si](CCC1CCC2OC2C1)(OC)OC] |

Trimethoxysilyl

| | | | |
|---|---|---|---|
| 21 | Dimethyloctadecyl[3- (trimethoxysilyl)propyl]ammonium chloride solution/ DTSACI | C₂₆H₅₈NO₃SiCl | 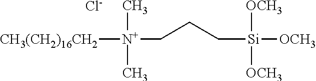 |
| 22 | 1,4-Bis(trimethoxysilyl)benzene | C₁₂H₂₂O₆Si₂ | 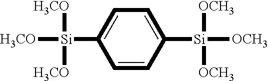 |
| 23 | 1-[3-(Trimethoxysilyl)propyl]urea | C₇H₁₈N₂O₄Si | 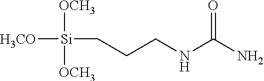 [SMILES: CO[Si](CCCNC(N)=O)(OC)OC] |
| 24 | Tris[3-(trimethoxysilyl)propyl]isocyanurate/TTPI | C₂₁H₄₅N₃O₁₂Si₃ | 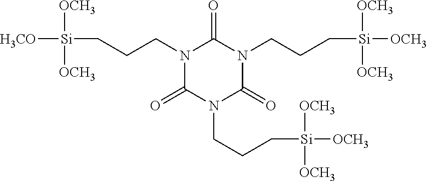 [SMILES: CO[Si](CCCn1c(=O)n(CCC[Si](OC)(OC)OC)c(=O)n(CCC[Si](OC)(OC)OC)c1=O)(OC)OC] |
| 25 | 3-(Trimethoxysilyl)propyl-N,N,N- trimethylammonium-¹⁵N chloride | C₉H₂₄Cl₁₅NO₃Si | 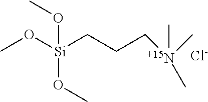 |
| 26 | Trimethoxyphenylsilane/TMPS | C₉H₁₄O₃Si | 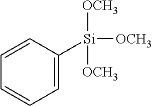 [SMILES: CO[Si](OC)(OC)c1ccccc1] |
| 27 | Vinyltrimethoxysilane/VTMS | C₅H₁₂O₃Si | 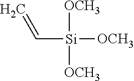 |
| 28 | 2-(Trimethylsilyloxy)ethyl methacrylate | C₉H₁₈O₃Si | 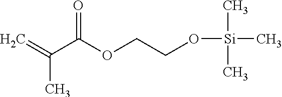 |

Triethoxysilane

| | | | |
|---|---|---|---|
| 29 | Triethoxysilane | C₆H₁₅O₃Si | 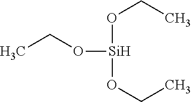 |
| 30 | (3-Chloropropyl)triethoxysilane | C₉H₂₁ClO₃Si | 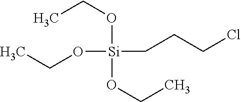 |
| 31 | (3-Mercaptopropyl)triethoxysilane/MPTS | C₉H₂₂O₃SSi | 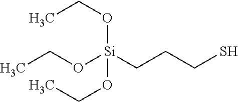 |
| 32 | (3-Aminopropyl)triethoxysilane/APTES | C₉H₂₃NO₃Si | 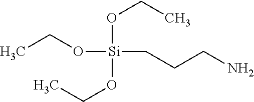 |
| 33 | (4-Chlorophenyl)triethoxysilane | C₁₂H₁₉ClO₃Si | 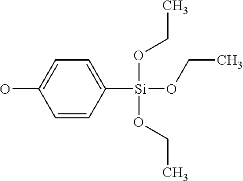 [SMILES: CCO[Si](OCC)(OCC)c1ccc(O)cc1] |
| 34 | Methyl-d3-triethoxysilane | CD₃Si(OC₂H₅)₃ | 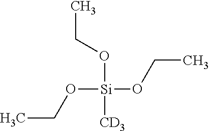 |
| 35 | (3-Glycidyloxypropyl)triethoxysilane/GPTES | C₁₂H₂₆O₅Si | 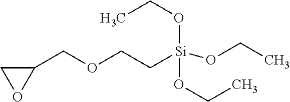 [SMILES: CCO[Si](CCOCC1CO1)(OCC)OCC] |
| 36 | (1-NAPHTHYL)TRIETHOXYSILANE | C₁₆H₂₂O₃Si | 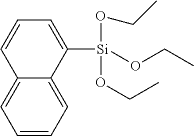 [SMILES: CCO[Si](OCC)(OCC)c1cccc2ccccc12] |
| 37 | 3-[Bis(2-hydroxyethyl)amino]propyl-triethoxysilane solution | C₁₃H₃₁NO₅Si | 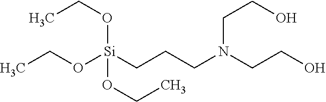 [SMILES: CCO[Si](CCCN(CCO)CCO)(OCC)OCC] |
| 38 | 3-(Triethoxysilyl)propionitrile/TESPN | C₉H₁₉NO₃Si | 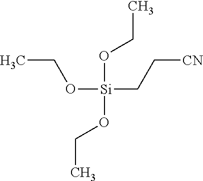 |
| 39 | Bis[3-(triethoxysilyl)propyl]tetrasulfide/TESPTS | C₁₈H₄₂O₆S₄Si₂ | 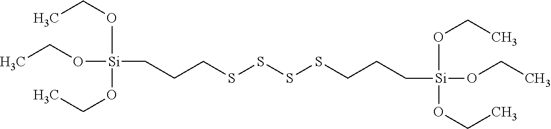 [SMILES: CCO[Si](CCCSSSSCCC[Si](OCC)(OCC)OCC)(OCC)OCC] |
| 40 | 3-(Triethoxysilyl)propyl isocyanate/TEPI | C₁₀H₂₁NO₄Si | 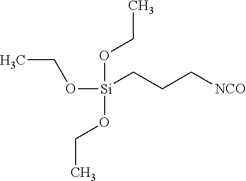 |
| 41 | 1,2-Bis(triethoxysilyl)ethane/BTESE | C₁₄H₃₄O₆Si₂ | 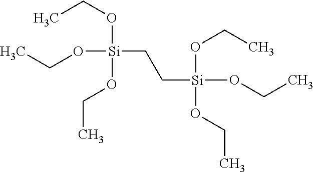 [SMILES: CCO[Si](CC[Si](OCC)(OCC)OCC)(OCC)OCC] |

Triethoxysilyl

| | | | |
|---|---|---|---|
| 42 | 4,4′-Bis(triethoxysilyl)-1,1′-biphenyl | C₂₄H₃₈O₆Si₂ | 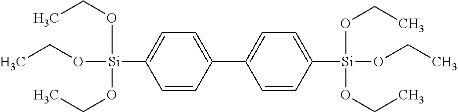 [SMILES: CCO[Si](OCC)(OCC)c1ccc(-c2ccc([Si](OCC)(OCC)OCC)cc2)cc1] |
| 43 | 1,4-Bis(triethoxysilyl)benzene | C₁₈H₃₄O₆Si₂ | 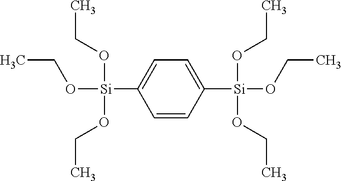 [SMILES: CCO[Si](OCC)(OCC)c1ccc([Si](OCC)(OCC)OCC)cc1] |
| 44 | Triethoxyvinylsilane/TEVS | C₈H₁₈O₃Si | 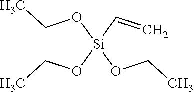 |
| 45 | 3-Cyanopropyltriethoxysilane/CPTS | C₁₀H₂₁NO₃Si | 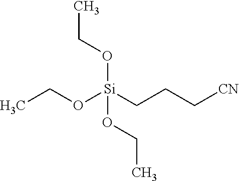 |
| 46 | Dodecyltriethoxysilane/DTES | C₁₈H₄₀O₃Si | 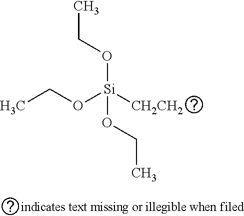 |
| 47 | Triethoxy-3-(2-imidazolin-1-yl)propylsilane | C₁₂H₂₆N₂O₃Si | 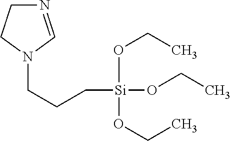 [SMILES: CCO[Si](CCCN1C=NCC1)(OCC)OCC] |

Phosphonic acid and Phosphonate

| | | | |
|---|---|---|---|
| 48 | Diethyl (1-cyanoethyl)phosphonate | C₇H₁₄NO₃P | 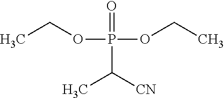 |
| 49 | Diethyl (bromodifluoromethyl)phosphonate | C₅H₁₀BrF₂O₃P | 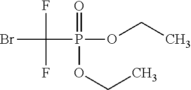 |
| 50 | Diethyl (hydroxymethyl)phosphonate | C₅H₁₃O₄P | 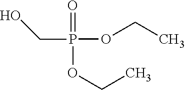 |
| 51 | Diethyl (phenylthiomethyl-¹³C)phosphonate | ¹³CC₁₀H₁₇O₃PS | 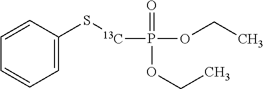 [SMILES: CCOP(=O)([13CH2]Sc1ccccc1)OCC] |
| 52 | Diethyl (methylthiomethyl)phosphonate | C₆H₁₅O₃PS | 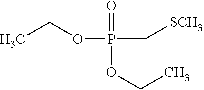 |
| 53 | Diethyl (difluoromethyl)phosphonate | C₅H₁₁F₂O₃P | 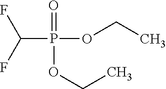 |
| 54 | Diethyl(3-bromopropyl)phosphonate | C₇H₁₆BrO₃P | 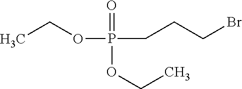 |
| 55 | Diethyl (2-oxopropyl)phosphonate | C₇H₁₅O₄P | 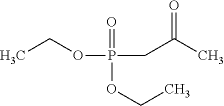 |
| 56 | Diethyl (phenylsulfinylmethyl-¹³C)phosphonate | ¹³CC₁₀H₁₇O₄PS | 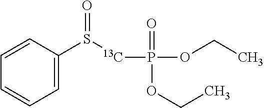 [SMILES: CCOP(=O)([13CH2]S(=O)c1ccccc1)OCC] |
| 57 | Dimethyl (1-diazo-2-oxopropyl)phosphonate solution | C₅H₉N₂O₄P | 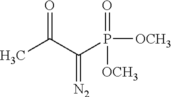 |
| 58 | (Aminomethyl)phosphonic acid | CH₆NO₃P | 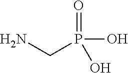 |
| 59 | DIPHENYL (TRIPHENYLPHOSPHORANYLIDENEMETHYL)PHOSPHO- NATE | C₃₁H₂₆O₃P₂ | 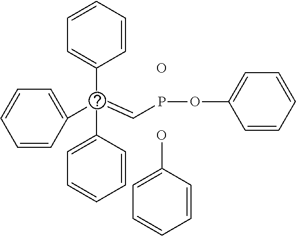 |
| 60 | Dimethyl [2-oxo-2-(cyclohexyl- d11)ethyl]phosphonate | C₁₀D₁₁H₈O₄P | 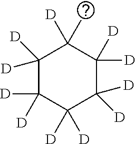 [SMILES: [2H]C1([2H])C([2H])([2H])C([2H])([2H])C([2H])(C)C([2H])([2H])C1([2H])[2H]] |
| 61 | Methylenebis(phosphonic dichloride) | CH₂Cl₄O₂P₂ | 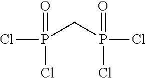 |
| 62 | DIBENZYL (ALPHA-ANILINOBENZYL)-PHOSPHONATE | C₂₇H₂₆NO₃P | 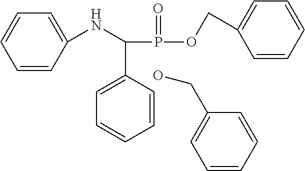 |
| 63 | DIPHENYL(ALPHA-ANILINOBENZYL)PHOSPHONATE | C₂₅H₂₂NO₃P | 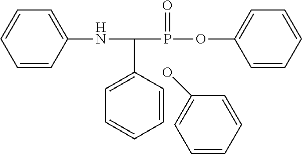 |
| 64 | DIETHYL (METHOXY(METHOXYCARBONYL)METHYL)PHOSPHO- NATE | C₈H₁₇O₆P | 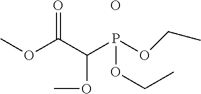 |
| 65 | DIISOBUTYL (N,N- DIETHYLCARBAMOYL)PHOSPHONATE | C₁₃H₂₈NO₄P | 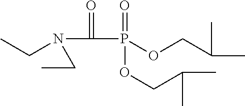 [SMILES: CCN(CC)C(=O)P(=O)(OCC(C)C)OCC(C)C] |
| 66 | DIISOPROPYL (N,N- DIBENZYLCARBAMOYLMETHYL)PHOSPHONATE | C₂₂H₃₀NO₄P | 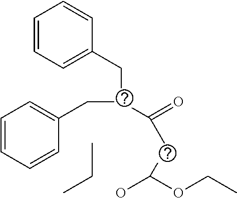 |
| 67 | DIISOPROPYL (N,N- DIETHYLCARBAMOYL)PHOSPHONATE | C₁₁H₂₄NO₄P | 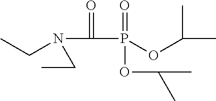 [SMILES: CCN(CC)C(=O)P(=O)(OC(C)C)OC(C)C] |
| 68 | DIOCTYL (N,N-DIETHYLCARBAMOYL)PHOSPHONATE | C₂₁H₄₄NO₄P | 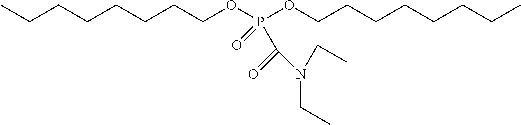 [SMILES: CCCCCCCCOP(=O)(OCCCCCCCC)C(=O)N(CC)CC] |
| 69 | DIOCTYL (N,N- DIMETHYLCARBAMOYLMETHYL)PHOSPHONATE | C₂₀H₄₂NO₄P | 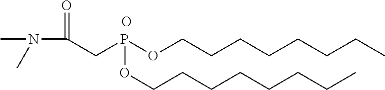 |
| 70 | Diethyl [difluoro(trimethylsilyl)methyl]phosphonate | C₈H₁₉F₂O₃PSi | 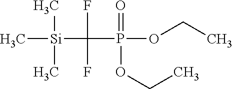 |
| 71 | Diethyl (2-oxo-2-phenylethyl)phosphonate | C₁₂H₁₇O₄P | 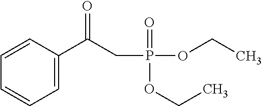 [SMILES: CCOP(=O)(CC(=O)c1ccccc1)OCC] |
| 72 | DIETHYL (3-METHOXYCARBONYL-2- PROPENYL)PHOSPHONATE | C₉H₁₇O₅P | 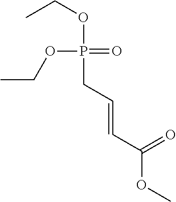 |
| 73 | DIPHENYL (ALPHA-ANILINO-2- PYRIDYLMETHYL)PHOSPHONATE | C₂₄H₂₁N₂O₃P | 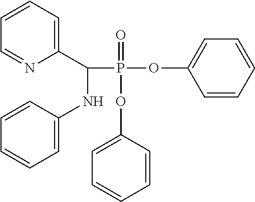 [SMILES: O=P(Oc1ccccc1)(Oc1ccccc1)C(Nc1ccccc1)c1ccccn1] |
| 74 | Phosphonic acid-1803 | H₃1₈O₃P | 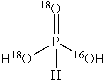 |
| 75 | BIS(2-ETHYLHEXYL) (N,N- DIISOPROPYLCARBAMOYLMETHYL)PHOSPHONATE | C₂₄H₅₀NO₄P | 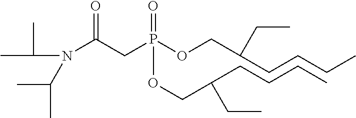 [SMILES: CCCCC(CC)COP(=O)(CC(=O)N(C(C)C)C(C)C)OCC(CC)CCCC] |
| 76 | BIS(2,2,4-TRIMETHYLPENTYL) (N,N- DIETHYLCARBAMOYLMETHYL)PHOSPHONATE | C₂₂H₄₆NO₄P | 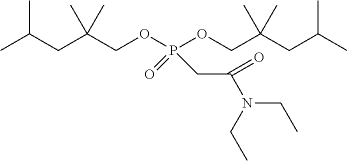 [SMILES: CCN(CC)C(=O)CP(=O)(OCC(C)(C)CC(C)C)OCC(C)(C)CC(C)C] |
| 77 | DI-SEC-BUTYL (N,N- DIETHYLCARBAMOYLMETHYL)PHOSPHONATE | C₁₄H₃₀NO₄P | 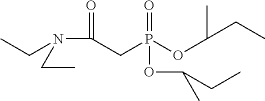 [SMILES: CCC(C)OP(=O)(CC(=O)N(CC)CC)OC(C)CC] |
| 78 | DIBUTYL (1-(N,N- DIETHYLCARBAMOYL)ETHYL)PHOSPHONATE | C₁₅H₃₂NO₄P | 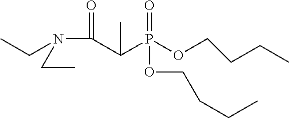 [SMILES: CCCCOP(=O)(OCCCC)C(C)C(=O)N(CC)CC] |
| 79 | (12-Phosphonododecyl)phosphonic acid | C₁₂H₂₈O₆P₂ | 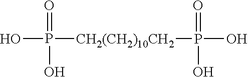 |
| 80 | (3-Bromopropyl)phosphonic acid | C₃H₈BrO₃P | 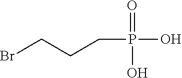 |
| 81 | 1,4-Phenylenebis(phosphonic acid) | C₆H₈O₆P₂ | 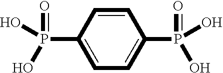 |
| 82 | Methyl phosphonic acid-¹³C | ¹³CH₅O₃P | 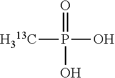 |
| 83 | (DICHLOROMETHYL)PHOSPHONIC DICHLORIDE | CHCl₄OP | 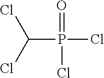 |
| 84 | Ethyl phosphonic acid-(methyl-¹³C) | C₁₃CH₇O₃P | 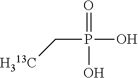 |
| 85 | (1-AMINOPROPYL)PHOSPHONIC ACID | C₃H₁₀NO₃P | 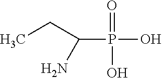 |
| 86 | (2-ISOPROPYLPHENYL)PHOSPHONIC ACID | C₉H₁₃O₃P | 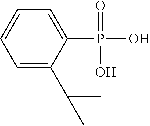 |
| 87 | (2-METHOXYPHENYL)PHOSPHONIC ACID | C₇H₉O₄P | 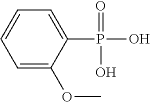 |
| 88 | (2,3-XYLYL)PHOSPHONIC ACID | C₈H₁₁O₃P | 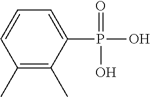 |
| 89 | (2,4-XYLYL)PHOSPHONIC ACID | C₈H₁₁O₃P | 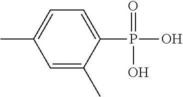 |
| 90 | (2,5-XYLYL)PHOSPHONIC ACID | C₈H₁₁O₃P | 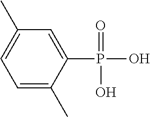 |
| 91 | (3-NITROPHENYL)PHOSPHONIC ACID | C₆H₆NO₅P | 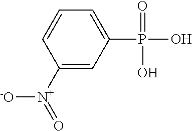 |
| 92 | (3,5-XYLYL)PHOSPHONIC ACID | C₈H₁₁O₃P | 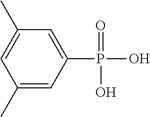 |
| 93 | (4-BROMOPHENYL)PHOSPHONIC ACID | C₆H₆BrO₃P | 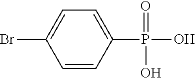 [SMILES: O=P(O)(O)c1ccc(Br)cc1] |
| 94 | (4-CHLOROPHENYL)PHOSPHONIC ACID | C₆H₆ClO₃P | 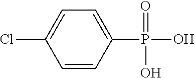 [SMILES: O=P(O)(O)c1ccc(Cl)cc1] |
| 95 | (4-ETHYLPHENYL)PHOSPHONIC ACID | C₈H₁₁O₃P | 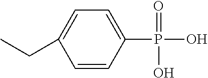 |
| 96 | (M-TOLYL)PHOSPHONIC ACID | C₇H₉O₃P | 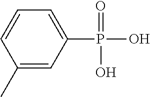 |
| 97 | [1,1′-Biphenyl]-4,4′-diylbis(phosphonic acid) | C₁₂H₁₂O₆P₂ | 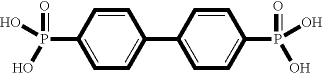 |
| 98 | Dibenzyl phosphite | C₁₄H₁₄O₃P+ | 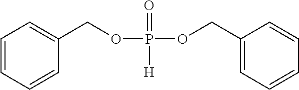 [SMILES: O=[PH](OCc1ccccc1)OCc1ccccc1] |
| 99 | (1R)-(+)-(1-Amino-2-methylpropyl)phosphonic acid | C₄H₁₂NO₃P | 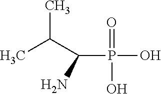 |
| 100 | 11-(2-Bromoisobutyrate)-undecyl-1-phosphonic acid | C₁₅H₃₀BrO₅P | 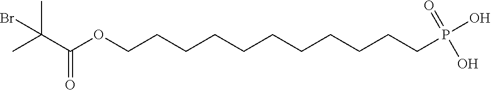 [SMILES: CC(C)(Br)C(=O)OCCCCCCCCCCCP(=O)(O)O] |
| 101 | N,N′-2-methylpiperazinebis(methylene phosphonic acid) | C₇H₁₈N₂O₆P₂ | 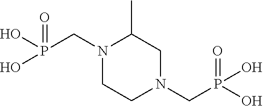 [SMILES: CC1CN(CP(=O)(O)O)CCN1CP(=O)(O)O] |
| 102 | (NICOTINAMIDOMETHYL)PHOSPHONIC ACID, DISODIUM SALT | C₇H₇N₂Na₂O₄P | 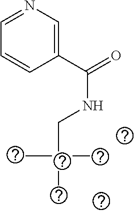 |
| 103 | (NICOTINAMIDOMETHYL)PHOSPHONIC ACID, IRON(II) SALT | C₁₄H₁₆FeN₄O₈P₂ | 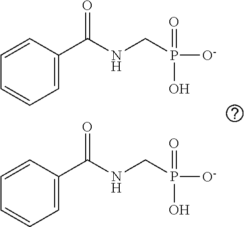 [SMILES: O=C(NCP(=O)([O-])O)c1ccccc1 ; O=C(NCP(=O)([O-])O)c1ccccc1] |
| 104 | (AMINOMETHYL)-PHOSPHONIC ACID, IRON (II) SALT | C₂H₁₀FeN₂O₆P₂ | 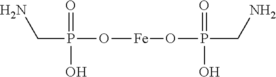 |
| 105 | Di-tert-butyl phosphite | C₈H₁₉O₃P | 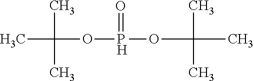 |
| 106 | Diphenyl phosphite | (C₆H₅O)₂P(O)H | 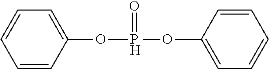 |
| 107 | (1-AMINO-1-PHOSPHONO-OCTYL)-PHOSPHONIC ACID | C₈H₂₁NO₆P₂ | 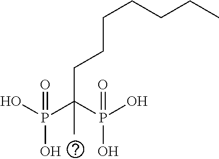 [SMILES: CCCCCCCC(C)(P(=O)(O)O)P(=O)(O)O] |
| 108 | Phenylphosphonic acid | C₆H₅P(O)(OH)₂ | 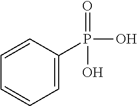 |
| 109 | 4-Aminobutylphosphonic acid | C₄H₁₂NO₃P | 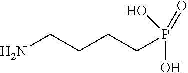 |
| 110 | 2-Aminoethylphosphonic acid/2-AEP | H₂NCH₂CH2P(O)(OH)₂ | 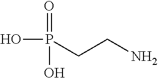 |
| 111 | 3-Aminopropylphosphonic acid | H₂N(CH₂)₃P(O)(OH)₂ | 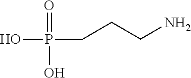 |
| 112 | 4-Aminobenzylphosphonic acid | C₇H₁₀NO₃P | 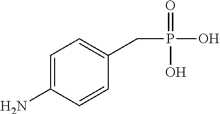 [SMILES: Nc1ccc(CP(=O)(O)O)cc1] |
| 113 | 4-Methylumbelliferyl phosphate | C₁₀H₉O₆P | 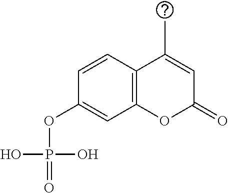 [SMILES: Cc1cc(=O)oc2cc(OP(=O)(O)O)ccc12] |
| 114 | 12-Mercaptododecylphosphonic acid | C₁₂H₂₇O₃PS | 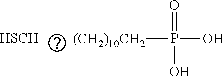 |
| 115 | 11-Phosphonoundecyl acrylate | C₁₄H₂₇O₅P | 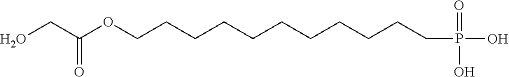 [SMILES: O=C(CO)OCCCCCCCCCCCP(=O)(O)O] |
| 116 | 11-Hydroxyundecylphosphonic acid | C₁₁H₂₅O₄P | 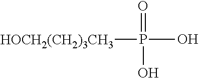 |
| 117 | 12-Pentafluorophenoxydodecylphosphonic acid | C₁₈H₂₆F₅O₄P | 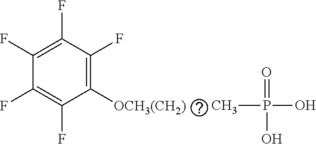 |
| 118 | Adefovir/PMEA | C₈H₁₂N₅O₄P | 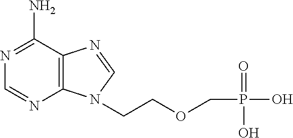 [SMILES: Nc1ncnc2c1ncn2CCOCP(=O)(O)O] |
| 119 | 3-(Trihydroxysilyl)propyl methylphosphonate, monosodium salt | CH₃P(O)(ONa)O(CH₂) 3Si(OH)₃ | 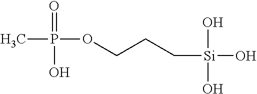 |
| 120 | (2-diethylphosphatoethyl)triethoxysilane | C₁₂H₂₉O₆PSi | 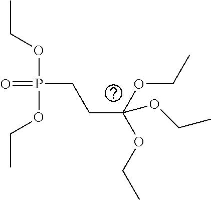 [SMILES: CCOC(CCP(=O)(OCC)OCC)(OCC)OCC] |
| 121 | Phosphonic acid, P-methyl-, methyl 3- (trimethoxysilyl)propyl ester | C₈H₂₁O₆PSi | 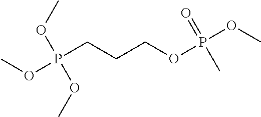 |
| 122 | Diethyl(trimethylsilylmethyl)phosphonate | C₈H₂₁O₃PSi | 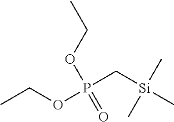 |
| 123 | 2-dimethoxyphosphorylethyl(triethoxy)silane | C₁₀H₂₅O₆PSi | 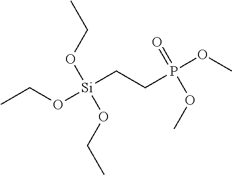 [SMILES: CCO[Si](CCP(=O)(OC)OC)(OCC)OCC] |
| 124 | 11-diethoxyphosphorylundecyl(trimethoxy)silane | C₁₈H₄₁O₆PSi | 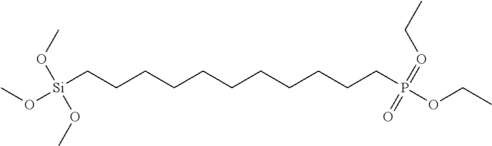 |
| 125 | Diethyl[3-(triethoxysilyl)propyl]phosphonate | C₁₃H₃₁O₆PSi | 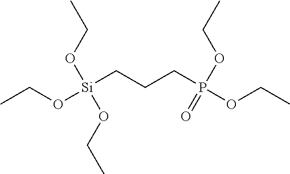 [SMILES: CCO[Si](CCCP(=O)(OCC)OCC)(OCC)OCC] |
| 126 | Diethyl[1-(trimethylsiloxy)-1- methylethyl]phosphonate | C₁₀H₂₅O₄PSi | 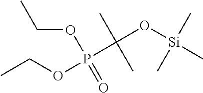 [SMILES: CCOP(=O)(OCC)C(C)(C)O[Si](C)(C)C] |
| 127 | Diethyl{2-[(trimethylsilyl)oxy]propyl}phosphonate | C₁₀H₂₅O₄PSi | 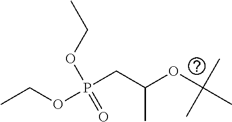 [SMILES: CCOP(=O)(CC(C)OC(C)(C)C)OCC] |

(1B)&(2B) Zr(OR)₄

| | | | |
|---|---|---|---|
| 128 | Zirconium(IV) Ethoxide | C₈H₂₀O₄Zr | 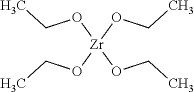 |
| 129 | Zirconium(IV) propoxide | C₁₂H₃₂O₄Zr | 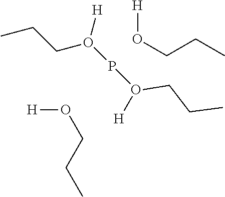 |
| 130 | Zirconium(IV) isopropoxide | C₁₂H₃₂O₄Zr | 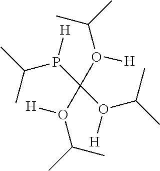 |
| 131 | Zirconium(IV) butoxide | C₁₆H₄₀O₄Zr | 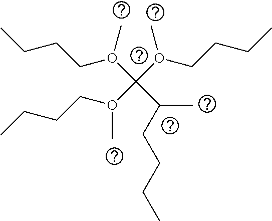 |
| 132 | Zirconium(IV) tert-butoxide | C₁₆H₄₀O₄Zr | 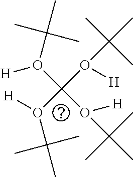 |

(1B)&(2B) Ti(OR)₄

| | | | |
|---|---|---|---|
| 133 | Titanium(IV) methoxide | C₄H₁₆O₄Ti | 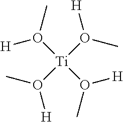 |
| 134 | Titanium(IV) ethoxide | C₈H₂₄O₄Ti | 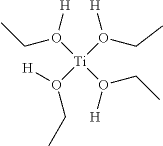 |
| 135 | Titanium(IV) isopropoxide | C₁₂H₂₈O₄Ti | 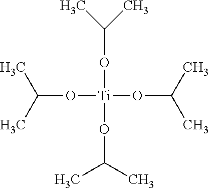 |
| 136 | Titanium(IV) tetrapropoxide | C₁₂H₂₈O₄Ti | 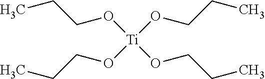 |
| 137 | Titanium(IV) butoxide | C₁₆H₄₀O₄Ti | 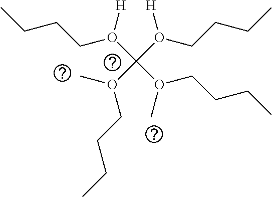 |
| 138 | Titanium(IV) tert-butoxide | C₁₆H₄₀O₄Ti | 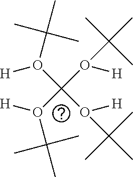 |

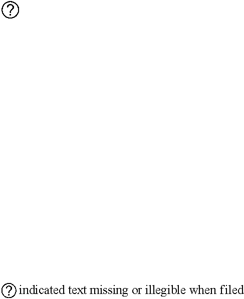

### Example Ligands Bonding to SiO₂ Substrate

At least one substrate-bonding substituent group of the ligand bonds to the substrate surface, which immobilizes the ligand relative to the substrate. When the surface of the supporting body or substrate contains silicon dioxide (SiO₂), the ligand may have at least one alkoxysilane or siloxysilane as a substrate-bonding substituent group, although not limited thereto. For example, the alkoxysilane or siloxysilane may form a siloxane bond with hydroxyl groups in the substrate. The siloxane bond is relatively strong so that the ligands are connected to the substrate 105. Also, multiple ligands bonded to the substrate may laterally form siloxane bonds together as illustrated in FIG. 4A, although not limited thereto.

### Example Ligands Bonding to Metal Nanoparticles

At least one substrate-bonding substituent group of the ligand bonds to metal nanoparticles 103. In embodiments where the at least one metal-bonding substituent group includes a thiol group, the sulfur atom of the thiol group bonds to a metal nanoparticle. This bond is relatively weak, but it is stable enough to prevent the metal nanoparticles from aggregation. In embodiments where the at least one metal-bonding substituent group includes an amine group, the amine group may attach to metal of a metal nanoparticle via a covalent bond or ionic bond.

### Substrate

### Supporting Body—Material

In embodiments, the supporting body or substrate 105 for the LSPR catalyst can be made of or contains at least one material that is reactive to form a chemical bond with the ligands. The surfaces of the supporting body are in such a material that can form a chemical body with the substrate-bonding substituent group of the ligand compound. In embodiments, the substrate and/or its surface may contain silicon dioxide (SiO₂) or include silica. For example, the supporting body or its surface is made of or contains glass, quartz, tridymite, cristobalite, opal, fumed silica, silica gel, silicate, aerogel, zeolites, and silicon carbide, etc. although not limited thereto.

### Supporting Body—Shape

The supporting body or substrate 105 may be in any shape as long as it has one or more surfaces onto which ligands can bond and attach. For example, the supporting body is in the shapes of balls, beads, spheroids, rods, chips, plates, or fibers for certain specific applications although not limited thereto. In some embodiments, one or more surfaces of the supporting body are round substrate although not limited thereto. In other embodiments, one or more surfaces of the supporting body are even, planar, bumpy, irregular, spherical, cylindrical, globular, etc., although not limited thereto.

### Transparency

The supporting body is formed of or contains a material that is transparent, translucent, or opaque. Some supporting bodies may be transparent or translucent at least in part for transmitting light beams therethrough. Such transparent or translucent supporting bodies may let light beams supplied travel therethrough and reach metal nanoparticles formed over the surfaces thereof for LSPR. Some other supping bodies may be formed or contain an opaque material through which transmission of light beams would be unlikely. In some embodiments, an opaque coating may be applied to originally transparent or translucent supporting bodies.

### Metal Nanoparticles Over Supporting Body—LSPR Catalyst

Networked and/or Non-Networked Metal Nanoparticles

An LSPR catalyst includes metal nanoparticles formed over a supporting body. In some LSPR catalysts, most of the metal nanoparticles are networked together via ligands as in FIGS. 1B-1E, 3A and 3B. In other LSPR catalysts, most or all the metal nanoparticles are individual or not networked as in FIGS. 1A, 4A, 4B, 4C, 4D and 4E. In some other LSPR catalysts, some metal nanoparticles are networked and other metal nanoparticles are not networked.

### Nanoparticles Over Some or all of Substrate Surface

The metal nanoparticles, whether networked or not, may be formed over at least part of the substrate surface. In some embodiments, networked or non-networked metal nanoparticles may be formed over only an area or portion of the substrate surface. In other embodiments, networked or non-networked metal nanoparticles may be formed over multiple areas of the substrate surface. In other embodiments, networked or non-networked metal nanoparticles may be formed over substantially entire areas of the substrate surface. In a non-networked nanoparticle context, a monolayer (i.e., only the monolayer) may be formed over only a portion(s) of the substrate surface. Still in a non-networked nanoparticle context, metal nanoparticles may be in a monolayer over a portion(s) of the substrate surface, and one or more additional layers of nanoparticles over the monolayer may be formed over at least some other areas of the substrate surface.

### Single Metal Nanoparticle Bonding to One or More Ligands

A single metal nanoparticle 103 may bond to multiple ligands 109 attached to the substrate as illustrated in FIGS. 1A and 4A. Alternatively, a single metal nanoparticle 103 may bond to a single ligand attached to the substrate 105 as illustrated in FIGS. 4B and 4C. In some embodiments, some metal nanoparticles each individually bond to a single ligand, and other metal nanoparticles each individually bond to multiple ligands.

### Height Over Supporting Body Surfaces

In some embodiments, the ligands connecting between the substrate and metal nanoparticles are of the same compound. In other embodiments, the ligands are of two or more compounds. In some embodiments, non-networked metal nanoparticles are connected to the ligands generally at about the same height over and from the substrate surface onto which the ligands are attached, as illustrated in FIG. 4D. However, the ligands having different sizes and lengths may be used to provide non-networked metal nanoparticles at varying heights from the supporting body surfaces.

### Monolayer and Multilayer of Non-Networked Nanoparticles

In some embodiments, non-networked metal nanoparticles may form a layer (first layer) floating over the substrate generally at about the same height from the substrate surface although some metal nanoparticles could float at a height higher than the first layer of nanoparticles. Some nanoparticles may not bond to a ligand at all and float over the first layer of nanoparticles by way of other forces between metal nanoparticles such as van der Waals force. In some metal nanoparticles floating at a level higher than or over the first layer form one or more additional layers over the first layer when enough metal nanoparticles are horizontally concentrated over the first layer to call them a layer. In some embodiments, the metal nanoparticles form the first layer (monolayer) only and do not form another layer over at least some areas of the monolayer as there are not enough metal nanoparticles concentrated to be called a layer over the at least some areas.

### Densely Arranged Non-Networked Nanoparticles

Metal nanoparticles 103 may be densely arranged or bound to form the first layer over the substrate 105 such that at least some of neighboring nanoparticles of the layer laterally contact one another. FIGS. 1A, 4A and 4D conceptually illustrate that immediately neighboring nanoparticles of the layer horizontally or laterally contact one another. FIG. 4E is a photograph of nanoparticles 103 taken from above the nanoparticles viewing in a direction toward the substrate, i.e., the substrate underlies the nanoparticles. Referring to FIG. 4E, the individual pieces with a closed boundary line represent nanoparticles, in which multiple nanoparticles surround one nanoparticle, and one of the multiple nanoparticles surrounding the one nanoparticle is also surrounded by multiple nanoparticles. The individual nanoparticles in FIG. 4E may be generally in the same horizontal plane such that many of them contact their immediately neighboring nanoparticles. As shown in FIG. 4E, most or substantially all metal nanoparticles contact at least one neighboring nanoparticle with some vacancies 111 (dark areas) in which no metal nanoparticles are present, although not limited thereto. In some embodiments, there are few vacancies between nanoparticles. The metal nanoparticles, in which metal nanoparticles are densely arranged or bound to form the first layer, may cover only a portion or some portions of the substrate surface or the entire area of the substrate surface.

### Nanoparticles Enhancing Surface Plasmon Resonance

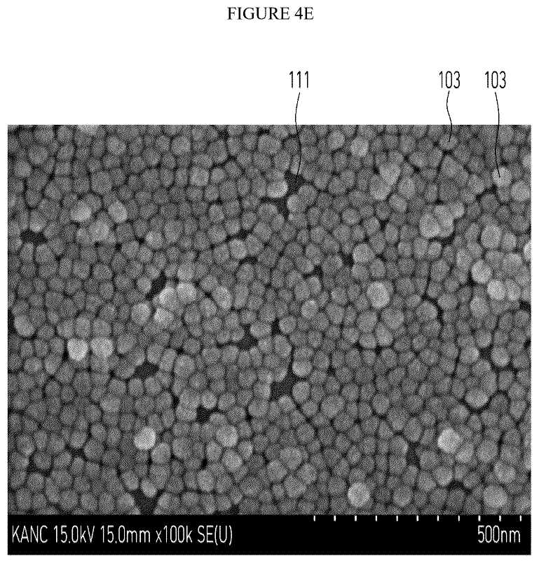

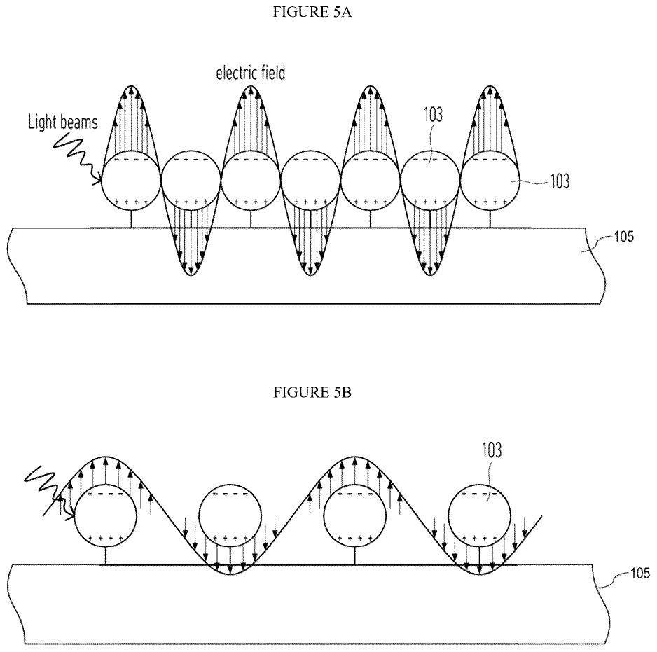

FIG. 5A conceptually illustrates an embodiment in which metal nanoparticles 103 are densely arranged and laterally contacting each other. FIG. 5B conceptually illustrates another embodiment in which metal nanoparticles 103 are laterally spaced apart from each other. When the metal nanoparticles are densely bound as in FIG. 5A, without being bound by any theories, it is believed that the electric fields from LSPR of individual nanoparticles combine by constructive interference and generate a combined electric filed that is much larger than those from individual nanoparticles that are apart from each other as in FIG. 5B.

### Making LSPR Catalyst with Networked Nanoparticles

### Networked Nanoparticles

As discussed above, metal nanoparticles may be formed over the supporting body in the form of networked nanoparticles to provide an LSPR catalyst. In the network of nanoparticles, two nanoparticles are interconnected via one or more ligands, and either of the nanoparticles may be interconnected with at least one nanoparticle via one or more ligands, which may continue further, as illustrated in FIGS. 1B-1E.

Making Networked Nanoparticles over Supporting Body

Networked nanoparticles may be formed over a supporting body by a sequential process, i.e., first making a nanoparticle network and subsequently bonding some nanoparticles of the network to a surface of the supporting body. Also, networked nanoparticles may be formed over a supporting body by a simultaneous process, i.e., performing networking of nanoparticles and bonding some nanoparticles of the network to a surface of the supporting body.

### Sequential Processes

A nanoparticle network may be formed using a ligand (first ligand) configured to interconnect between two metal nanoparticles as discussed above in connection with FIGS. 3A and 3B although not limited thereto. Subsequently, the nanoparticle network is attached to the supporting body with another ligand (second ligand) configured to interconnect between a metal nanoparticle and a surface of the supporting body as discussed above in connection with FIGS. 4A-4C although not limited thereto.

### Attaching Nanoparticle Network to Supporting Body—Scenario 1

The nanoparticle network may be attached to the supporting body by first causing the second ligand's substrate-bonding substituent group to contact the supporting body surface to bond the second ligand to the supporting body. Subsequently, the prepared nanoparticle network may be caused to contact the second ligand connected to the supporting body to form a bond between the metal bonding substituent group of the second ligand and at least part of nanoparticles of the prepared network.

### Attaching Nanoparticle Network to Supporting Body—Scenario 2

In the alternative, the second ligand may be caused to contact the prepared network, by which the meta-bonding substituent group of the second ligand may bond to at least part of metal nanoparticles of the prepared network. Subsequently, the supporting body may be caused to contact the networked nanoparticles with the second ligand, by which the supporting body surface bonds to the substrate-bonding substituent group of the second ligand bonded to the network's nanoparticles.

### Attaching Nanoparticle Network to Supporting Body—Scenario 3

Still in the alternative, the supporting body, the second ligand, and the prepared nanoparticle network may be caused to contact one another. Then, the second ligand bond to a metal nanoparticle of the network via the metal-boding substituent group. Also, the second ligand bond to a surface of the supporting body via the substrate-boding substituent group.

### Simultaneous Processes—One Ligand

In simultaneous processes, nanoparticle network may be formed while the supporting body bonds to at least some nanoparticles belonging to the network that is being formed. In one embodiment, individual or partially networked nanoparticles are mixed with a supporting body and a ligand that includes a first substituent group capable of bonding to a metal nanoparticle and a second substituent group capable of bonding to a metal nanoparticle and the supporting body surface (substrate). Then, some ligand molecules may interconnect between two nanoparticles as discussed above in connection with FIGS. 3A and 3B, which forms a nanoparticle network. Some other ligand molecules may interconnect between one nanoparticle and the supporting body surface to connect the nanoparticle network being formed to the supporting body.

### Simultaneous Process—Two Ligands

In another embodiment, individual or partially networked nanoparticles are mixed with a supporting body and two ligands (first and second ligands). The first ligand may be a network forming one configured to interconnect between two metal nanoparticles as discussed above in connection with FIGS. 3A and 3B. The second ligand may be configured to interconnect between a metal nanoparticle and the supporting body surface as discussed above in connection with FIGS. 4A-4C although not limited thereto.

### Mixing

In the processes presented in this disclosure, ligands may be caused to contact metal nanoparticles and the supporting body to form bonds between metal nanoparticles and between metal nanoparticles and a supporting body, etc. To facilitate reactions, ultrasound may be applied to the liquid mixture containing reactants. In addition or in the alternative, mechanical shaking or mixing may also be applied to the liquid mixture.

### Making LSPR Catalyst with Non-Networked Nanoparticles

LSPR with Non-Networked Nanoparticles

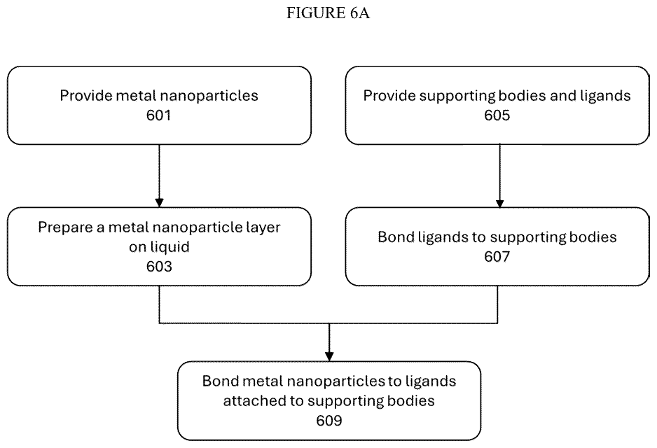

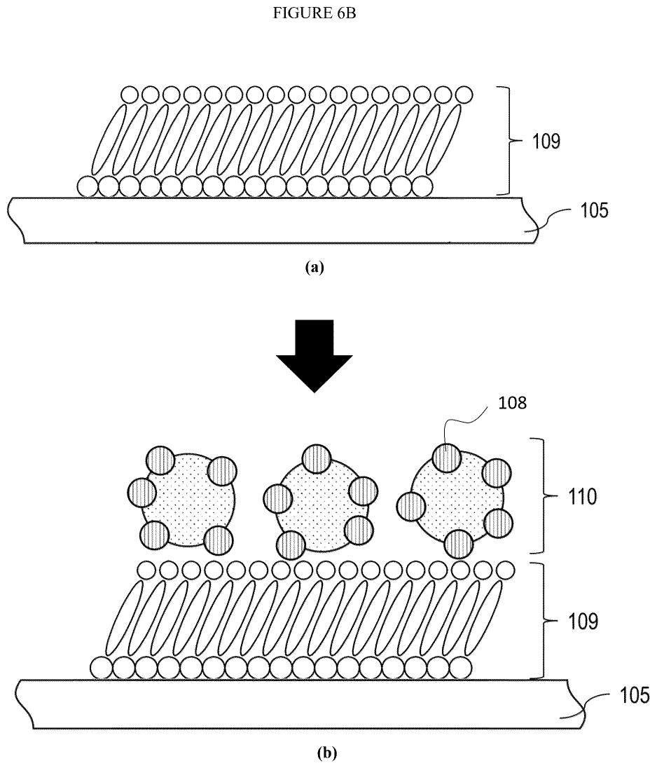

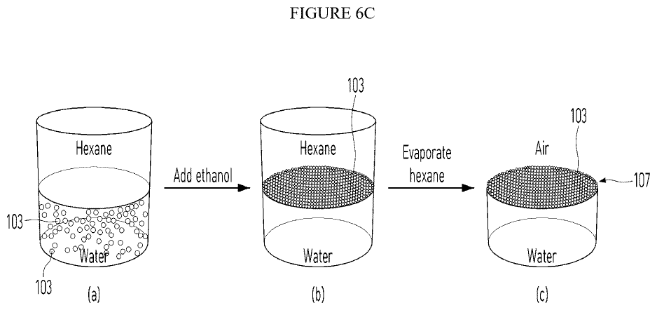

FIG. 6A is a process flowchart for making non-networked metal nanoparticles formed over a substrate according to one embodiment. First, metal nanoparticles are provided at STEP 601. Then, a layer of metal nanoparticles is prepared on liquid at STEP 603. The substrate and ligands are provided at STEP 605. Then, ligands are bonded to the substrate at STEP 607. Subsequently, the metal nanoparticles are bonded to a free end of one or more ligands attached to the substrate at STEP 609. In this process, ligands are bonded to the substrate first as in (a) of FIG. 6B, and then nanoparticles are bonded to the ligands as in (b) of FIG. 6B.

### Providing Metal Nanoparticles—STEP 601

The metal nanoparticles may be catalyst-decorated metal nanoparticles, metal nanoparticles without catalyst metal deposits thereon or a mixture of the two. The metal nanoparticles may be nanoparticles of a single plasmonic metal, a mixture of nanoparticles of two or more plasmonic metals, nanoparticles of an alloy of two or more plasmonic metals, core-shell nanoparticles, or a mixture of at least two of the foregoing. The metal nanoparticles may be decorated with catalytic metal deposits on their surfaces in accordance with options procedures therefor.

### Preparing Catalyst-Decorated Metal Nanoparticles

To prepare catalyst-decorated nanoparticles, first metal nanoparticles are dispersed in water or an aqueous solution. A precursor of the catalyst metal is added to the liquid containing the metal nanoparticles, which provides a liquid mixture including the metal nanoparticles and the precursor in water or aqueous solution. The precursor is a compound containing at least one catalytic meta. Some example precursors include copper (II) nitrate trihydrate (Cu(NO₃)₂·3H₂O), ruthenium (III) chloride trihydrate (RuCl₃·3H₂O), magnesium nitrate hexahydrate (Mg(NO₃)₂·6H₂O), aluminum nitrate nonahydrate (Al(NO₃)₂·9H₂O), or iron (III) nitrate nonahydrate (Fe(NO₃)₃·9H₂O). Subsequently, a reduction agent is added to the liquid mixture, which is then stirred. Following centrifugation and washing of the resulting mixture, precipitations are collected to provide catalyst-decorated metal nanoparticles, in which the catalytic metal reduced from the precursor is deposited on surface of the metal nanoparticles.

### Annealing or No Annealing

In some embodiments, the catalyst-decorated metal nanoparticles are not subject to annealing or a high temperature process that could fuse or form an alloy of the catalytic metal of the deposits and the plasmonic metal of the nanoparticles. Thus, no fusion or alloy is formed between the catalytic metal of the deposits and the plasmonic metal of the nanoparticles. In other embodiments, the catalyst-decorated metal nanoparticles are subject to annealing or a high temperature process to form fusion or alloy between the catalytic metal of the deposits and the plasmonic metal of the nanoparticles.

### Preparing a Layer of Metal Nanoparticles on Liquid—STEP 603

FIG. 6C illustrates a process of forming a layer of metal nanoparticles on water (or an aqueous solution) according to an embodiment. The metal nanoparticles prepared at STEP 601 are dispersed in deionized water to provide a metal nanoparticle aqueous solution, which is the bottom portion of (a) of FIG. 6C. Then, oil (e.g., hexane) is added to the metal nanoparticle aqueous solution in a container to form an oil/water two-phase interface, in which the hexane layer floats over the metal nanoparticle aqueous solution. See (a) of FIG. 6C. Subsequently, a surfactant (e.g., ethanol) is added to the oil/water two-phase interface, which causes the metal nanoparticles 103 to self-assemble and form a layer at the interface. See (b) of FIG. 6C. Subsequently, hexane is evaporated to expose the metal nanoparticles on the air-water interface. See (c) of FIG. 6C. Metal nanoparticles on water may form a monolayer 107, although not limited thereto. The metal nanoparticles in monolayer may laterally contact their immediately neighboring metal nanoparticles with or without some vacancies like those shown in FIGS. 4D and 4E.

### Preparing Supporting Bodies—STEP 605

At STEP 605, a supporting body is provided independent of STEPS 601 and 603, e.g., before, after or concurrently with either or both of preparing metal nanoparticles on liquid. The supporting bodies may be in balls, beads, spheroids, rods, chips, plates, or fibers. The supporting bodies may be prepared with a clean surface over which the ligands and nanoparticles are formed.

### Preparing Ligands—STEP 605

Also at STEP 605, ligand molecules are provided independent of STEPS 601 and 603, e.g., before, after or concurrently with either or both of preparing metal nanoparticles on liquid. The ligand includes a metal-bonding substituent group and a substrate-bonding substituent group. Subsequently, a liquid composition containing the ligand is prepared at a desired concentration of the ligand compound.

### Immobilizing Ligands Relative to Supporting Body Surfaces—STEP 607

At STEP 607, surfaces of the supporting bodies are caused to contact the liquid composition to let the ligand compound interact with in the surface materials of the supporting bodies. Then, the ligand compound reacts with one or more surface materials of the supporting body to form a chemical bond to the supporting body surfaces. In this process, many molecules of the ligand compound are attached to the supporting body surfaces and immobilized relative to the supporting body. As a result, a ligand-attached supporting body is provided as an intermediate device, in which the attached ligands have one or more free ends for later bonding to metal nanoparticles.

### Bonding Metal Nanoparticles to Ligands—STEP 609

The ligand-attached supporting body (intermediate device) from STEP 607 is submerged into the water passing the layer of metal nanoparticles in (c) of FIG. 6C. Subsequently, the intermediate device is lifted or taken out of the water. By these actions, the ligand-attached supporting body contacts metal nanoparticles as it passes the layer of metal nanoparticles on the way into the water and/or on the way out of the water. In this process, some of the metal nanoparticles floating on water contact the ligands attached to the supporting body surface and bond to at least one free end of the ligands, which substantially immobilizes the metal nanoparticles relative to the supporting body. Subsequently, the supporting body taken out of water is subject to drying to obtain an LSPR catalyst, i.e., metal nanoparticles formed over the supporting body surface in which the ligands are interposed between the supporting body and the metal nanoparticles as illustrated in FIGS. 1 and 4A-4D.

### Densely Bound Nanoparticles

As discussed above, the metal nanoparticles may be densely bound together or laterally contact with one another as illustrated in FIGS. 1, 4D and 4E. At STEP 607, the concentration of the ligands in the liquid composition may be adjusted at a desired level. To accomplish a high density of the nanoparticles, the concentration of ligands is adjusted sufficiently high to make the supporting body surface overcrowded with the ligands in the ligand-attached supporting body. As illustrated in FIG. 1, the supporting body surface may be almost packed with ligands. With the overcrowded or packed ligands on the supporting body surface, scooping of metal nanoparticles on the supporting body surface at STEP 609 would likely make metal nanoparticles densely bound and laterally contact as shown in FIGS. 1, 4D and 4E, although not limited thereto.

Alternative Process for LSPR with Non-Networked Nanoparticles

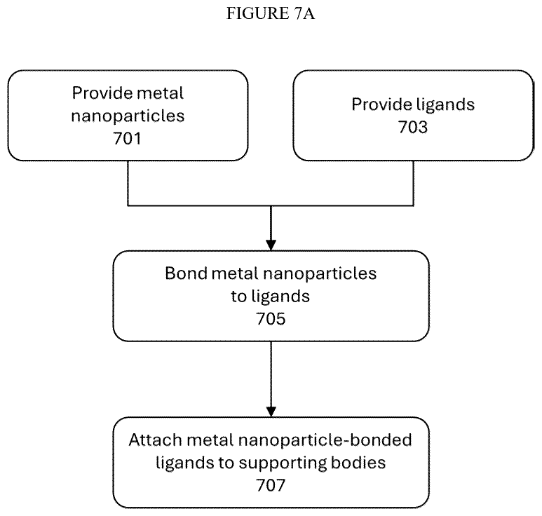

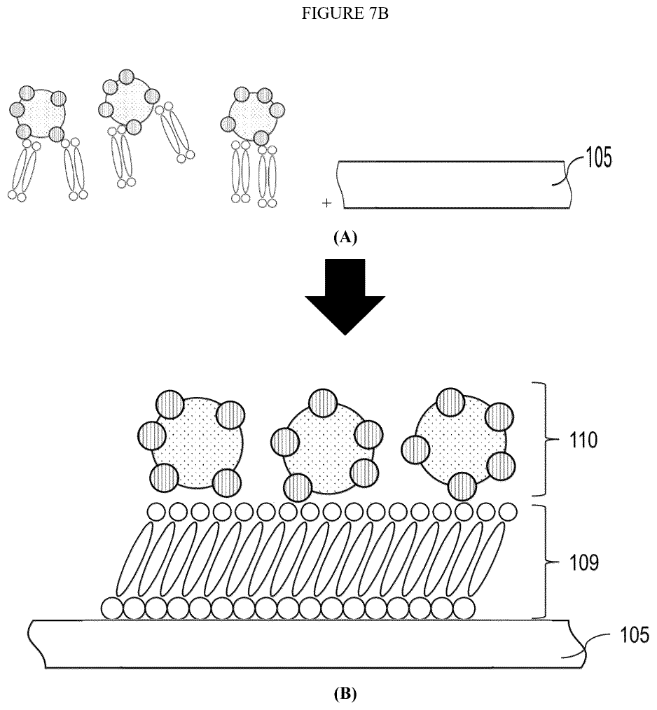

FIG. 7A is a process flow chart for making metal nanoparticles formed over a substrate according to another embodiment. The discussions above in connection with the process of FIG. 6A are applicable to the process of FIG. 7A unless specifically discussed otherwise. The process of FIG. 7A differs from FIG. 6A in that the ligands are bonded to metal nanoparticles before they are bonded to the substrate. In this process, metal nanoparticles are provided at STEP 701 in the same or similar fashion as discussed in connection with STEP 601. At STEP 703, ligands are provided in the same or similar fashion as discussed in connection with STEP 605. Subsequently at STEP 705, the ligands are bonded to metal nanoparticles. Subsequently at STEP 707, a layer of ligand-bonded metal nanoparticles is prepared on liquid. Further subsequently at STEP 709, metal nanoparticle-bonded ligands are attached to the substrate to provide the LSPR catalyst. In this process, as compared to FIGS. 6A and 6B, ligands are bonded to metal nanoparticles first as in (a) of FIG. 7B, and then nanoparticle-bonded ligands are bonded to the substrate as in (b) of FIG. 7B.

### Bonding Ligands to Nanoparticles—STEP 705

At STEP 705, ligands are bonded to metal nanoparticles. For example, metal nanoparticles are added to a liquid composition containing ligand molecules, in which the metal-bonding substituent group of the ligand molecule bonds to the surface of a metal nanoparticle. As a result, one or more ligand molecules bond to a single metal nanoparticle as illustrated in FIG. 7B.

### Immobilizing Nanoparticle-Bonded Ligands to Supporting Bodies—STEP 707

At STEP 707, the ligands are bonded to metal nanoparticles are attached to the substrate. The nanoparticle-bonded ligands obtained from STEP 705 are added to a liquid phase containing at least one supporting body. Then, the substrate-bonding substituent group of at least part of the ligand compounds bond to the surface of the at least one supporting body. As a result, non-networked nanoparticles are formed over the surface of the at least one supporting body with the ligands intervening therebetween as illustrated in FIG. 7C.

### Glass Fiber Filter LSPR Catalyst

### Glass Fiber Filter

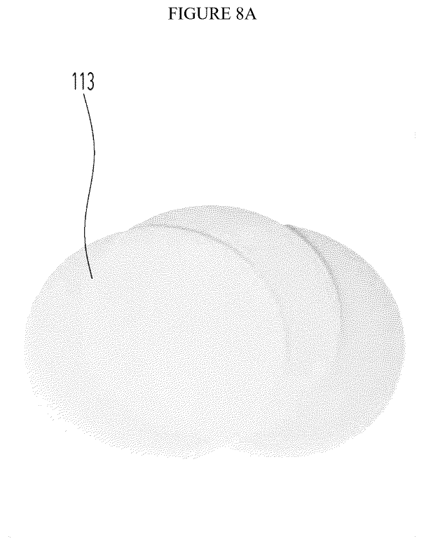

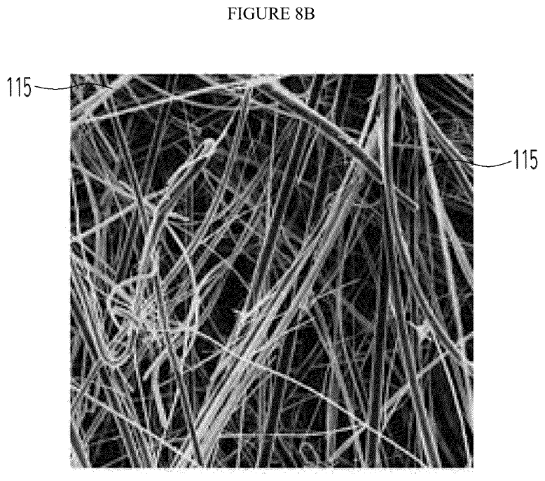

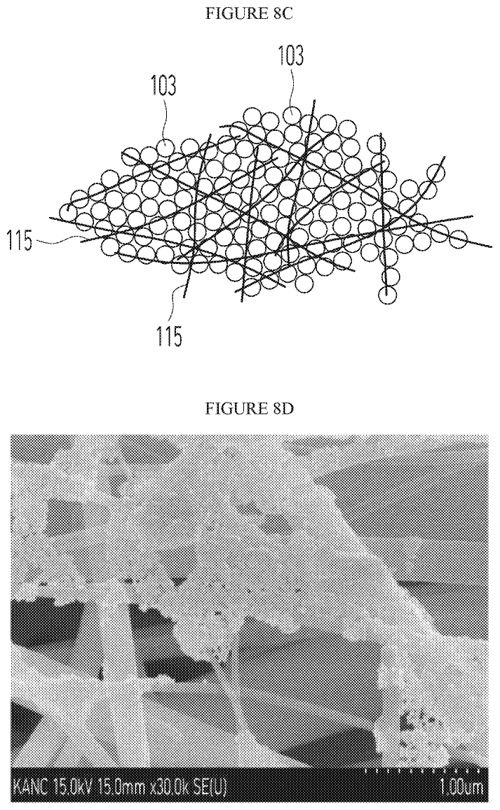

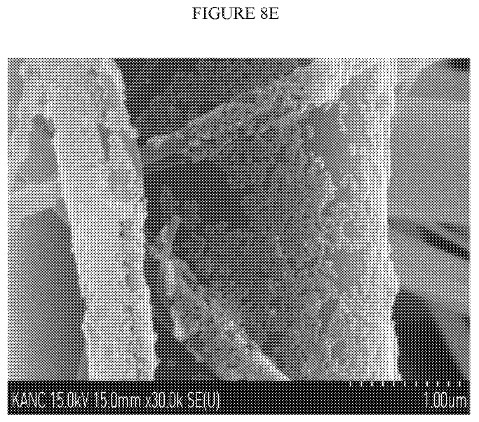

A glass fiber filter 113 may be used to provide the support body or substrate for an LSPR catalyst. A glass fiber filter is a porous filter in the shape of sheet or paper as shown in FIG. 8A. The glass fiber filter or glass fiber filter sheet is made of or contains borosilicate glass fibers with or without a binder and other ingredients. FIG. 8B is a microscopic view of the interior of a glass fiber filter of FIG. 8A, in which glass fibers 115 are randomly entangled to form a network.

### Glass Fibers as Supporting Body

Glass fibers inside a glass fiber filter may work as the supporting body having circumferential surfaces, over which metal nanoparticles or are formed with ligands interposed between the circumferential surfaces and nanoparticles. The glass fibers have a micro-sized diameter, e.g., between about 1 μm and about 10 μm although not limited thereto. Given the size difference between the circumference of the glass fibers and the metal nanoparticles, metal nanoparticles are attached to the glass fibers via ligands and immobilized relative to the glass fibers.

### Glass Fiber Filter LSPR Catalyst

The metal nanoparticles formed on circumferences of glass fibers provides a glass fiber filter LSPR catalyst. The metal nanoparticles may be networked or non-networked. FIG. 8C conceptually illustrates metal nanoparticles formed over circumferences of glass fibers 115 inside a glass fiber filter, which provides a glass fiber filter LSPR catalyst. FIGS. 8D and 8E are photographs of metal nanoparticles 103 formed over glass fiber circumferences. When the glass fiber filter LSPR catalyst is illuminated, light beams may enter the glass fibers, transmit through the glass fibers, and reach the metal nanoparticles that are bonded to the glass fibers via ligands.

### Making Glass Fiber Filter LSPR Catalyst

The glass fiber filter LSPR catalyst may be prepared using any method presented in this disclosure or any other appropriate method the process. For example, a glass fiber filter is subject to contacting or immersed into a liquid composition containing a ligand compound. When the glass fiber filter is immersed in the liquid composition, molecules of the ligand compound (ligands) contact glass fibers inside the glass fiber filters and bond to circumferential surfaces of glass fibers. As a result, a ligand-attached glass fiber filter (an intermediate device) is formed, in which ligands are attached to circumferential surfaces of glass fibers of the glass fiber filter. Subsequently, the ligand-attached glass fiber filter is submerged into the water passing the layer of metal nanoparticles as in (c) of FIG. 6C and then lifted out of the water. By this process, some the metal nanoparticles floating on water may contact ligands attached to glass fiber circumferences inside the ligand-attached glass fiber filter. A glass fiber filter LSPR catalyst is formed when metal nanoparticles bond to ligands on the glass fiber circumferences. See FIG. 8C.

### Glass Bead LSPR Catalyst

### Glass Bead LSPR Catalyst

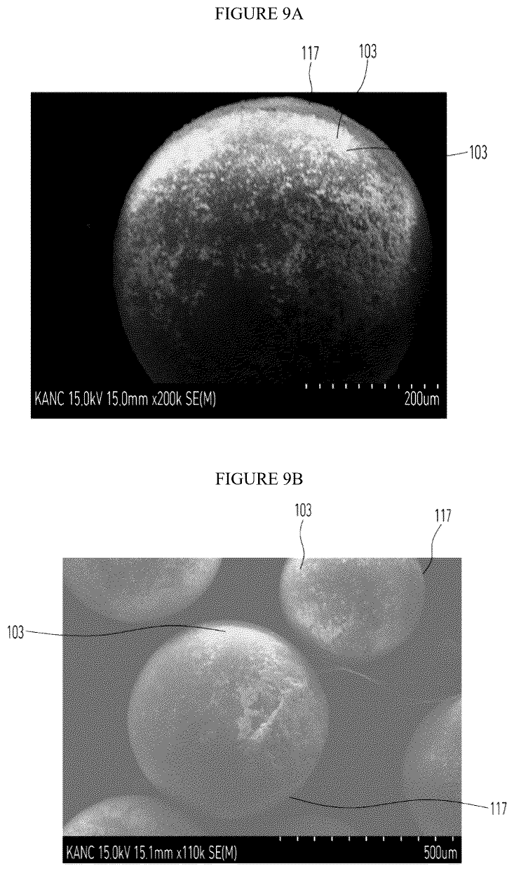

Glass beads 117 may be used as a supporting body(s) for an LSPR catalyst. A glass bead is a bid made of or containing glass or a silica material. The glass beads for the LSPR catalyst are generally round or spherical shape although not perfect and not limited thereto. For example, beads are in spheres, spheroids, round-cornered cubes, etc. To provide a glass bead LSPR catalyst, metal nanoparticles 103 are formed over surfaces of a glass bead with ligands interposed between metal nanoparticles and bead surfaces. The metal nanoparticles may be networked or non-networked. In some embodiments, metal nanoparticles may cover substantially entire surfaces of a glass bead. In other embodiments, metal nanoparticles may cover only some portions of the surfaces of the glass bead. FIGS. 9A and 9B are photographs of glass bead LSPR catalysts in which metal nanoparticle are formed and immobilized in at least some portions of the bead surfaces.

### Bead Size

The beads for the LSPR catalyst have a diameter of about 1, 5, 10, 20, 30, 40, 50, 60, 70, 80, 90, 100, 150, 200, 250, 300, 350, 400, 450, 500, 550, 600, 650, 700, 750, 800, 850, 900, 950, 1000, 1050, 1100, 1150, 1200, 1250, 1300, 1350, 1400, 1450, 1500, 1550, 1600, 1650, 1700, 1750, 1800, 1850, 1900, 1950, 2000, 2050, 2100, 2150, 2200, 2250, 2300, 2350, 2400, 2450, 2500, 2550, 2600, 2650, 2700, 2750, 2800, 2850, 2900, 2950, or 3000 μm, although not limited thereto. In embodiments, the diameter may be within a range formed by any two numbers listed in the immediately previous sentence. For example, the diameter is between about 200 μm and about 1000 μm, between about 400 μm and about 1200 μm, between about 500 μm and about 1500 μm, etc.

### Transparency

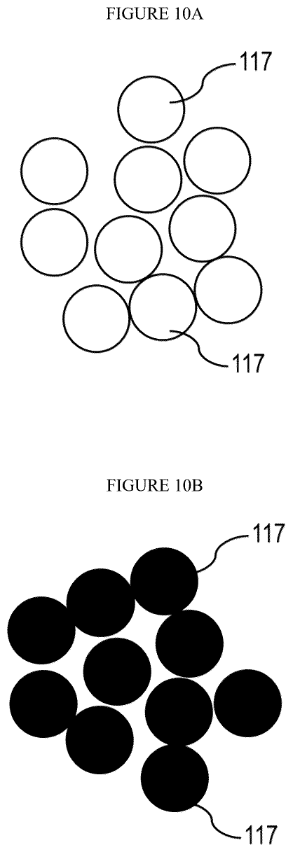

The beads for the LSPR catalyst may be optically transparent, translucent, or opaque. The beads 117 may be originally transparent before coating metal nanoparticles as in FIG. 10A. The glass bead LSPR catalyst including metal nanoparticles over the bead surfaces may be opaque as in FIG. 10B. As illustrated in FIG. 10C, the glass bead LSPR catalyst may include a mixture of the glass bead LSPR catalyst of FIG. 10B and glass beads of FIG. 10A without metal nanoparticles.

### Making Glass Beads LSPR Catalyst

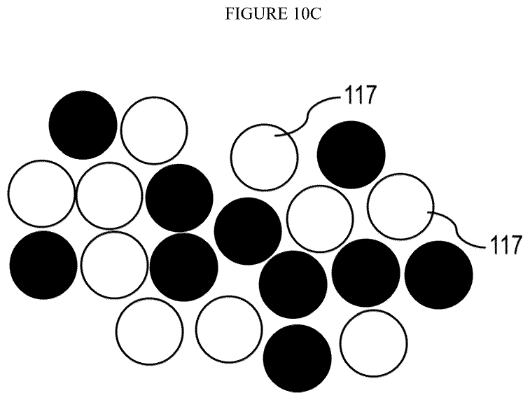

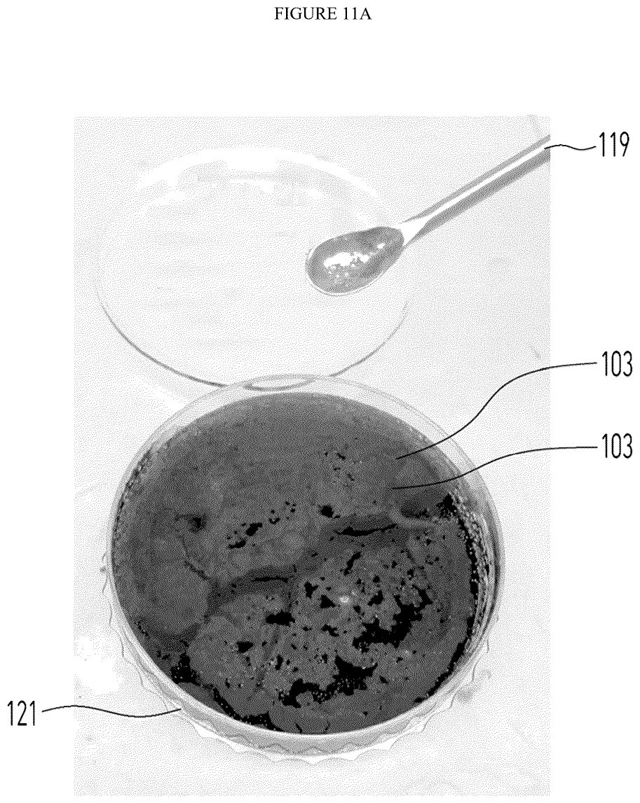

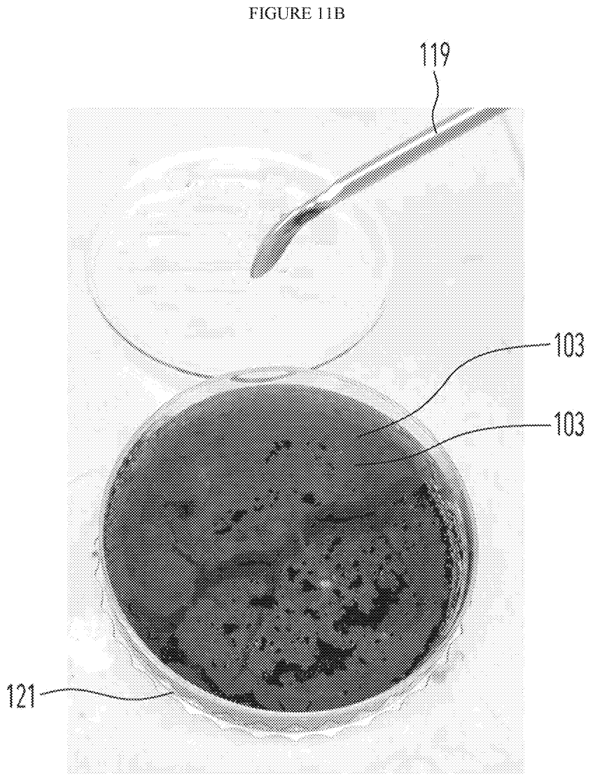

The glass beads LSPR catalyst may be prepared using any method presented in this disclosure or any other appropriate method the process. For example, glass beads are added to a liquid composition containing a ligand compound. Then, the ligand molecules (ligands) contact and bond to surfaces of the glass beads. As a result, the ligands are attached to surfaces of the glass bead, and a ligand-attached glass bead (an intermediate bead device) is formed. Subsequently, the ligand-attached glass bead is immersed into the water passing the layer of the metal nanoparticles as in (c) of FIG. 6C. If the ligand-attached glass bead is too light, it may not go into the water passing the layer of metal nanoparticles. The ligand-attached glass bead may be dropped from above the metal nanoparticles floating on water at a level high enough to make sure that the ligand-attached (ligand coated) glass bead goes into the water passing the layer of metal nanoparticles. FIG. 11A is a photograph immediately before dropping, in which ligand-attached glass beads are kept in a laboratory spoon 119 at a level over a petri-dish 121 containing the metal nanoparticles (black) 103 floating on water. FIG. 11B is a photograph when or immediately after dropping the ligand-attached glass beads from the laboratory spoon into the water. By this process, some of the metal nanoparticles floating on water may contact and bond to the ligands on the glass bead surfaces. A bead LSPR catalyst is formed when metal nanoparticles bond to ligands on the surfaces of the glass bead.

### Glass Rod LSPR Catalyst

### Glass Rod LSPR Catalyst

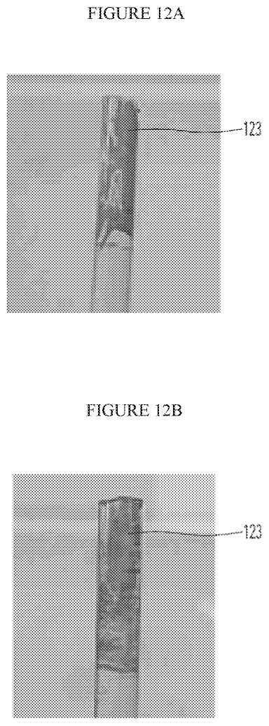

Glass rods may be used as a supporting body for an LSPR catalyst. A glass rod is an elongated bar or stick made of or containing a silica material. The glass rod 123 for the LSPR catalyst is generally in a cylindrical shape, although not limited thereto. The glass rod has a cross-section taken in a plane perpendicular to its length direction, and the cross-section is in the shape of a circle, oval, polygon, round-cornered polygon etc., although not limited thereto. To provide a glass rod LSPR catalyst, metal nanoparticles are formed over circumferential surfaces of a glass rod with ligands interposed between metal nanoparticles and the circumferential surfaces. The metal nanoparticles may be networked or non-networked. In some embodiments, metal nanoparticles may cover substantially entire circumferential surfaces of a glass rod. In other embodiments, metal nanoparticles may cover only some portions of the circumferential surfaces of the glass rod. FIGS. 12A and 12B are photographs of glass rod LSPR catalysts, in which metal nanoparticles are formed in only some portions (gray portions) of the circumferential surfaces of the glass rod.

### Size

The glass rods may have any length while glass rods with different lengths are used for different purposes or contexts. The glass rods have diameter or length in a cross-sectional taken in a plane perpendicular to its length direction. The glass rods may have a cross-sectional diameter or length of about 0.5, 1, 1.5, 2, 2.5, 3, 3.5, 4, 4.5, 5, 5.5, 6, 6.5, 7, 7.5, 8, 8.5, 9, 9.5, 10, 12, 14, 16, 18, 20, 22, 24, 26, 28, 30, 32, 34, 36, 38, 40, 42, 44, 46, 48, 50, 52, 54, 56, 58, 60, 62, 64, 66, 68, 70, 72, 74, 76, 78, 80, 82, 84, 86, 88, 90, 92, 94, 96, 98, 100, 105, 110, 115, 120, 125, 130, 135, 140, 145, 150, 160, 170, 180, 190, 200, 220, 240, 260, 280, or 300 mm, although not limited thereto. In embodiments, the cross-sectional diameter or length may be within a range formed by any two numbers listed in the immediately previous sentence. For example, the cross-sectional diameter or length is between about 1 mm and about 10 mm, about 10 mm and about 50 mm, and about 3 mm and about 20 mm, etc.

### Making Glass Rod LSPR Catalyst

The glass rod LSPR catalyst may be prepared using any method presented in this disclosure or any other appropriate method the process. For example, a glass rod is subject to contacting to a liquid composition containing a ligand compound. Then, the ligand molecules (ligands) contact and bond to circumferential surfaces of the glass rod. As a result, the ligands are attached to circumferential surfaces of the glass rod, and a ligand-attached glass rod (an intermediate device) is formed. Subsequently, the ligand-attached glass rod is immersed into the water passing the layer of the metal nanoparticles in (c) of FIG. 6C. By this process, some of the metal nanoparticles floating on water may contact and bond to the ligands on the glass rod surfaces. A glass rod LSPR catalyst is formed when metal nanoparticles bond to ligands on the circumferential surfaces of the glass rod.

### Glass Chip LSPR Catalyst

### Glass Chip LSPR Catalyst

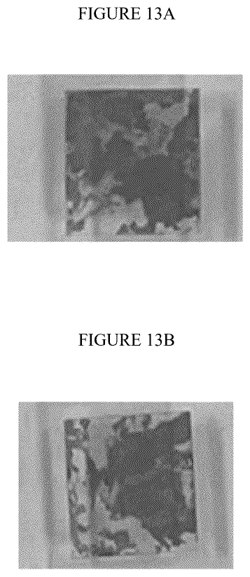

Glass chips may be used as a supporting body for an LSPR catalyst. A glass chip refers to a chip or piece containing a silica material in any shape and in any size. Metal nanoparticles may be networked or non-networked. The nanoparticles may cover only some portions of the chip surfaces or may cover a substantially entire surface of the chip. Glass chip LSPR catalysts may be prepared generally in the same way as other LSPR catalyst are prepared. FIGS. 13A and 13B are photographs of glass chip LSPR catalysts in which metal nanoparticles are formed in only some portions (gray portions) of the circumferential surfaces of the glass rod.

Glass Chip LSPR Catalyst with Through Holes

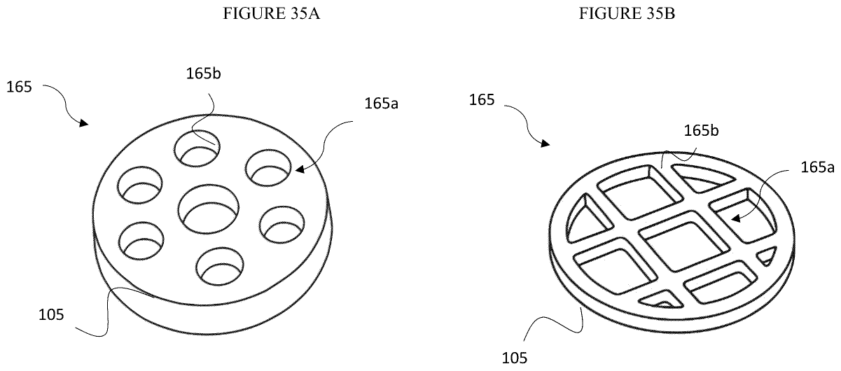

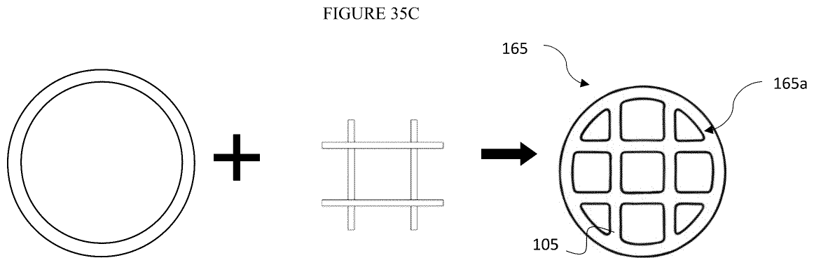

The glass chip LSPR catalyst may include through-holes 165a in the glass chip body or substrate 105 as illustrated in FIGS. 35A-35C forming a glass chip LSPR catalyst 165. Through-holes 165a increase the surface area of the glass chip support body for the LSPR catalyst and provide channels for passing gas therethrough as discussed later in light of the use of the catalyst. FIG. 35A shows a circular disc with multiple circular shape through-holes 165a evenly spaced across the surface, and FIG. 35B shows a disc-type support body having a grid-patterned structure with intersecting channels or rectangular through-holes 165a.

### Hole Variation

The number, size, and shape of the through-holes formed in the substrate 105 are not limited to the illustrated examples and may vary. For example, although FIG. 35A depicts uniformly spaced through-holes of uniform size, the holes may alternatively be irregular in spacing and size. The shape of the through-holes is also not limited and may include circular, rectangular, triangular, cross-shaped, irregular, or other geometries. The number and size of the holes can affect performance characteristics; for instance, a greater number of smaller holes can increase the total surface area, thereby providing more ligand attachment sites and enabling a higher density of nanoparticles to be supported on the glass surface. Additionally, the interior surfaces of the through-holes may differ in texture and may be smooth, roughened, or comprise a combination thereof.

### Fabrication of Through-holes

In some embodiments, through-holes may be formed in the glass material using techniques such as laser processing, etching, or drilling, resulting in a perforated structure. Different fabrication methods may be used depending on the hole shape and pattern; for instance, the holes in FIG. 35A may be formed by mechanical drilling, while those in FIG. 35B may be produced using laser cutting. FIG. 35C illustrates a glass catalyst support having a mesh-type structure. In this example, the glass catalyst may be formed by integrating a glass ring with a mesh structure, which may be fabricated using methods such as laser cutting.

### Through-Hole Glass Catalyst

In some embodiments, the glass chip LSPR catalyst 165 includes a glass support body or substrate 105 incorporating through-holes 165a, as shown in FIGS. 35A and 35B. Metal nanoparticles are connected to the glass surface of the supporting body with through holes via ligands such that some of the metal nanoparticles are formed on the top and bottom surfaces of the glass chip and further on at least part of inner surfaces 165b of the through-holes 165a.

### Glass Surface Treatment

Glass Chip LSPR Catalyst with Surface Texture

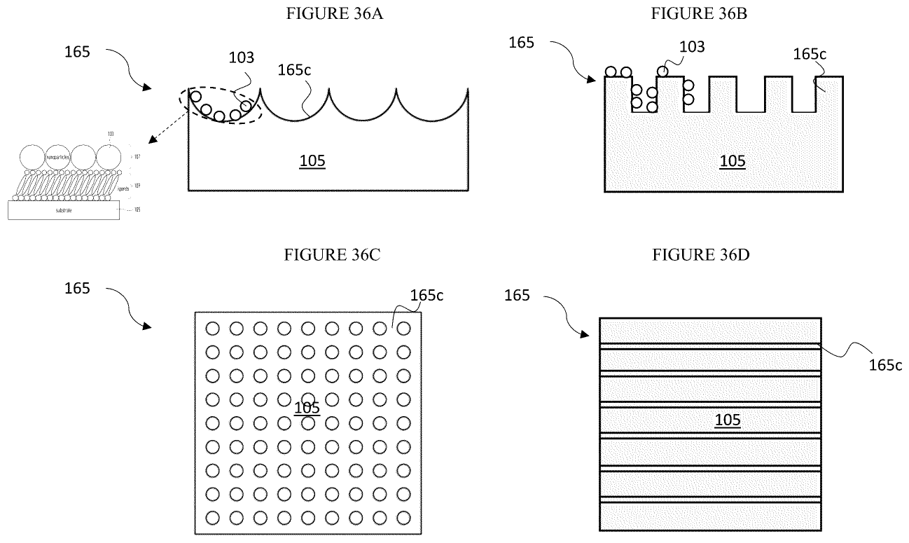

A surface 165c of the glass chip body 105 may be treated to form various textures that increase surface roughness and surface area. The surface treatment may be applied to any of the glass materials described herein, including but not limited to glass beads, glass rods, glass chips, and other glass substrates, and further glass chips having through holes. FIGS. 36A and 36B illustrate side views of surface-treated glass catalysts according to embodiments, and FIGS. 36C and 36D illustrate top views of surface-treated glass catalysts.

### Surface Texture

The glass catalysts 165 may have a concave wave-like pattern formed by a sequence of curved recesses as shown in FIG. 36A. The curvature, depth, and spacing of the recesses can differ in various embodiments. In some embodiments, a convex pattern, rather than the concave shape, may be formed. FIG. 36B depicts a stepped pattern with repeating rectangular or square grooves. The width, depth, spacing, and number of the grooves may also be varied. FIG. 36C illustrates an array of circular pores or pits that are uniformly distributed across the surface. The size, number, and spacing of the pores can be tailored, and although shown as circular, the pore shapes may include triangles, rectangles, diamonds, octagons, or irregular forms. In some embodiments, the glass catalysts may have a linear pattern consisting of multiple parallel channels as shown in FIG. 36D. These channels may be straight, wavy, or zigzag, and their thickness and spacing can be varied. The examples in FIGS. 36A to 36D are illustrative and not limited, but other uniform or non-uniform surface textures may also be used.

### Glass Surface Treatment Techniques

The above-described glass treatment can be achieved using various techniques including but not limited to, wet etching with hydrofluoric acid, powder blasting with fine particles, laser patterning, and mechanical processing (e.g., drilling and milling) can be. These methods can help create specific patterns or rough textures on the glass without perforating it. In some embodiments, the treated surface may further be modified by applying a coating or by subjecting it to a heat treatment process.

### Increased Surface Areas

Surface-treated glass chips or catalyst substrates exhibit increased surface areas for the attachment of nanoparticles via ligands. As illustrated in FIG. 36A, the wave-like concave structures provide multiple curvature sites for nanoparticles to adhere, allowing for dense and stable surface coverage. In FIG. 36B, step-like grooves or recesses offer defined regions for the nanoparticle attachment. The vertical and horizontal sections of each groove provide more surface contacts for nanoparticles to adhere. The surface textures increase the physical and/or chemical interaction areas.

### Scattering Light

Light beams applied to the glass catalysts 165 may be scattered on the treated surfaces 165b thereof, as they enter the body and the treated surfaces. These surface treatments increase irregularities and refractive interfaces on the surface, causing incident light to be diffusely reflected and scattered in multiple directions. This light scattering increases light distribution activity.

### Flow Reaction System

### Continuous Flow Reaction System

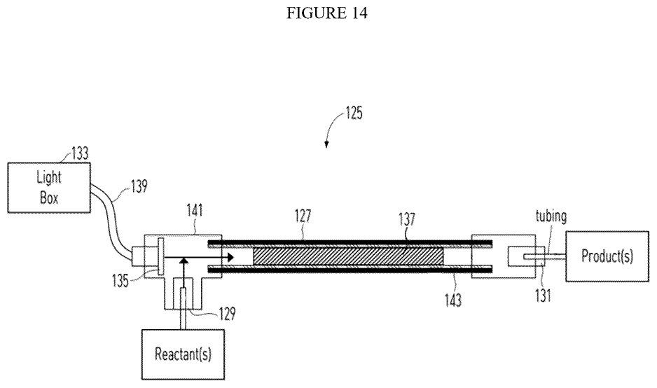

One aspect of the disclosure and its embodiments provide a flow reaction system 125 for a chemical reaction. In the flow reaction system, at least one reactant flows through a continuous flow reactor or simply a flow reactor 127, in which the chemical reaction occurs. FIG. 14 illustrates a continuous flow reaction system in accordance with embodiments.

### Flow Reactor

FIG. 14 illustrates the flow reaction system 125 with a cross-sectional view of the flow reactor. In the illustrated embodiment, the flow reactor is a pipe or elongated tube having an inlet or upstream end 129 to the left of the drawing and an outlet or downstream end 131 to the right of the drawing. A chemical reaction may occur while at least one reactant is flowing through the reactor in a flow direction from the inlet toward the outlet inside the flow reactor. The pipe or tube of flow reactor may be made of any materials appropriate for the chemical reaction. The pipe or tube may be transparent, translucent or opaque. For example, the pipe or tube is made of one or more materials selected from the group consisting of stainless steel, carbon steel, copper, plastic such as polyvinyl chloride, chlorinated polyvinyl chloride, polyethylene, polypropylene, etc., cast iron, brass, bronze, ductile iron, aluminum, etc.

### Size of Flow Reactor

The size of the flow reactor can vary depending upon the scale of the chemical reaction therein. The pipe of flow reactor has a cross-sectional diameter of about 1, 2, 3, 4, 5, 6, 7, 8, 9, 10, 12, 14, 16, 18, 20, 25, 30, 35, 40, 45, 50, 55, 60, 65, 70, 75, 80, 85, 90, 95, 100, 110, 120, 130, 140, 150, 160, 170, 180, 190 or 200, although not limited thereto. In embodiments, the cross-sectional diameter may be within a range formed by any two numbers listed in the immediately previous sentence. For example, the cross-sectional diameter is between about 2 mm and about 10 mm, about 2 mm and about 100 mm, and about 20 mm and about 1200 mm, etc.

### Reactant(s) Supply and Product(s) Collector

In the illustrated embodiment, a reactant supply is connected to the flow reactor at the inlet via a connecting adaptor. The reactant supply is to supply at least one reactant into the flow reactor. The reactant supply may include a container for containing at least one reactant and a control valve for controlling the flow rate and/or pressure of the reactant. Depending upon the chemical reaction and the at least one reactant, the system may include multiple reactant supplies. A product collector may be connected at the outlet and receives product(s) of the chemical reaction and also any remaining reactant(s) discharged there.

### Light Box

A light box 133 is connected to the flow reactor via an optical fiber. The light box is a light source for generating light beams to be supplied into the flow reactor. The light box may generate light beams with wavelengths that can excite free electrons in metal nanoparticles of the LSPR catalyst. Any light source may be used for the light box as long as it generates light beams with wavelengths for LSPR in the metal nanoparticles and sufficient intensity for the system. The light source for the light box may be laser, LED, sunlight, halogen bulb/lamp, tungsten-halogen lamp, metal halide bulb, incandescent bulbs, neon lamp, HID lamp (high-intensity discharge lamp), etc. although not limited thereto.

### Transparent Seal

A transparent seal 135 may be provided between the optical fiber 139 and the flow reactor 127. The transparent seal 135 provides airtight sealing at the junction between the optical fiber 139 and the flow reactor while allowing the light beams from the light box 133 to be transmitted to into inside the flow reactor 127. The light beams may be directed to an irradiation direction substantially perpendicular to an incident surface of the transparent seal. The irradiation direction may be generally aligned to the flow direction and the length direction of the flow reactor.

### Union Tee

The union tee 141 is a connector connected to the light source, reactant supply and flow reactor with or without at least one adaptor. The connector receives at least one reactor and light beams and provides a channel to the flow reactor.

### LSPR Catalyst Device

The LSPR catalyst device 137 includes one or more various LSPR catalysts whether presented or not in this disclosure. At least one LSPR catalyst device is placed inside the flow reactor. Upon illuminated with light beams, the LSPR catalyst(s) in the LSPR catalyst device is to generate LSPR electric field which it to facilitates the chemical reaction by transferring LSPR energy to the reactant(s) that contact or are present in close proximity to nanoparticles of the LSPR catalyst device. Some embodiments of the LSPR catalyst devices are discussed below in more detail. The at least one LSPR catalyst device may be in a single unit or multiple units. The at least one LSPR catalyst may be arranged along the flow direction to contact the at least one reactant at various location in the flow direction for the chemical reaction.

### Transparent Channel Along LSPR Catalyst Device

The flow reaction system provides an optically transparent channel for facilitating the transmission or propagation of light beams inside the flow reactor toward the downstream end. The transparent channel may be provided at least part of or throughout the extension of the LSPR catalyst device(s) toward the outlet of the pipe such that more light beams can reach therethrough a point in the length direction than the same flow reaction system except that no such transparent channel is affirmatively provided. As will be discussed further, the transparent channel may be formed inside the LSPR catalysts and/or between the LSPR catalysts device and the interior surface(s) of the pipe.

### Mirror

In the illustrated embodiment, where light beams are supplied from one end of the flow reactor 127, the interior surface or exterior surface of the flow reactor may be mirror-cladded for reflecting light beams incident thereto. All or most of the light beams reflected on the mirror 143 are kept inside the flow reactor 127 and redirected to the LSPR catalyst device. A mirror may be provided on the entire interior or exterior surface or partially on select areas of the interior surface. Alternatively, in some embodiments, no mirror is provided on the interior surface.

### Exterior Light Sources

Although not illustrated, the flow reaction system 125 may include one or more additional light sources that are located outside the flow reactor 127. Light beams from the exterior light sources may be directed to the flow reactor 127 for illuminating the LSPR catalyst located inside the flow reactor 127. The exterior light sources in addition to light box are to provide light beams for maximizing LSPR throughout where the LSPR catalyst device is located inside the flow reactor. The exterior light source(s) may be applicable to any additional flow reaction system discussed in this disclosure.

Designs with Additional Light Sources

When exterior light sources are provided, the flow reactor 127 is made of a transparent material with regard to the light beams from the additional light sources such that the light beams enter the inside of the flow reactor 127. In case the interior surface of the flow reactor 127 is mirror-cladded, the mirror cladding is formed such that light beams incident to the flow reactor from outside may enter the inside the flow reactor through the mirror cladding while the mirror cladding effectively reflects light beams incident thereto from inside. The technical designs discussed in this paragraph may be applicable to any additional flow reaction system discussed in this disclosure.

### Multiple Reactor System

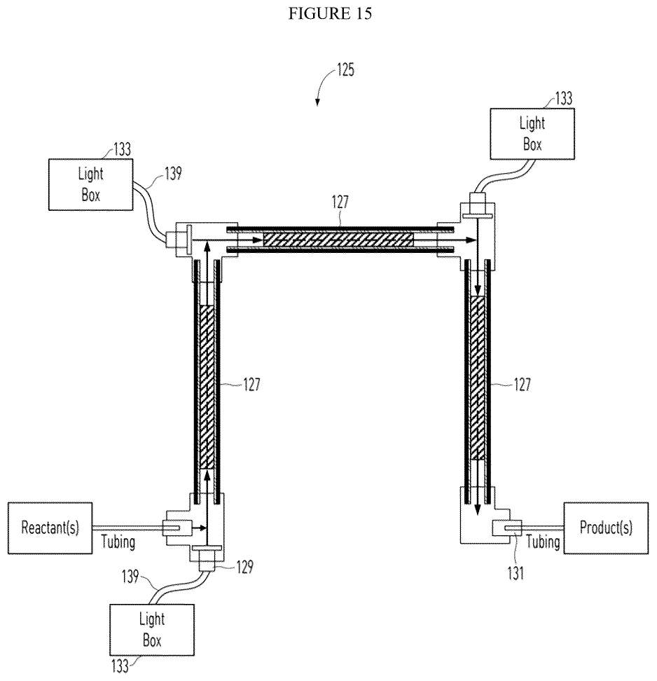

One aspect of the disclosure and its embodiments provide a flow reaction system 125 with multiple flow reactors. FIG. 15 illustrates a flow reaction system with three flow reactors 127 and multiple light boxes 133 in accordance with an embodiment. All the discussions above in connection with the flow reaction system and its components are applicable to the multiple reactor system.

### Connection of Multiple Flow Reactors

Referring to FIG. 15, three flow reactors form a serial connection for fluid connection through the three flow reactors 127. As illustrated, the light box 133 and reactant supply are connected to the inlet 129 of the flow reactor 1, the outlet of the flow reactor 1 is connected to the inlet of the flow reactor 2, the outlet of the flow reactor 2 is then connected the inlet of the flow reactor 3, and the outlet 131 of the flow reactor 3 is connected to the product collector. In some embodiments, more flow reactors can be connected to form additional serial connections for fluid communication throughout the flow reactors. In other embodiments, at least one of the multiple flow reactors in serial connection may be replaced with multiple flow reactors in parallel connection. For example, two flow reactors 2-1 and 2-2 may replace the flow reactor 2 such that the outlet of the flow reactor 1 is connected to both inlets of flow reactor 2-1 and 2-2 and further both outlets of flow reactor 2-1 and 2-2 are connected to the inlet of the flow reactor 3.

### Multiple Light Supplies and Direction of Light Beams

Referring to FIG. 15, three light boxes are connected to the system such that each light box is connected to one of the three flow reactors, although not limited thereto. Each light box generates light beams for sending light beams into one of the flow reactors. For each flow reactor, connector parts such as optical fiber, transparent sealing and the union tee may be arranged to direct the light beams in the irradiation direction that is generally in parallel alignment with the flow direction of the particular flow reactor.

### Angled Connection Between Two Consecutive Flow Reactors

Two consecutively connected flow reactors may extend along axes that are generally perpendicular as illustrated in FIG. 15. More generally, two consecutively connected flow reactors extend along different axes with an angle therebetween although not limited thereto. Given the tubing connection requirements between the two flow reactors and the straightness of light beams, this angled connection make it possible or easier to direct light beams in parallel with the flow direction for the later one of the two consecutive flow reactors. The angle may be about 10, 15, 20, 25, 30, 35, 40, 45, 50, 55,60, 65, 70, 75, 80, 85 or 90°, although not limited thereto. The angle may be within a range formed by any two numbers listed in the immediately previous sentence. For example, the angle is between about 45° and about 90°, between about 20° and about 60°, and between about 10° and about 30°, etc.

### Single Glass Rod LSPR Catalyst Device

### Single Glass Rod LSPR Catalyst Device

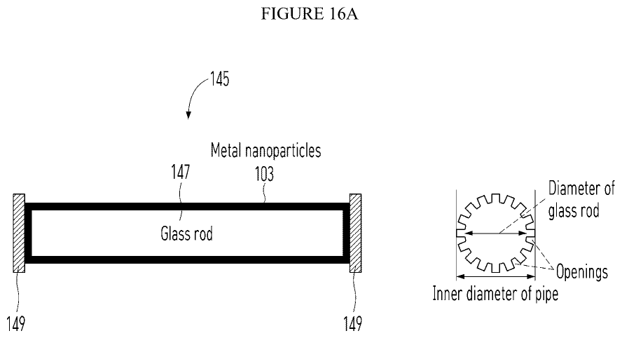

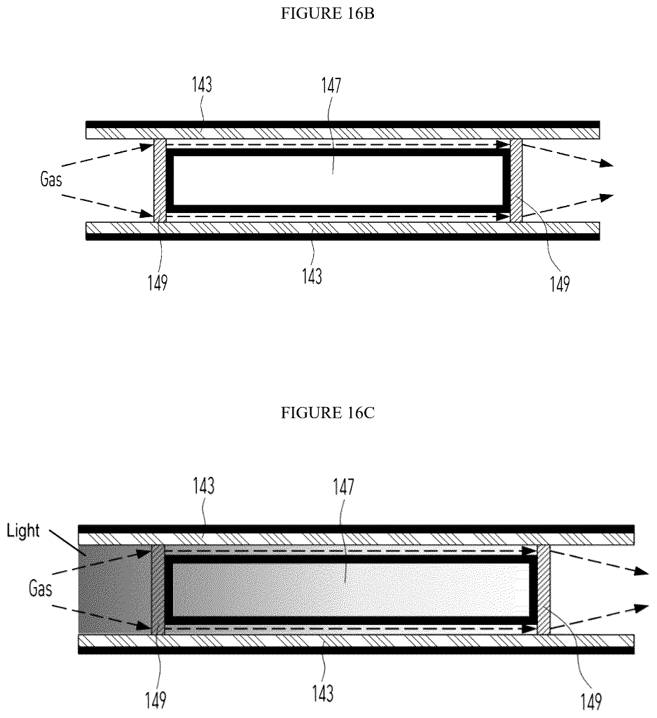

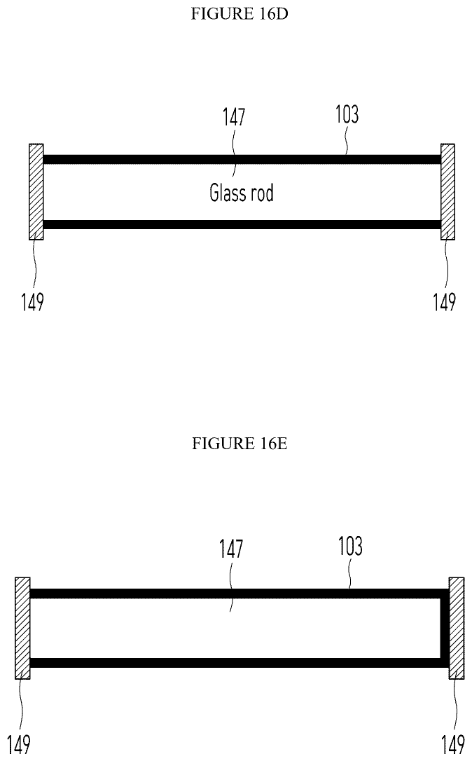

FIG. 16A illustrates a cross-sectional view of a glass rod LSPR catalyst device 145 including a single glass rod according to an embodiment. The glass rod LSPR catalyst device includes a glass rod LSPR catalyst and two brackets 149 at both ends of the glass rod. As discussed above, the glass LSPR rod catalyst includes metal nanoparticles formed over all or part of circumferential surfaces of the glass rod. FIG. 16B illustrates a cross-sectional view in which the glass rod LSPR catalyst device of FIG. 16A is placed inside the flow reactor 127 as in FIG. 14. FIG. 16C illustrates the same cross-sectional view as FIG. 16B with light beams illuminated into the flow reactor from left to right. In this and other drawings, the gradation (left darker than right) represents the strength of light beam, in which the light intensity one the left side is higher than on the right side inside flow reactor. However, the exterior light source(s) may provide light beams into the flow reactor to compensate gradation or dissipation of light intensity inside the flow reactor.

### Brackets for Single Glass Rod LSPR Catalyst Device

The brackets 149 may be connected or fixed to the glass rod 147 to support (as a supporting member) the glass rod so that the glass rod does not contact the interior surface (or mirror) of the flow reactor. The bracket includes a peripheral portion surrounding a central portion. The right side drawing of FIG. 16A illustrates one of the brackets when viewed in the length direction of the glass rod. The bracket is a shape of a gearwheel, in which the peripheral portion has an uneven edge similar to teeth of the gearwheel, although not limited thereto. The two ends of the glass rod mat be fixed to the central portion of the brackets, and the central portion of the bracket generally corresponds to the diameter of the glass rod although not limited thereto. The entire diameter of the bracket including the uneven periphery generally corresponds to (maybe slightly smaller than) the inner diameter of the pipe of flow reactor so that when inserted inside the pipe at least part the peripheral edge of the bracket contacts the interior surface of the pipe. The bracket may be transparent in its entirety, or at least the uneven peripheral portion is transparent. Alternatively, the at least uneven peripheral portion may be opaque and nontransparent.

### Annular Channel and Gas Flow

With the configuration as illustrated in FIGS. 16A-16C, the glass rod LSPR device provide an annular channel surrounding the glass rod between the interior surface of the pipe and the circumferential surfaces of the glass rod. Further, the uneven periphery of the brackets provides a plurality of openings between the interior surface of the pipe and the central portion. Accordingly, as illustrated in FIGS. 16B and 16C, gas can pass through the openings defined between the interior surface of the pipe and the bracket, and also travel through the annular channel.

### Size of the Glass Rod LSPR Catalyst

The length of the glass rod LSPR catalyst is smaller than the length of pipe of flow reactor. The diameter of the glass rod LSPR catalyst may be determined in view of the size of the annular channel formed by the gap between the circumferential surface of the glass rod LSPR catalyst and the interior surface of the pipe. The gap may be about 0.1, 0.2, 0.4, 0.6, 0.8, 1, 1.5, 2, 2.5, 3, 3.5, 4, 4.5, 5, 5.5, 6, 6.5, 7, 7.5, 8, 8.5, 9, 9.5, 10, 11, 12, 13, 14, or 15 mm, although not limited thereto. In embodiments, the gap may be within a range formed by any two numbers listed in the immediately previous sentence. For example, the gap is between about 0.1 mm and about 1 mm, about 1 mm and about 5 mm, and about 0.5 mm and about 10 mm, etc.

### Transparent Channel for Light Beam Travel

The flow reaction system with a single glass rod LSPR catalyst may have a transparent channel for light beams to travel along the glass rod LSPR catalyst. The light beams can pass the bracket at least through the openings (and optionally the transparent peripheral portion) to reach the annular channel. Then, as illustrated in FIG. 16C, the light beams travel through the annular channel along the glass rod LSPR catalyst in the length direction of the pipe.

Glass Rod LSPR Catalyst with Transparent End(s)

Metal nanoparticles 103 may not be formed at all over the surface of either or both ends of the glass rod LSPR catalyst. Alternatively, metal nanoparticles once formed may be removed from the surface of either or both ends of the glass rod. Referring to FIG. 16D, the glass rod LSPR catalyst does not have metal nanoparticles on both ends of the glass rod LSPR catalyst. Referring to FIG. 16E, the glass rod LSPR catalyst does not have metal nanoparticles on one end of the glass rod LSPR catalyst. These are to make at least one end of the glass rod (more) transparent so that the light beams can travel through the glass rod body. In such embodiments, the central portion of the bracket is made to be transparent too so that the light beams can travel through the central portion of the bracket and also through the glass rod body, which provides another transparent channel for light beams to travel along the glass rod LSPR catalyst device.

### Multiple Glass Rod LSPR Catalyst Device

### Multiple Glass Rod LSPR Catalyst Device

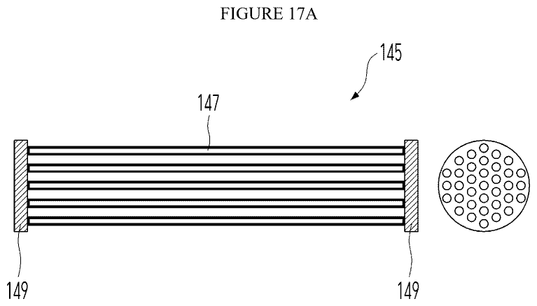

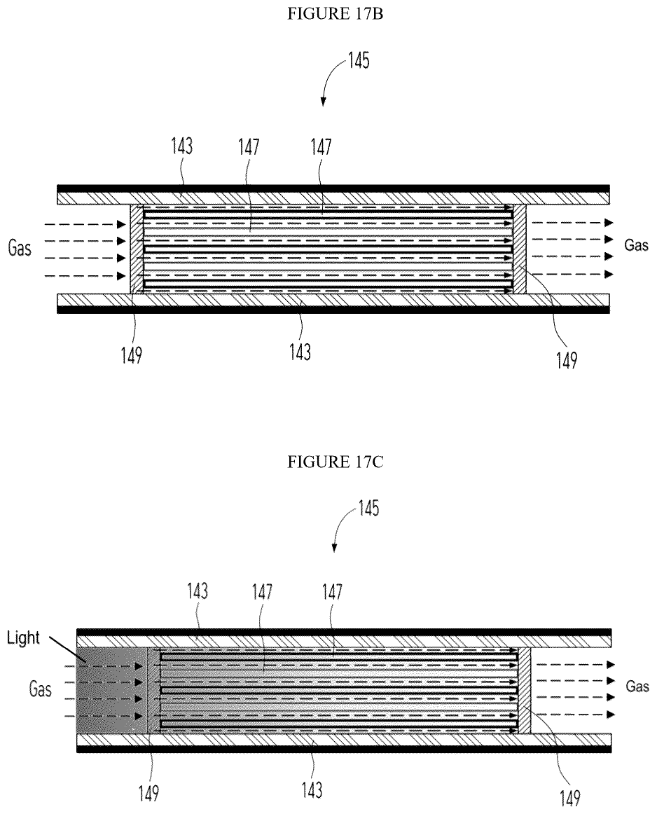

FIG. 17A illustrates a cross-sectional view of a glass rod LSPR catalyst device 145 including a plurality of glass rod LSPR catalysts and two brackets 149 according to an embodiment. FIGS. 17B and 17C illustrate a cross-sectional view in which the multiple glass rod LSPR catalyst device of FIG. 17A is placed inside the flow reactor as in FIG. 14. Each of the plurality of glass rod LSPR catalysts 147 is essentially a single glass rod LSPR catalyst and accordingly has all the characters and features discussed above. As illustrated, the plurality of glass rod LSPR catalysts have generally the same length and extend generally parallel to each other with some space therebetween.

### Size of Glass Rod LSPR Catalysts

The length of the glass rod LSPR catalysts is smaller than the length of the pipe of flow reactor. The diameter of the glass rod LSPR catalysts is about 0.5, 1, 1.5, 2, 2.5, 3, 3.5, 4, 4.5, 5, 5.5, 6, 6.5, 7, 7.5, 8, 8.5, 9, 9.5, 10, 12, 14, 16, 18, 20, 22, 24, 26, 28 or 30 mm, although not limited thereto. In embodiments, the diameter may be within a range formed by any two numbers listed in the immediately previous sentence. For example, the diameter is between about 1 mm and about 5 mm, about 3 mm and about 10 mm, and about 8 mm and about 20 mm, etc.

### Brackets for Multiple Glass Rod LSPR Catalyst Device

As illustrated, the two brackets are provided at both ends of the plurality of glass rod LSPR catalysts along the length direction of the glass rods. The two ends of the individual glass rods may be fixed to these brackets, which is to keep and maintain the arrangement of the glass rod LSPR catalysts, in which they are generally parallel to each other and apart from each other, so that they form an integral LSPR catalyst device. The right side drawing of FIG. 17A illustrates one of the brackets when viewed in the length direction of the glass rods. The bracket has a circular body with a plurality of openings generally throughout the body. The diameter of the bracket generally corresponds to (maybe slightly smaller than) the inner diameter of the pipe of flow reactor so that, when inserted inside the pipe, the edge of the bracket contacts the interior surface of the pipe as illustrated in FIGS. 17B and 17C. The bracket may be entirely or at least in part optically transparent.

### Channel for Gas Travel

With the configuration as illustrated in FIGS. 17A-17C, gas can pass through the openings formed in the brackets and travel through the spaces between and among the glass rods within the LSPR catalyst device.

### Transparent Channel for Light Beam Travel

The flow reaction system with multiple glass rod LSPR catalysts has a transparent channel for light beams to travel along the glass rod LSPR catalyst device. The light beams can pass the bracket at least through the openings and transparent body of the bracket. Then, as illustrated in FIG. 17C, the light beams travel through the spaces between and among the glass rods within the LSPR catalyst device together with gas. Further, at least part of the individual glass rod LSPR catalysts may be the one illustrated in FIG. 16D or 16E. This is to make at least one end of the glass rod (more) transparent so that the light beams can travel through the glass rod body, which provides one or more additional transparent channels for light beams to travel along the glass rod LSPR catalyst device.

### Some Glass Rods Not LSPR Catalyst

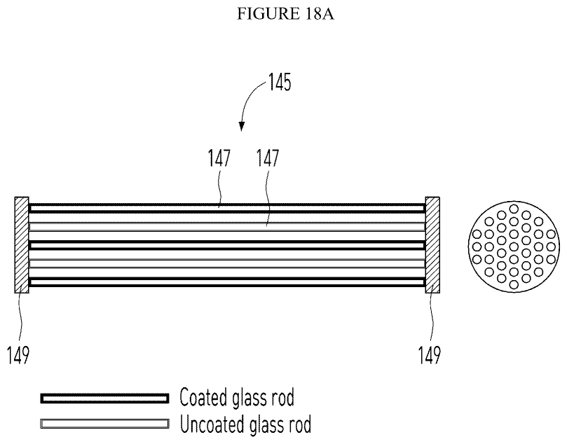

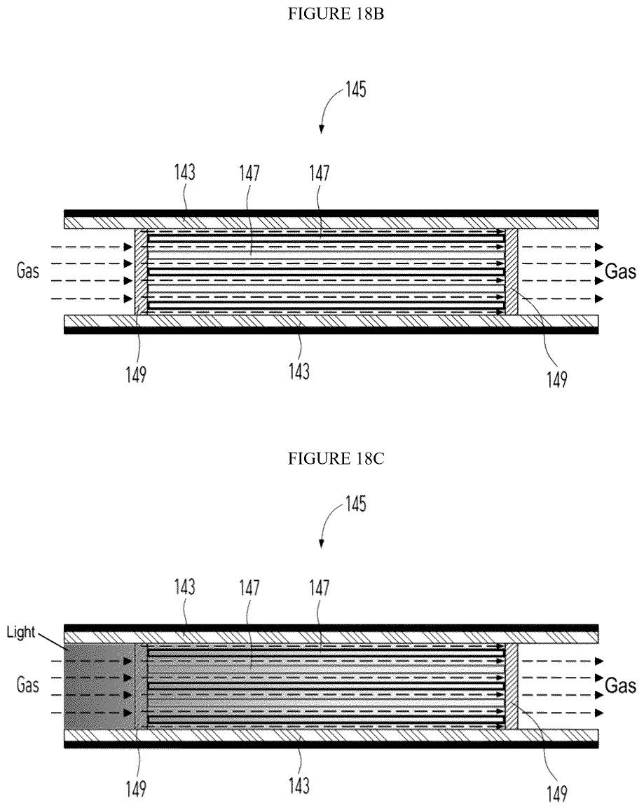

FIGS. 18A-18C illustrate a cross-sectional view of a glass rod LSPR catalyst device 145 including a plurality of glass rod LSPR catalysts 147 according to another embodiment. The multiple glass rod LSPR catalysts are the same as those in FIGS. 17A-17C except that some of the plurality of glass rods are not coated with metal nanoparticles and therefore are not LSPR catalyst. All the discussions of the glass rod LSPR catalyst are applicable to those glass rods that are coated with metal nanoparticles. The glass rods that are not coated with metal nanoparticles may be transparent or translucent so that light beams may travel through the glass rod bodies. The transparent glass rods and glass rod LSPR catalysts may be randomly arranged. Alternatively, the transparent glass rods may be arranged with the glass rod LSPR catalysts to maximize or increase the transmission of light beams in the flow direction of the flow reactor for illuminating the portions of the glass rod LSPR catalysts that are located downstream or close to the outlet end. The at least one transparent glass rod of FIGS. 18A-18C provide at least one additional transparent channel for light beams to travel along the multiple glass rod LSPR catalyst device.

### Some Glass Rods Omitted

Although not illustrated, one or more glass rod LSPR catalysts may be omitted from the multiple glass rods device of FIG. 17A. Although not illustrated, one or more glass rod LSPR catalysts may be omitted from the multiple glass rod LSPR catalyst device of FIG. 18A. The omission of glass rods provide at least one additional transparent channel for light beams to travel along the multiple glass rod LSPR catalyst device.

### Glass Bead LSPR Catalyst Device

### Glass Beads LSPR Catalyst Device

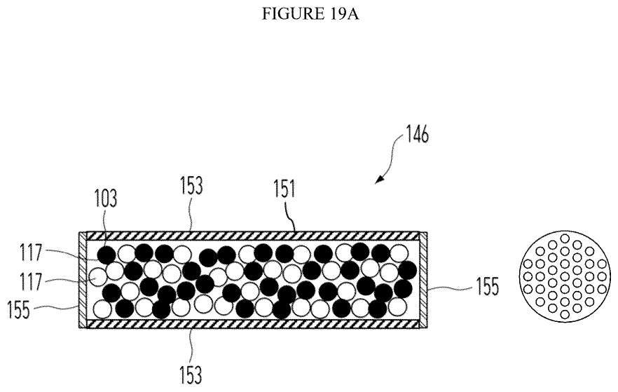

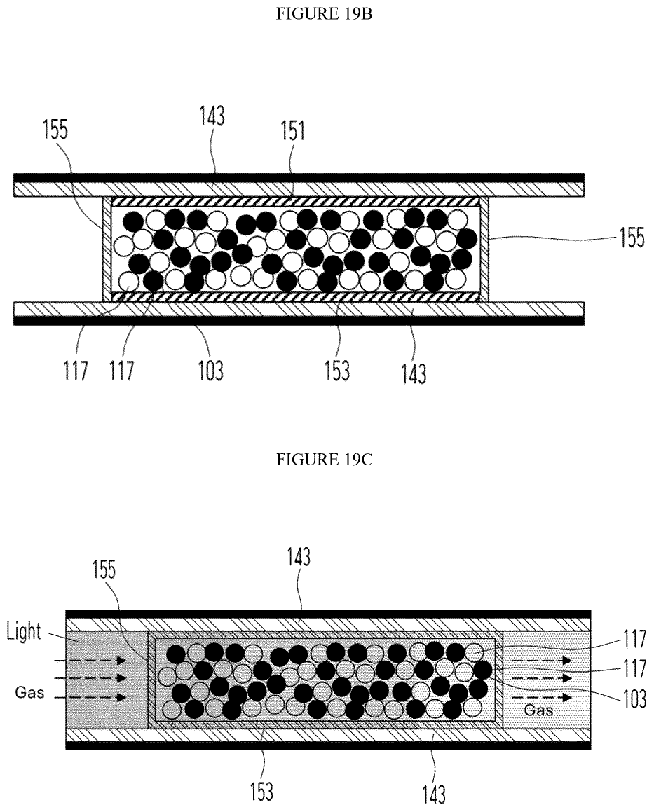

FIG. 19A illustrates a cross-sectional view of a glass bead LSPR catalyst device 146 including a number of glass bead LSPR catalysts according to an embodiment. The glass bead LSPR catalyst device 146 includes a glass bead container 151 and a number of glass bead LSPR catalysts contained therein. As discussed above, the glass bead LSPR catalysts includes metal nanoparticles formed over all or part of the glass bead surfaces. FIGS. 19B and 19C illustrate a cross-sectional view in which the LSPR catalyst device of FIG. 19A is placed inside the flow reactor 127 as in FIG. 14.

Glass Bead LSPR Catalysts Mixed with Transparent Glass Beads

In the illustrated embodiment of FIGS. 19A-19C, there are dark beads and white beads. The dark beads represent LSPR catalysts including metal nanoparticles over glass bead surfaces, i.e., not transparent. The white beads represent transparent glass beads that do not have metal nanoparticles over glass bead surfaces and accordingly are not LSPR catalysts. Accordingly, the bead container contains a mixture of LSPR catalyst glass beads and transparent glass beads to allow transmission of light beams through the beads contained in the container. LSPR catalyst glass beads and transparent glass beads may be mixed together inside the container. Accordingly, the transparent glass beads are randomly dispersed inside the container.

### Amount of Transparent Glass Beads

The transparent glass beads may be about 10, 15, 20, 25, 30, 35, 40, 45, 50, 55, 60, 65, 70, 75, 80, or 85 vol % of the total glass beads contained in the bead container, although not limited thereto. In embodiments, the amount of the transparent glass beads may be within a range formed by any two numbers listed in the immediately previous sentence. For example, the amount of the transparent glass beads is between about 20 vol. % and about 60 vol. %, between about 40 vol. % and about 80 vol. %, between about 35 vol. % and about 65 vol. %, etc.

### Bead Size

The size of the beads is determined in view of a desired porosity that the beads will collectively generate. If the beads are too small, it may be difficult to accomplish the overall porosity needed for gas flowability through the beads. In addition, if the beads are too large, contacts between the gas and surfaces of glass bead LSPR catalysts may not be as high. The glass beads have a diameter of about 50, 60, 70, 80, 90, 100, 150, 200, 250, 300, 350, 400, 450, 500, 550, 600, 650, 700, 750, 800, 850, 900, 950, 1000, 1050, 1100, 1150, 1200, 1250, 1300, 1350, 1400, 1450, 1500, 1550, 1600, 1650, 1700, 1750, 1800, 1850, 1900, 1950 or 2000, μm, although not limited thereto. In embodiments, the diameter may be within a range formed by any two numbers listed in the immediately previous sentence. For example, the diameter is between about 200 μm and about 1000 μm, between about 400 μm and about 1200 μm, between about 500 μm and about 1500 μm, etc.

### Glass Bead Container

The bead container 151 may include a cylindrical sidewall and two circular covers (or end walls) covering the two ends of the cylindrical body as illustrated in FIG. 19A. The diameter of the cylindrical sidewall 153 corresponds to (maybe slightly smaller than) the interior diameter of the pipe of flow reactor. At least one of the two covers 155 may be transparent for the light beams to pass therethrough for reaching the glass beads. The cylindrical sidewall may also be transparent particularly when there is a mirror cladding on the interior surface of the pipe. The two covers may have a porous structure to allow gas to path therethrough. The pores formed in the two covers are smaller than the diameter of smaller beads to avoid beads from infiltrating or permeating through the pores from the container.

### Transparent Channel for Light Beam Travel

The flow reaction system with glass bead LSPR catalysts may have a transparent channel for light beams to travel along the glass bead LSPR catalyst device. The light beams can pass the transparent left cover to reach glass beads inside the container. Then, as illustrated in FIG. 19C, the light beams travel through the transparent glass beads that are randomly dispersed in the beads, which provides a number of transparent channels for light beams to travel substantially throughout the length of the container along the length direction of the flow reactor.

### Bead Cover

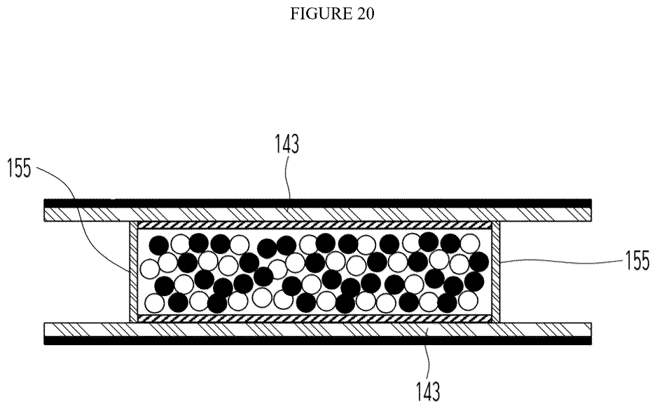

As an alternative to the bead container, the beads may be kept inside the pipe of flow reactor 127 with two covers as illustrated in FIG. 20. The two covers are opposingly inserted inside the pipe and beads are kept between the two covers 155 and by the interior surface of the pipe. At least one of the two covers may be transparent for the light beams to pass therethrough for reaching the glass beads. The two covers may have a porous structure to allow gas to path therethrough. The pores formed in the two covers are slightly smaller than the diameter of smaller beads to maintain the beads inside the container.

### Glass Fiber Filter LSPR Catalyst Device

### Glass Fiber Filter LSPR Catalyst Device

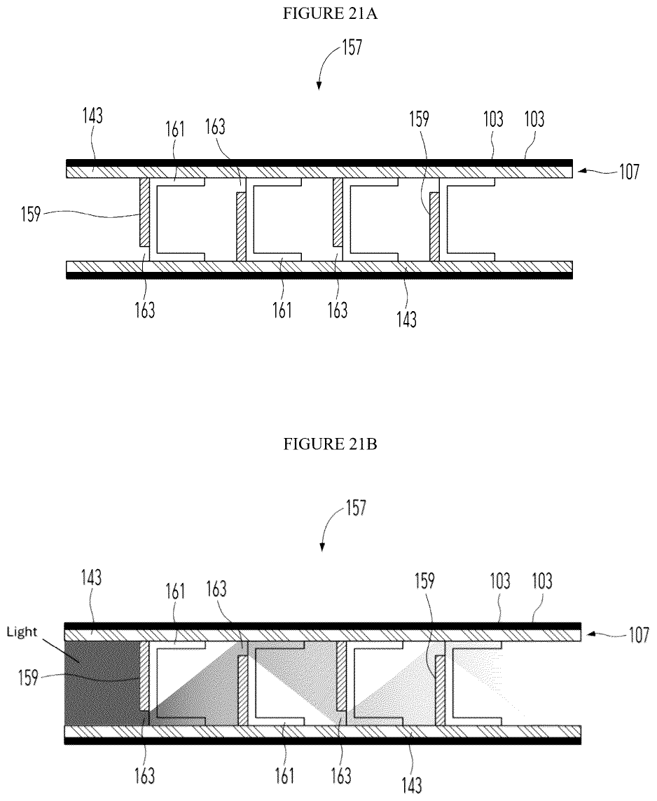

FIG. 21A illustrates a cross-sectional view of a flow reactor 157 in which a plurality of glass fiber filter LSPR catalyst devices 159 are installed inside a pipe of flow reactor. Each glass fiber filter LSPR catalyst device 159 is or includes a glass fiber filter LSPR catalyst and a bracket (or support member) 161 for the glass fiber filter LSPR catalyst device 159. As discussed above, the glass fiber filter LSPR catalyst includes metal nanoparticles formed over circumferential surfaces of glass fibers inside a glass fiber filter.

### Porosity of Glass Fiber Filter

For the flow reaction system, the glass fiber filter LSPR catalyst has a porosity of about 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, or 5 μm, although not limited thereto. In embodiments, the temperature may be within a range formed by any two numbers listed in the immediately previous sentence. For example, the temperature is between about 0.3 μm and about 3 μm, between about 0.6 μm and about 2.7 μm, between about 1.0 μm and about 2.2 μm, etc.

### Brackets Holding Glass Fiber Filter LSPR Catalyst

Each bracket is arranged or installed inside the pipe and apart from its neighboring brackets with a gap in the length direction of the pipe. In the illustrated embodiment, each bracket holds or support one glass fiber filter LSPR catalyst. Accordingly, the glass fiber filter LSPR catalysts are arranged inside the pipe and apart from its neighboring LSPR catalysts with a gap in the length direction of the pipe. The gaps between two consecutive brackets are generally the same although not limited thereto.

### Area Not Covered by Glass Fiber Filter LSPR Catalyst

The glass fiber filter LSPR catalysts are oriented such that the major (two opposite) surfaces of the sheet like glass fiber filter are generally perpendicular to the length direction of the pipe. The major surfaces of the glass fiber filter LSPR catalyst are smaller than the cross-section of the interior space of the pipe taken in the length direction. Thus, the glass fiber LSPR filter catalyst does not block the entire cross-section of the interior space, and for each glass fiber filter LSPR catalyst there is an area 163 that is not covered by the glass fiber filter LSPR catalyst (not-covered area) as indicated in FIG. 21A.

### Not-Covered Area Blocked by Bracket

The not-covered area by each glass fiber filter LSPR catalyst is blocked or covered by the corresponding bracket that supports the particular glass fiber filter LSPR catalyst. If the not-covered area were not blocked by the corresponding bracket, the gas flowing through the pipe would pass through the non-covered area without much contacting metal nanoparticles inside the glass fiber filter LSPR catalyst.

Bracket with Porous Material

The bracket 161 is made of a porous material throughout its body. Alternatively, the bracket may include one or more portions that are made of a porous material. At least the portion of the bracket covering or blocking the not-covered area of the corresponding glass fiber filter LSPR catalyst may be made of a porous material. At least the portion of the bracket covered by the corresponding glass fiber filter LSPR catalyst may be made of a porous material. The bracket may have an opening that is covered by the corresponding glass fiber filter LSPR catalyst. With these configurations, the bracket allows gas, which has once passed through the glass fiber filter LSPR catalyst, to pass through the opening.

Bracket with Transparent Material

The bracket is made of an optically transparent material throughout its body. Alternatively, the bracket may include one or more portions that are made of a transparent material. At least the portion of the bracket covering or blocking the not-covered area of the corresponding glass fiber filter LSPR catalyst may be made of a transparent material. The light beams may pass through the not-covered area of a glass fiber filter LSPR catalyst and further pass through the transparent bracket covering the not-covered area.

### Not-Covered Areas Not Aligned Together

The not-covered areas 163 may not be aligned together in a direction along the length direction of the pipe. For example, the not-covered areas of two consecutive glass fiber filter LSPR catalysts do not overlap when viewed in the length direction of the pipe. Referring to FIG. 21A, the first glass filter fiber LSPR catalyst 159 from left is installed at an upper portion of the corresponding bracket, and the not-covered area 163 is located below the first glass filter fiber LSPR catalyst. The second glass filter fiber LSPR catalyst from left is installed at a lower portion of the corresponding bracket, and the not-covered area is located above the second glass filter fiber LSPR catalyst. Although not illustrated, a glass filter fiber LSPR catalyst is installed at another portion of the corresponding bracket, and the not-covered area is located at a diagonal portion on the cross-section of the interior space.

### Transparent Channel for Light Beam Travel

The flow reaction system with a plurality of glass fiber filter LSPR catalyst devices may have a transparent channel for light beams to travel along the glass fiber filter LSPR catalyst devices. FIG. 21B illustrates propagation of light beams in a cross-sectional view of the flow reactor 127 with glass fiber filter LSPR catalyst devices. As illustrated, the light beams travel through the not-covered areas 163 and the portions of the brackets 161 corresponding to the not-covered areas which provide a transparent channel for the light beams to travel along the glass fiber filter LSPR catalyst devices.

### Through-Hole Glass LSPR Catalyst Device

Flow Reactor with Through-Hole Glass Catalyst Devices

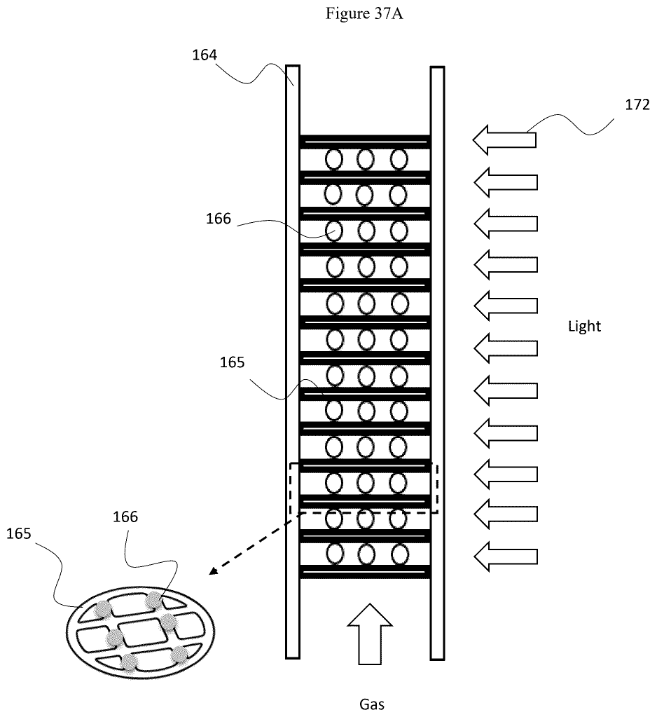

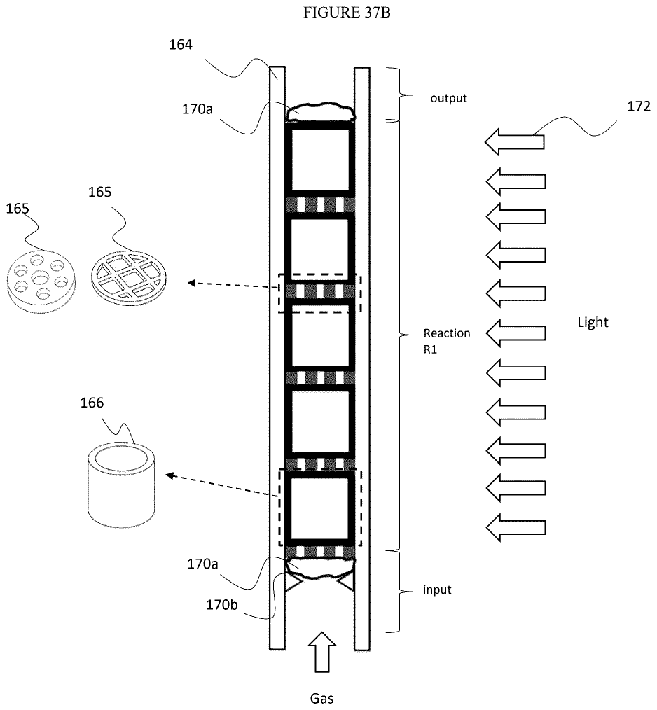

Each of FIGS. 37A and 37B illustrates an example flow reactor 164 incorporating a plurality of through-hole glass catalyst devices 165. The catalyst devices 165 are arranged in a vertically stacked configuration within the reactor chamber 164. The catalyst device 165 comprises a glass body having a plurality of through-holes formed therethrough, which permits gas to flow therethrough inside the reactor 164. Any through-hole glass catalyst devices discussed above including those illustrated in FIGS. 35A-36D can be used in the flow reactor 164. The through-holes increase the overall reactive surface area and promote improved interaction between the gas and the catalyst surfaces. One or more spacers 166 may be interposed between adjacent catalyst devices 165.

### Spacers Between Catalyst Devices

The spacers 166 may be positioned between adjacent glass catalyst devices 165 to maintain spacing and structural stability. These spacers 166 can maintain consistent separation, prevent clogging, and facilitate efficient heat and mass transfer during fluid (e.g., gas) flow through the catalyst stack. The spacers 166 can further help maintain a stable and uninterrupted flow of reactants.

### Shapes and Sizes of Spacers

The spacers 166 are transparent particles that are bonded to surfaces of the catalyst devices 165. The transparent particles may have various shapes, including but not limited to spheres, cylinders, cones, cubes, pyramids, tetrahedrons, and prisms, and are not limited to the spherical shape illustrated in the figures. For example, FIG. 37A illustrates one or more particulate spacers positioned between the catalyst devices 165, while FIG. 37B shows a cylindrical spacer disposed between adjacent catalyst devices 165. The number, size, and shape of the spacers 166 are not limited to the illustrated embodiments and may vary depending on the design requirements. In some embodiments, the spacers may be uniform in size and shape within the reactor 164 and may be bonded to the catalyst devices 165, although such configurations are merely illustrative and not restrictive.

### Fiber Materials for Spacers

In some embodiments, fibrous materials can be used as spacers 170. Such fibrous materials include, but are not limited to, glass wool 170a. Unlike the spacers 166, fibrous spacers can be packed, shaped, or compressed to conform to specific geometries and provide structural support or spacing between components. In some embodiments, the fibrous material 170a may be positioned at one or both ends of the stack as illustrated in FIG. 37A. In other embodiments, although not illustrated, the fibrous material may be located between two adjacent catalyst devices 165. When the fibrous spacer is used at the bottom of the reactor 164, a separate support structure 170b may be included to retain the spacers in place and to maintain the overall alignment of the stacked components. In other embodiments, the fibrous material 170b may be positioned between adjacent catalyst devices 165 as spacer.

### Flow Reactor Structure

The reactor structures illustrated in FIGS. 37A and 37B include vertically stacked catalyst supports 165 and spacers 166 or 170a. The reactor structure, may be implemented in various reactor configurations such as those shown in FIGS. 14 and 15. For example, the stack-type catalyst arrangements of FIGS. 37A and 37B may be integrated into a single tubular reactor configuration (FIG. 14) or a multi-branch or orthogonal flow system (FIG. 15).

### Light Source for Flow Reactor

A light source may be provided to supply light beams to the flow reactor. The light source 172 may be positioned on the side, directing light optimally for enhanced performance. The light source may be LED, laser, sunlight, halogen bulb/lamp, tungsten-halogen lamp, metal halide bulb, incandescent bulbs, neon lamp, HID lamp (high-intensity discharge lamp), etc. although not limited thereto. In some embodiments, light is introduced from one or more directions, such as from the top, bottom, side, or at an angle, relative to the orientation of the reactor. The light source 172 may be provided from outside as shown in FIGS. 37A and 37B or provided inside the reactor 164. In some embodiments, in addition to or in the alternative to the outside light source 172, the light source 172 is provided in a light box and connected to the reactor 164 as illustrated in FIGS. 14 and 15.

### Flow Reactor Arrangement-Vertical-Horizontal, Slanted

The flow reactor may be arranged in a vertical, horizontal, slanted, or other non-orthogonal orientation. In various embodiments, light may be supplied from one or more directions, including the top, bottom, side, or at an angle. Likewise, the introduction and discharge of gas or other fluids may be implemented through inlets and outlets located at any suitable position on the reactor, such as from the bottom, top, side, or diagonally, to accommodate different flow patterns, reactor geometries, or process requirements. This configurational flexibility allows the reactor to be adapted for use in a wide range of applications including combination of one or more of horizontal, vertical, or orthogonal structures.

### Connection of Flow Reactors

The reactor 164 may be connected to one or more gas inlet and outlet lines as illustrated in FIG. 15 using suitable fittings, such as a 3-way T-union or other types of fluid connectors. A temperature monitoring element, such as a K-type thermocouple probe, may also be included to monitor operating conditions. In some embodiments, multiple reactors may be connected in parallel, series, or other spatial arrangements, such as vertical, horizontal, or orthogonal configurations. Each reactor may be independently or collectively supplied with gas and exposed to light, allowing for modular scalability and enhanced catalytic performance across various system architectures.

Operation of Flow Reactor with Through-Hole Glass Catalysts

A chemical reaction occurs while at least one reactant is flowing through the reactor in a flow direction from the inlet toward the outlet inside the flow reactor. During operation, for example, gas or fluid stream containing ammonia (NH₃) gas is introduced through the inlet and directed through the vertically or otherwise arranged stack of glass catalyst devices 165 and spacers 166. The gas flowing inside the flow reactor passes through through-holes 165a of multiple catalyst devices 165 arranged inside the flow reactor 164, thereby contacting and/or passing by nanoparticles attached to surfaces of the catalyst devices 165. While the gas is flowing inside the flow reactor, light 172 may be applied from at least one light source to illuminate the catalyst device located inside the flow reactor, which activates localized surface plasmon resonance (LSPR) to provide energy for decomposition of ammonia molecules.

### Applying Heat

In some embodiments, the operation may further include heating of the flow reactor 164 to enhance the chemical reaction before and/or during flowing the gas inside the flow reactor. Heating may be performed using any heat source located outside the flow reactor. Heating may be applied locally to one or multiple portions of the reactor to reach a desired temperature for the reaction. In embodiments, the flow reactor may be heated to a specific temperature such as to about 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, 200205, 210, 215, 220, 225, 230, 235, 240, 245, 250, 255, 260, 265, 270, 275, 280, 285, 290, 300, 305, 310, 315, 320, 325, 330, 335, 340, 345, 350, 355, 360, 365, 370, 375, 380, 385, 390, 395, 400, 405, 410, 415, 420, 425, 430, 435, 440, 445, 450, 455, 460, 465, 470, 475, 480, 485, 490, 495, 500, 505, 510, 515, 520, 525, 530, 535, 540, 545, 550, 555, 560, 565, 570, 575, 580, 585, 590, 595, 600, 605, 610, 615, 620, 625, 630, 635, 640, 645, 650, 655, 660, 665, 670, 675, 680, 685, 690, 695, 700, 705, 710, 715, 720, 725, 730, 735, 740, 745, 750, 755, 760, 765, 770, 775, 780, 785, 790, 795, 800, 805, 810, 815, 820, 825, 830, 835, 840, 845, 850, 855, 860, 865, 870, 875, 880, 885, 890, 895 or 900° C., In embodiments, the flow reactor may be heated to a temperature within a range formed by any two numbers listed in the immediately previous sentence. For example, the flow reactor may be heated to the temperature is between about 200° C. and about 400° C., between about 180° C. and about 360° C., between about 240° C. and about 580° C., and between about 300° C. and about 600° C.

### Chemical Reactions in the Flow Reaction System

### Flow Chemical Reactions

The flow reaction system may accommodate many flow chemical reactions, including decomposition of ammonia, decomposition of NOx, synthesis of ammonia, hydrogenation relations, etc., although not limited thereto. The flow reaction system can facilitate those chemical reactions with LSPR energy generated the LSPR catalyst device. For example, use of the flow reaction system is discussed in terms of ammonia cracking.

Ammonia Cracking with Flow Reaction System

Ammonia cracking is a chemical reaction that decomposes ammonia (NH3) into its constituent elements, hydrogen (H2) and nitrogen (N2). The reaction is 2 NH3→N2+3 H2. This reaction is typically carried out at high temperatures (800-1000° C.) and pressures (10-20 bar) with a metal oxide LSPR catalyst. The flow reaction system works for the production of hydrogen (H2) with the ammonia cracking reaction. With the LSPR energy generated in the flow reactor, the ammonia cracking reaction can be performed at milder conditions.

### Reactant and Products

For the ammonia cracking reaction, ammonia gas may be the sole or primary reactant that the reactant supply send to the flow reactor. At the outlet of the flow reaction system, the product collector may receive nitrogen, hydrogen and undecomposed ammonia. In the reaction, two ammonia molecules turn to for molecules (one nitrogen and three hydrogen), and therefore the products have mole volume than the reactant.

### Plasma-Treated Ammonia as Reactant

To facilitate the reaction, the reactant supply may supply plasma-treated ammonia gas to the flow reactor in addition or in the alternative to the ammonia gas. The plasma-treated ammonia gas may include ammonia-derived radicals (e.g., one or more hydrogen atoms are removed from ammonia). Ammonia-derived radicals are more reactive than ammonia and will likely enhance the hydrogen production performance. The flow reaction system may include a plasma system for treating ammonia with plasma. The plasma system may be connected to or replace the reactant supply. The plasma-treated ammonia may include one or more chemical entities such as argon.

### Additional Reactant(s)

To facilitate the reaction, at least one additional reactant may be used to treat ammonia for generating ammonia-derived radicals. For example, ozone, sodium (Na), hydride ion (H-) or hydride compounds may interact with or attack ammonia molecules to remove one or more hydrogen atoms, which generates ammonia-derived radicals. The flow reaction system may be designed such that ammonia is pretreated with such additional reactant(s) before supplied to the flow reactor, i.e., downstream of the reactant supply or at the reactant supply. In the alternatively, ammonia gas and such additional reactant(s) are separately supplied into the flow reactor and react in the flow reactor. The supply of such additional reactant(s) may be combined with the supply of plasma-treated ammonia.

Ammonia Cracking with or without Heating

The ammonia cracking or other chemical reaction conducted in the flow reactor receive energy for the reaction from the LSPR catalyst(s) located inside the flow reactor. In case the energy from the LSPR catalyst(s) is sufficient for the reaction, the reaction inside the flow reactor runs without the application of heat to the flow reactor. In case more energy is required for the reaction, heat may be applied to the flow reactor using at least one heater or heat source located outside the flow reactor. The ammonia gas may or may not be pre-heated prior to being supplied to the flow reactor.

### Temperature

At steady state of the ammonia cracking reaction, with or without heating of the flow reactor, the temperature inside the flow reactor is about 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, 200205, 210, 215, 220, 225, 230, 235, 240, 245, 250, 255, 260, 265, 270, 275, 280, 285, 290, 300, 305, 310, 315, 320, 325, 330, 335, 340, 345, 350, 355, 360, 365, 370, 375, 380, 385, 390, 395, 400, 405, 410, 415, 420, 425, 430, 435, 440, 445, 450, 455, 460, 465, 470, 475, 480, 485, 490, 495, 500, 505, 510, 515, 520, 525, 530, 535, 540, 545, 550, 555, 560, 565, 570, 575, 580, 585, 590, 595, 600, 605, 610, 615, 620, 625, 630, 635, 640, 645, 650, 655, 660, 665, 670, 675, 680, 685, 690, 695, 700, 705, 710, 715, 720, 725, 730, 735, 740, 745, 750, 755, 760, 765, 770, 775, 780, 785, 790, 795, 800, 805, 810, 815, 820, 825, 830, 835, 840, 845, 850, 855, 860, 865, 870, 875, 880, 885, 890, 895 or 900° C., although not limited thereto. In embodiments, the temperature may be within a range formed by any two numbers listed in the immediately previous sentence. For example, the temperature is between about 300° C. and about 400° C., between about 250° C. and about 650° C., between about 550° C. and about 800° C., etc.

### Pressure

The pressure inside the flow reactor may be controlled with the flow rate and/or pressure of the ammonia gas supplied into the pipe. At steady state of the ammonia cracking reaction, the pressure inside the flow reactor is about 0.05, 0.1, 0.2, 0.3, 0.4, 0.5, 0.6, 0.7, 0.8, 0.9, 1, 1.2, 1.4, 1.6, 1.8, 2, 2.2, 2.4, 2.6, 2.8, 3, 3.2, 3.4, 3.6, 3.8, 4, 4.2, 4.4, 4.6, 4.8, 5, 5.2, 5.4, 5.6, 5.8, 6, 6.2, 6.4, 6.6, 6.8, 7, 7.2, 7.4, 7.6, 7.8, 8, 8.2, 8.4, 8.6, 8.8, 9, 9.2, 9.4, 9.6, 9.8, 10, 10.2, 10.4, 10.6, 10.8, 11, 11.2, 11.4, 11.6, 11.8, 12, 12.2, 12.4, 12.6, 12.8, 13, 13.2, 13.4, 13.6, 13.8, 14, 14.2, 14.4, 14.6, 14.8, or 15 bar, although not limited thereto. In embodiments, the pressure may be within a range formed by any two numbers listed in the immediately previous sentence. For example, the pressure is between about 0.1 bar and about 2 bar, between about 0.5 bar and about 4 bar, between about 5 bar and about 10 bar, etc.

### Flow Rate

At steady state of the ammonia cracking reaction, the ammonia gas may be supplied into the flow reactor at the flow rate of about 0.1, 0.2, 0.3, 0.4, 0.5, 0.6, 0.7, 0.8, 0.9, 1, 5, 10, 20, 30, 40, 50, 60, 70, 80, 90, 100, 120, 140, 160, 180, 200, 250, 300, 350, 400, 450, 500, 550, 600, 650, 700, 750, 800, 850, 900, 950, 1000, 1100, 1200, 1300, 1400, 1500, 1600, 1700, 1800, 1900, 2000, 2200, 2400, 2600, 2800, 3000, 3200, 3400, 3600, 3800, 4000, 4500, 5000, 5500, 6000, 6500, 7000,7500, 8000, 8500, 9000, 9500, 10000, 12000, 14000, 16000, 18000, or 2000 ml/min. In embodiments, the flow rate may be within a range formed by any two numbers listed in the immediately previous sentence. For example, the flow rate is between about 1 ml/min and about 10 ml/min, between about 3000 ml/min and about 6000 ml/min, between about 500 ml/min and about 2000 ml/min, etc.

### Wavelength of Light Beams

The light box supplies light beams into the flow reactor. The light beams may include a spectrum or range of various wavelengths as long as they include certain wavelength that can excite metal nanoparticles for surface plasmon resonance. The wavelengths for surface plasmon resonance may depend on the metal, size, shape and aggregation of the nanoparticles. In embodiments, the light beams have one or more wavelengths of about 360, 380, 400, 410, 420, 440, 460, 480, 500, 520, 540, 550, 560, 580, 600, 620, 640, 660, 680, 700, 720, 740, 760, 780, 800, 820 or 840 nm, although not limited thereto.

### Intensity of Light Beams

The light beams inputted into the flow reactor has the intensity of about 10, 20, 30, 40, 50, 60, 70, 80, 90, 100, 120, 140, 160, 180, 200, 220, 240, 260, 280, 300, 320, 340, 360, 380, 400, 420, 440, 460, 480, 500, 520, 540, 560, 580, 600, 620, 640, 660, 780, 800, 820, 840, 860, 880, 900, 920, 940, 960, 980, or 1000 mW/cm². In embodiments, the intensity may be within a range formed by any two numbers listed in the immediately previous sentence. For example, the intensity is between about 30 mW/cm² and about 100 mW/cm², between about 200 mW/cm² and about 600 mW/cm², between about 400 ml/min and about 800 mW/cm², etc.

### Maintenance

For continued performance of the LSPR catalyst device, the LSPR catalyst device may be replaced or refreshed to from time to time. First, the operation of the flow reaction system is temporarily stopped for maintenance. Then, the used flow reactor may be replaced with another flow reactor in which the LSPR catalyst device is new or refreshed. Alternatively, the used LSPR catalyst device is taken out of the flow reactor, and a new or refreshed LSPR catalyst device is inserted.

### Refreshing LSPR Catalyst Device

Surfaces of the metal nanoparticles are oxidized over time, which may form a metal oxide layer on metal nanoparticle surfaces. The LSPR catalyst device may be refreshed by cleaning the metal nanoparticle surfaces or removing at least part of the metal oxide layer therefrom. The operation of the flow reaction system may include a process of refreshing the LSPR catalyst device from time to time on a regular and/or need basis. For the refreshing process, the continuous flow reaction is temporarily stopped and resumed after refreshing the LSPR catalyst device.

Flow Reaction System with Cleaning Fluid

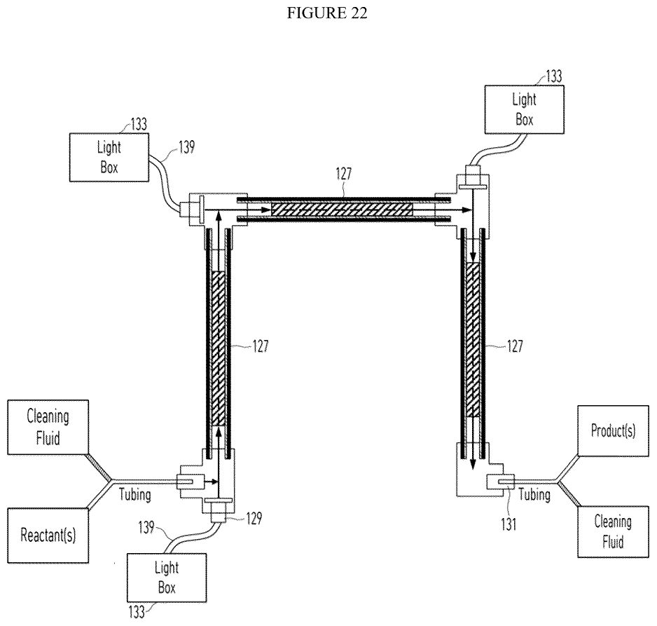

FIG. 22 illustrates a flow reaction system that integrates the refreshment of LSPR catalyst device. The inlet tubing of the system is connected to at least one reactant supply as in FIGS. 14 and 15. In addition, a supply of cleaning fluid is also connected to the inlet tubing of the flow reaction system. Each of the reactant supply and cleaning fluid supply may be in fluid communication with the tubing via a valve (not shown) for turning on and off the fluid communication. Similarly, the outlet tubing of the flow reaction system is connected to at least one product collector as in FIGS. 14 and 15. In addition a cleaning fluid collector is also connected to the outlet tubing of the flow reaction system. Each of the product collector and cleaning fluid collector may be in fluid communication with the tubing via a valve (not shown) for tuning on and off the fluid communication. Although not illustrated, each flow reactor of FIG. 15 may include a cleaning fluid supply at its inlet side and a cleaning fluid collector at its outlet side. Also, the single flow reactor system of FIG. 14 may include a cleaning fluid supply at the inlet side and a cleaning fluid collector at the outlet side.

### Refreshing Process

For the LSPR catalyst refreshing process, the supply of the reactant(s) to the flow reactor(s) is stopped by turning off the valve (not shown) for the reactant. Later, the continuous flow reaction (ammonia decomposition) is stopped and the valve for the product collector is turned off, which stops the continuous flow reaction. Subsequently, the valve for the cleaning fluid supply is turned on to flow the cleaning fluid into the flow reactor(s), which allows the cleaning fluid to contact and clean nanoparticle surfaces of the LSPR catalyst device(s) inside the flow reactor(s). Upon completion of the cleaning, the cleaning fluid inside the flow reactor(s) is flushed out to the cleaning fluid collector with the reactant(s) or another fluid. Here, the reactant(s) is supplied from the reactant supply, and the other fluid may be supplied from the cleaning fluid supply or another supply (not shown). Subsequently, the continuous flow reaction resumes.

### Batch or Continuous Process

In some embodiments, the cleaning process is performed in a batch mode. For example, the outlet-side valve to the cleaning fluid collector is turned off, and the cleaning fluid is supplied to the flow reactor(s) to fill the inner space of the flow reactor(s) to a desirable level. Then, the cleaning fluid stays inside the flow reactor(s) for a period of time sufficient to the cleaning process. Subsequently, the outlet-side valve to the cleaning fluid collector is turned on to discharge the cleaning fluid from the flow reactor(s). In other embodiments, the cleaning process is performed in a continuous mode. For example, the outlet-side valve to the cleaning fluid collector is turned on, and the cleaning fluid is continuously supplied to the flow reactor(s).

### Cleaning Fluid

The cleaning fluid may be liquid or gas. An acidic solution may be used as liquid cleaning fluid to remove metal oxides formed on metal nanoparticles. For example, gold/silver cleaner from Sigma-Aldrich (product number 901265) is used for the liquid cleaning fluid. After cleaning with liquid cleaning fluid, water may be used for flushing the liquid cleaning fluid. A plasma may also be used as gaseous cleaning fluid to remove metal oxides formed on metal nanoparticles. For example, plasma is created using oxygen and argon and supplied to the cleaning fluid supply.

### Liquid Phase Chemical Reaction System

### Liquid Phase Reaction System

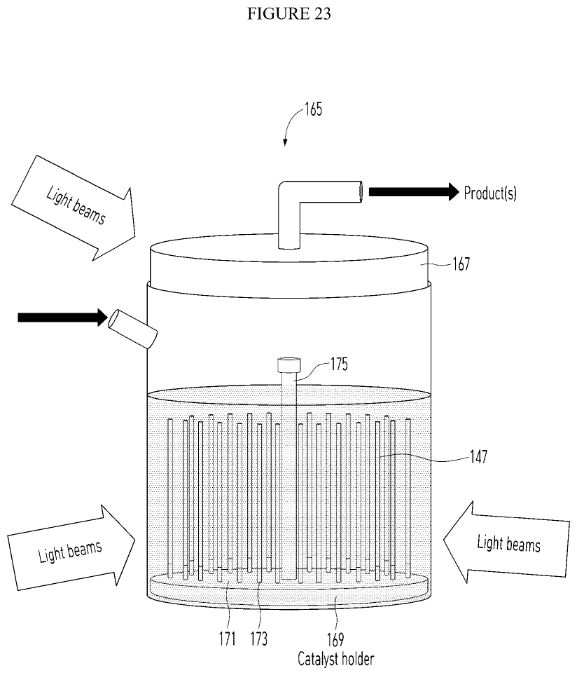

One aspect of the present disclosure and its embodiments provide a liquid phase chemical reaction system including LSPR catalyst devices. FIG. 23 illustrates an example liquid phase chemical reaction system including a liquid phase reaction vessel 165, glass rod catalysts 147 arranged inside the reactor, a reactant supply for supplying reactant(s) to the reactor, a cover 167 for the reactor, and a product collector for receiving product(s) from the reactor.

### Arrangement of Glass Rod LSPR Catalysts

Referring to FIG. 23, the glass rod LSPR catalysts arranged generally in a vertical direction and in parallel with one another, although not limited thereto. All or part of the glass rod LSPR catalysts may be arranged in a horizontal direction or in other directions. The glass rod LSPR catalysts are apart from each other with a gap. The gap between the glass rod LSPR catalysts may be regular, although not limited thereto.

### Catalyst Holder

A catalyst holder 169 is provided inside the reaction vessel to effectively hold, support and arrange the glass rod LSPR catalysts. The LSPR catalyst holder may include a base 171, a plurality of rod-holding elements 173, and a post 175. The base 171 is placed on the interior bottom of the reaction vessel. The rod-holding elements 173 may be a plurality of holes formed on the upper side of the base into which individual glass rod LSPR catalysts are fitted. The post 175 is optional but useful for handling the LSPR catalyst holder. At least one surface of the LSPR catalyst holder is mirror cladded so that light beams are reflected on the surfaces and redirected to the glass rod LSPR catalysts.

### Glass Rod LSPR Catalysts

The glass rod catalysts include metal nanoparticles formed over all or part of circumferential surfaces of the glass rod. Without being bound by any theories, metal nanoparticles densely bound on circumferential surfaces of a glass rod as in FIG. 24 is believed to generate a large LSPR energy with constructive interference of electric fields generated by individual metal nanoparticles. Further, the rod configuration of the glass rod LSPR catalysts 147 helps the metal nanoparticles 103 contact reactant(s) in the liquid composition that the glass rod LSPR catalysts contact, with which the likelihood of energy transfer from the metal nanoparticles to the reactant(s) is higher than other configurations. Nonetheless, other LSPR catalysts including metal nanoparticles formed over a substrate also should work in this liquid phase reaction system. Such other LSPR catalyst devices may be added to the illustrated system or may replace all or part of the glass rod LSPR catalysts.

### Illumination

For surface plasmon resonance, light beams are supplied to the LSPR catalysts located in the reaction vessel. The illumination may be provided by natural light or artificial light source(s). One or more one light source may be provided outside and/or inside the reaction vessel to effectively illuminate more surfaces of the LSPR catalysts disposed in the reaction vessel. One or more mirror surfaces may be used to enhance illumination of the LSPR catalyst surface. For example, mirror cladding may be provided on the upper surface of the base and/or the circumferential surfaces of the central post. Although not illustrated, a mirrored enclosure is provided with mirror cladding on the walls of the reaction vessel and the cover, and the light beams are supplied into the mirrored enclosure from outside or the source(s) is located inside the mirrored enclosure.

### Liquid Phase Chemical Reactions

The liquid phase chemical reaction system provides the activation energy to facilitate various chemical reactions. For example, the use of this system is discussed in terms of ammonia borane decomposition for the production of hydrogen.

### Ammonia Borane

Ammonia borane (AB) is a chemical compound with the formula NH3BH3. It is well known for its hydrogen storage capacity. Since it is solid at room temperature (melting point being 104° C.), it is relatively easy and convenient to store and transport. It is considered as a convenient source of hydrogen gas as it generates hydrogen (H₂) when it decomposes. However, the ammonia borane decomposition is a very slow process and needs a catalyst to speed up the reaction. While palladium (Pd) is an efficient catalyst, it is expensive for the production of hydrogen.

### Decomposition of Ammonia Borane

The liquid phase reaction system may work for ammonia borane decomposition for the production of hydrogen (H₂). The ammonia borane decomposition involves one or more of the reactions below. The LSPR energy generated with the glass rod LSPR catalysts or other LSPR catalysts may facilitate one or more of these reactions to make the hydrogen production at a commercially acceptable rate.

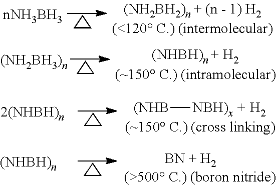

### Reactant(s) and Product(s)

For the ammonia borane decomposition, an aqueous solution of ammonia borane may be the sole or primary reactant. However, the ammonia borane aqueous solution may be supplied to the reaction vessel with one or more additional chemical entities for enhancing the reactions and/or stabilizing the reaction mixture in the reaction vessel. In addition to hydrogen (H₂), the above listed reactions generate various chemical entities containing borne and/or nitrogen. Hydrogen gas is collected, and the other chemical entities stay in the reaction vessel. Most of these other chemical entities, if not all, may deposit in the bottom of the reaction vessel.

### Concentration

In the ammonia borane aqueous solution, the concentration of ammonia borane may be adjusted to about 0.01, 0.02, 0.04, 0.06, 0.08, 0.1, 0.2, 0.3, 0.4, 0.5, 0.6, 0.7, 0.8, 0.9, 1, 1.2, 1.4, 1.6, 1.8, 2, 2.2, 2.4, 2.6, 2.8, 3, 3.2, 3.4, 3.6, 3.8, 4, 4.2, 4.4, 4.6, 4.8, 5, 5.2, 5.4, 5.6, 5.8, 6, 6.2, 6.4, 6.6, 6.8, 7, 7.2, 7.4, 7.6, 7.8, 8, 8.2, 8.4, 8.6, 8.8, 9, 9.2, 9.4, 9.6, 9.8 or 10 M/L, although not limited thereto. In embodiments, the concentration may be within a range formed by any two numbers listed in the immediately previous sentence. For example, the concentration is between about 0.1 M/L and about 1 M/L, between about 0.5 M/L and about 4 M/L, between about 2 M/L and about 10 M/L, etc.

### Wavelength of Light Beams

The light box supplies light beams into the flow reactor. The light beams may include a spectrum or range of various wavelengths as long as they include certain wavelengths that can excite metal nanoparticles for surface plasmon resonance. The wavelengths for surface plasmon resonance may depend on the metal, size, shape and aggregation of the nanoparticles. In embodiments, the light beams have one or more wavelengths of about 360, 380, 400, 410, 420, 440, 460, 480, 500, 520, 540, 550, 560, 580, 600, 620, 640, 660, 680, 700, 720, 740, or 760 nm, although not limited thereto.

### Intensity of Light Beams

The light source (not illustrated) may generate light beams with the intensity of about 10, 20, 30, 40, 50, 60, 70, 80, 90, 100, 120, 140, 160, 180, 200, 220, 240, 260, 280, 300, 320, 340, 360, 380, 400, 420, 440, 460, 480, 500, 520, 540, 560, 580, 600, 620, 640, 660, 780, 800, 820, 840, 860, 880, 900, 920, 940, 960, 980, or 1000 mW/cm². In embodiments, the intensity may be within a range formed by any two numbers listed in the immediately previous sentence. For example, the intensity is between about 30 mW/cm² and about 100 mW/cm², between about 200 mW/cm² and about 600 mW/cm², between about 400 ml/min and about 800 mW/cm², etc.

### Temperature

The ammonia borane cracking may be performed at room temperature without heating. Alternatively, the reaction vessel may be heated with at least one heater or heat source for the reaction at an elevated temperature. In addition, the ammonia borane aqueous solution may be preheated before supplying into the reaction vessel. At steady state of the ammonia cracking reaction, the temperature inside the flow reactor is about 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, 200, 205, 210, 215, 220, 225, 230, 235, 240, or 245, or 250° C., although not limited thereto. In embodiments, the temperature may be within a range formed by any two numbers listed in the immediately previous sentence. For example, the temperature is between about 25° C. and about 100° C., between about 100° C. and about 150° C., between about 150° C. and about 200° C., etc.

### Batch or Continuous Process

The ammonia borane cracking in the liquid phase reaction system may be performed in a batch process. Alternatively, the reaction can be performed continuously in the liquid phase reaction system. For example, the ammonia borane solution is continuously fed into the reaction vessel, and the gaseous products are collected through an outlet, which overall does not significantly change the composition in the reaction vessel over time.

### Maintenance

For continued performance of the LSPR catalyst device, the LSPR catalyst device may be replaced or refreshed to from time to time. First, the operation of the flow reaction system is temporarily stopped for maintenance. Then, the used glass rod LSPR catalysts may be replaced with new or refreshed ones. The used glass rod LSPR catalysts may be refreshed by removing at least part of the metal oxide formed on metal nanoparticles. For example, the used glass rod LSPR catalysts may be placed in a liquid cleaning solution such as gold/silver cleaner from Sigma-Aldrich (product number 901265).

### Combination of Features

This disclosure provides a lot of discussions and information about many features relating to nanoporous structures and/or glucose sensing technologies. It is the intention of this disclosure to provide as many devices, systems and methods relating to those features. Two or more features disclosed above may be combined together to form a device, system or method to the extent they are combinable even if a particular combination is not presented in the present disclosure. Also, it is the intention of this disclosure to pursue claims directed to many of those features disclosed herein. Some of those features are presented in the form of claims in the following section. Many claims are presented in dependent form by referring to one or more other claims. Applicant notes that some claims referring to multiple claims may encompass a combination of features that are in conflict with one another (hereinafter “improper combination”). However, Applicant recognizes that such claims may still encompass one or more combinations of features that do not have any conflicts with one another (hereinafter “proper combination”). By presenting claims that may encompass both proper and improper combinations, Applicant confirms its or inventor's possession of the proper combinations and intends to provide specific support for the proper combinations for later claiming of those proper combinations.

### EXAMPLES

Now various aspects and features of the present disclosure are further discussed in connection with examples and experiments.

### Providing Glass Plates

### Example 1.0

A piranha solution was prepared by mixing 98% sulfuric acid and 30% hydrogen peroxide with the ratio of 7:3.

### Example 1.1

Glass plates (5×5×0.7 mm) were immersed in the piranha solution of Example 1.0 for 30 minutes. Then, the glass plates were flipped and kept in the same solution for an additional 30 minutes. Subsequently, the glass plates were washed with distilled water 3 times and dried with a nitrogen spray gun.

### Example 1.2

Example 1.1 was repeated using glass plates (10×10×0.7 mm) in replacement of the glass plates (5×5×0.7 mm).

### Example 1.3

Example 1.1 was repeated using glass plates (15×15×0.7 mm) in replacement of the glass plates (5×5×0.7 mm).

### Example 1.4

Example 1.1 was repeated using glass plates (25×25×0.7 mm) in replacement of the glass plates (5×5×0.7 mm).

### Providing Glass Rods

### Example 1.5

Glass rods with diameter of 2 mm and length of 40-60 mm were immersed in the piranha solution of Example 1.0 for 30 minutes. Subsequently, the glass rods were washed with distilled water 3 times and dried with a nitrogen spray gun.

### Example 1.6

Example 1.5 was repeated using glass rods with diameter of 3 mm and length of 40-60 mm in replacement of the 2 mm diameter glass rods.

### Example 1.7

Example 1.5 was repeated using glass rods with diameter of 4 mm and length of 40-60 mm in replacement of the 2 mm diameter glass rods.

### Example 1.8

Example 1.5 was repeated using glass rods with diameter of 5 mm and length of 40-60 mm in replacement of the 2 mm diameter glass rods.

### Providing Glass Fiber Filters

### Example 1.9

Example 1.5 was repeated using glass rods with diameter of 6 mm and length of 40-60 mm in replacement of the 2 mm diameter glass rods.

### Example 1.10

Glass fiber filters with binder (1.0 μm pore size, 142 mm diameter) available from Millipore Sigma (SKU AP1514250) were immersed in the piranha solution of Example 1.0 for 30 minutes. Subsequently, the glass fiber filters were washed with distilled water 3 times and dried with a nitrogen spray gun.

### Example 1.11

Example 1.10 was repeated using glass fiber filters without binder (0.7 μm pore size, 9 mm diameter) available from Millipore Sigma (SKU AP4004700) in replacement of the glass fiber filter with no binder resin.

### Example 1.12

Glass beads (diameter smaller than 106 μm) available from Millipore Sigma (SKU G4649) were immersed in the piranha solution of Example 1.0 for 30 minutes. Subsequently, the glass beads were washed with distilled water 3 times and dried with a nitrogen spray gun.

### Example 1.13

Example 1.12 was repeated using glass beads (diameter 425-600 μm) available from Millipore Sigma (SKU G8772) in replacement of the glass beads (diameter smaller than 106 μm).

### Example 1.14

Example 1.12 was repeated using glass beads (diameter 710-1,180 μm) available from Millipore Sigma (SKU G1152) in replacement of the glass beads (diameter smaller than 106 μm).

Providing Glass Discs with Through Holes

### Example 1.15

Glass pieces in the disc shape are provided.

### Example 1.16

Glass discs provided in Example 1.15 are subject to drilling to form a plurality of through holes as illustrated in FIG. 35A.

### Example 1.17

Glass discs with a plurality of openings in the shape like FIG. 35B are prepared using the method illustrated in FIG. 35C.

### Example 1.18

The glass discs prepared in Example 1.16 are immersed in the piranha solution of Example 1.0 for 30 minutes. Subsequently, the glass discs with through holes are washed with distilled water 3 times and dried with a nitrogen spray gun.

### Examples 1.19

Example 1.18 is repeated except that glass discs prepared in Example 1.17 are used in replacement of the glass discs prepared in Example 1.16.

### Providing Glass Discs with Textured Surfaces

### Example 1.20

Glass pieces in the disc shape are provided.

### Example 1.21

Glass discs provided in Example 1.20 are subject to surface treated with etching to provide textures on the surface as illustrated in FIG. 36A.

### Example 1.22

Glass discs provided in Example 1.20 are subject to surface treated with powder blasting to provide textures on the surface as illustrated in FIG. 36B.

### Example 1.23

Glass discs provided in Example 1.20 are subject to surface treated with mechanical processing to provide textures on the surface as illustrated in FIG. 36C.

### Example 1.24

Glass discs provided in Example 1.20 are subject to surface treated with mechanical processing to provide textures on the surface as illustrated in FIG. 36D.

### Example 1.25

The glass discs prepared in Example 1.21 are immersed in the piranha solution of Example 1.0 for 30 minutes. Subsequently, the glass discs with surface-treated are washed with distilled water 3 times and dried with a nitrogen spray gun.

### Examples 1.26-1.28

Example 1.25 is repeated except that glass discs prepared in Examples 1.22-1.24 are used in replacement of the glass discs prepared in Example 1.21.

Preparing Coating Ligands

### Example 2.0

100 μl of 95% MPTMS (available from Sigma Aldrich) was added to 20 ml of 95% ethanol in a plastic (non-glass) container to provide a ligand composition.

### Example 2.1

The glass plates (5×5×0.7 mm) obtained in Example 1.1 were immersed in the ligand composition of Example 2.0 for 2 hours. Then, the glass plates were flipped and kept in the ligand composition for an additional 2 hours. Subsequently, the glass plates were taken out of the ligand composition, rinsed with water 3-4 times, and dried with a nitrogen spray gun. As a result, ligand-coated glass plates were obtained.

### Example 2.2

Example 2.1 was repeated using glass plates (10×10×0.7 mm) from Example 1.2 in replacement of the glass plates.

### Example 2.3

Example 2.1 was repeated using glass plates (15×15×0.7 mm) from Example 1.3 in replacement of the glass plates.

### Example 2.4

Example 2.1 was repeated using glass plates (25×25×0.7 mm) from Example 1.4 in replacement of the glass plates.

### Example 2.5

The glass rods with 2 mm diameter from Example 1.5 were immersed in the ligand composition of Example 2.0 for 2 hours. Subsequently, the glass rods were taken out of the ligand composition, rinsed with water 3-4 times, and dried with a nitrogen spray gun. As a result, ligand-coated glass rods were obtained.

### Example 2.6

Example 2.5 was repeated using glass rods with 3 mm diameter from Example 1.6 in replacement of the glass rods with 2 mm diameter.

### Example 2.7

Example 2.5 was repeated using glass rods with 4 mm diameter from Example 1.7 in replacement of the glass plates with 2 mm diameter.

### Example 2.8

Example 2.5 was repeated using glass rods with 5 mm diameter from Example 1.8 in replacement of the glass plates with 2 mm diameter.

### Example 2.9

Example 2.5 was repeated using glass rods with 6 mm diameter from Example 1.9 in replacement of the glass plates with 2 mm diameter.

### Example 2.9

Example 2.5 was repeated using glass rods with 6 mm diameter from Example 1.9 in replacement of the glass plates with 2 mm diameter.

### Example 2.10

The glass fiber filters with binder resin from Example 1.10 were immersed in the ligand composition of Example 2.0 for 2 hours. Subsequently, the glass fiber filters were taken out of the ligand composition, rinsed with water 3-4 times, and dried with a nitrogen spray gun. As a result, ligand-coated glass fiber filters were obtained.

### Example 2.11

Example 2.10 was repeated using glass fiber filters with no binder resin from Example 1.11 in replacement of the glass fiber filters with binder resin.

### Example 2.12

The glass beads (diameter smaller than 106 μm) from Example 1.12 were immersed in the ligand composition of Example 2.0 for 2 hours. Subsequently, the glass beads were taken out of the ligand composition, rinsed with water 3-4 times, and dried with a nitrogen spray gun. As a result, ligand-coated glass beads were obtained.

### Example 2.13

Example 2.12 was repeated using glass beads (diameter 425-600 μm) with no binder resin from Example 1.11 in replacement of the glass beads (diameter smaller than 106 μm).

### Example 2.14

Example 2.12 was repeated using glass beads (diameter 710-1,180 μm) with no binder resin from Example 1.11 in replacement of the glass beads (diameter smaller than 106 μm).

### Example 2.15-2.16

The glass discs from Examples 1.18-1.19 are immersed in the ligand composition of Example 2.0 for 2 hours. Subsequently, the glass discs are taken out of the ligand composition, rinsed with water 3-4 times, and dried with a nitrogen spray gun. As a result, ligand-coated glass discs with through holes are obtained.

### Example 2.17-2.20

The glass discs from Examples 1.25-1.28 are immersed in the ligand composition of Example 2.0 for 2 hours. Subsequently, the glass discs are taken out of the ligand composition, rinsed with water 3-4 times, and dried with a nitrogen spray gun. As a result, ligand-coated glass discs with textured surfaces are obtained.

### Preparing Nanoparticle Coating Liquid

### Example 3.1

A diameter 30 nm gold nanoparticle suspension (synthesized by Applicant) was centrifuged to provide concentrated nanoparticles (OD 3.18 at 528 nm). Distilled water was added to the concentrated nanoparticles to provide a nanoparticle-water suspension, which is then moved to a petri dish (diameter 3.5 cm). 2 ml hexane was added to the petri dish to form oil/water two-phase interface in the petri dish. Then, ethanol was rapidly injected into the petri dish with a syringe. Subsequently, the mixture was left for 2 hours, which let hexane fully evaporated, which provided a nanoparticle coating liquid. The foregoing process was repeated to produce multiple coating liquids in petri dishes.

### Example 3.2

Example 3.1 was repeated using a diameter 30 nm gold nanoparticle suspension (synthesized by Applicant, concentrated OD 5.072 at 524 nm) in replacement of the gold nanoparticles.

### Example 3.3

Example 3.1 was repeated using a diameter 30 nm gold nanoparticle suspension (synthesized by Applicant, concentrated OD 5.624 at 524 nm) in replacement of the gold nanoparticles.

### Example 3.4

Example 3.1 was repeated using a diameter 60 nm gold nanoparticle suspension (synthesized by Applicant, concentrated OD 2.97 at 535 nm) in replacement of the gold nanoparticles.

### Example 3.5

Example 3.1 was repeated using a diameter 60 nm gold nanoparticle suspension (synthesized by Applicant, concentrated OD 4.014 nm at 533 nm) in replacement of the gold nanoparticles.

### Example 3.6

Example 3.1 was repeated using a diameter 40 nm gold nanoparticle suspension (from BBI Solution, concentrated OD 3.04 at 524 nm) in replacement of the gold nanoparticles.

### Example 3.7

Example 3.1 was repeated using a diameter 40 nm gold nanoparticle suspension (from Cyto Diagnostics, concentrated OD approx. OD 3) in replacement of the gold nanoparticles.

### Example 3.8

Example 3.1 was repeated using a diameter 40 nm silver nanoparticle suspension (from Sigma-Aldrich, concentrated OD 3.56 at 420 nm) in replacement of the gold nanoparticles.

### Example 3.9

Example 3.1 was repeated using a diameter 25 nm copper nanoparticle suspension (from Sigma-Aldrich, concentrated OD unknown) in replacement of the gold nanoparticles.

### Example 3.10

Example 3.1 was repeated using a diameter 25 nm silver-coated copper nanoparticles suspension (synthesized by Applicant using copper nanoparticles from Sigma-Aldrich, concentrated OD unknown) in replacement of the gold nanoparticles.

### Forming LSPR Catalysts—Coating Nanoparticles on Glass Plates and Glass Rods

### Example 4.1

A ligand-coated glass plate (5×5×0.7 mm) from Example 2.1 was rinsed with water 3-4 times and dried with a nitrogen spray gun. The ligand-coated glass plate was picked with lab tweezers and dipped into a nanoparticle coating liquid prepared in Example 3.1 to have it submerged under the nanoparticle array of the nanoparticle coating liquid. Then, the ligand-coated glass plate was gently lifted out of the nanoparticle coating liquid while maintaining the glass plate generally horizontally, which was to scoop nanoparticles on the top surface of the glass plate. When completely lifted out of the coating liquid, nanoparticles and liquid were observed on both top and bottom surfaces of the glass plate. As the liquid was drying off from the peripheries of the glass plate, it was placed on a petri dish for drying for 1-2 hours. After drying, the nanoparticle-coated glass plate was washed with water 3-4 times and dried with a nitrogen spray gun. As a result, a nanoparticle-coated glass plate (5×5×0.7 mm) was obtained. The foregoing process was repeated to produce multiple copies of nanoparticle-coated glass plate (5×5×0.7 mm).

### Examples 4.2-4.6

Example 4.1 was repeated for ligand-coated glass plates (5×5×0.7 mm) from Example 2.1 using nanoparticle coating liquids prepared in Examples 3.2-3.6 individually to provide nanoparticle-coated glass plates of Examples 4.2-4.6, respectively. This process was repeated to produce multiple copies of the nanoparticle-coated glass plate for each of Examples 4.2-4.6.

### Examples 4.7

Example 4.1 was repeated for another ligand-coated glass plate (5×5×0.7 mm) from Example 2.1 using a nanoparticle coating liquid prepared in Examples 3.8 to provide a nanoparticle-coated glass plate. This process was repeated to produce multiple copies of the nanoparticle-coated glass plate.

### Examples 4.8

Example 4.1 was repeated for another ligand-coated glass plate (5×5×0.7 mm) from Example 2.1 using a nanoparticle coating liquid prepared in Examples 3.10 to provide a nanoparticle-coated glass plate. This process was repeated to produce multiple copies of the nanoparticle-coated glass plate.

### Examples 4.9

Example 4.1 was repeated for a ligand-coated glass plate (10×10×0.7 mm) from Example 2.2 using a nanoparticle coating liquid prepared in Examples 3.6 to provide a nanoparticle-coated glass plate. This process was repeated to produce multiple copies of the nanoparticle-coated glass plate.

### Examples 4.10

Example 4.1 was repeated for a ligand-coated glass plate (15×15×0.7 mm) from Example 2.3 using a nanoparticle coating liquid prepared in Examples 3.6 to provide a nanoparticle-coated glass plate. This process was repeated to produce multiple copies of the nanoparticle-coated glass plate.

### Examples 4.11

Example 4.1 was repeated for a ligand-coated glass plate (25×25×0.7 mm) from Example 2.4 using a nanoparticle coating liquid prepared in Examples 3.6 to provide a nanoparticle-coated glass plate. This process was repeated to produce multiple copies of the nanoparticle-coated glass plate.

### Examples 4.12

A ligand-coated glass rod (2 mm diameter) from Example 2.5 was rinsed with water 3-4 times and dried with a nitrogen spray gun. The ligand-coated glass rod was picked with lab tweezers and dipped into a nanoparticle coating liquid prepared in Example 3.7. The ligand-coated glass rod was oriented to extend generally horizontally under the nanoparticle array of the nanoparticle coating liquid. Then, the glass rod was gently lifted out of the nanoparticle coating liquid while maintaining the glass rod generally horizontally such that the circumference of the glass rod contacts as much of the nanoparticle array. When completely lifted out of the coating liquid, nanoparticles and liquid were observed on the circumference of the glass rod. The glass rod was kept in the air without contacting any object to dry off the liquid from the circumference. After drying, the nanoparticle-coated glass rod was washed with water 3-4 times and dried with a nitrogen spray gun. As a result, a nanoparticle-coated glass rod was obtained.

### Examples 4.13

Example 4.12 was repeated for a ligand-coated glass rod (2 mm diameter) from Example 2.5 using a nanoparticle coating liquid prepared in Examples 3.8 to provide a nanoparticle-coated glass rod. This process was repeated to produce multiple copies of the nanoparticle-coated glass rod.

### Examples 4.14

Example 4.12 was repeated for a ligand-coated glass rod (2 mm diameter) from Example 2.5 using a nanoparticle coating liquid prepared in Examples 3.9 to provide a nanoparticle-coated glass rod. This process was repeated to produce multiple copies of the nanoparticle-coated glass rod

### Examples 4.15

Example 4.12 was repeated for a ligand-coated glass rod (2 mm diameter) from Example 2.5 using a nanoparticle coating liquid prepared in Examples 3.10 to provide a nanoparticle-coated glass rod. This process was repeated to produce multiple copies of the nanoparticle-coated glass rod.

### Examples 4.16

Example 4.12 was repeated for a ligand-coated glass rod (3 mm diameter) from Example 2.6 using a nanoparticle coating liquid prepared in Examples 3.1 to provide a nanoparticle-coated glass rod. This process was repeated to produce multiple copies of the nanoparticle-coated glass rod

### Examples 4.17

Example 4.12 was repeated for a ligand-coated glass rod (3 mm diameter) from Example 2.6 using a nanoparticle coating liquid prepared in Examples 3.7 to provide a nanoparticle-coated glass rod. This process was repeated to produce multiple copies of the nanoparticle-coated glass rod

### Examples 4.18

Example 4.12 was repeated for a ligand-coated glass rod (3 mm diameter) from Example 2.6 using a nanoparticle coating liquid prepared in Examples 3.8 to provide a nanoparticle-coated glass rod. This process was repeated to produce multiple copies of the nanoparticle-coated glass rod.

### Examples 4.19

Example 4.12 was repeated for a ligand-coated glass rod (3 mm diameter) from Example 2.6 using a nanoparticle coating liquid prepared in Examples 3.9 to provide a nanoparticle-coated glass rod. This process was repeated to produce multiple copies of the nanoparticle-coated glass rod.

### Examples 4.20

Example 4.12 was repeated for a ligand-coated glass rod (3 mm diameter) from Example 2.6 using a nanoparticle coating liquid prepared in Examples 3.10 to provide a nanoparticle-coated glass rod. This process was repeated to produce multiple copies of the nanoparticle-coated glass rod.

### Examples 4.21

Example 4.12 was repeated for a ligand-coated glass rod (4 mm diameter) from Example 2.7 using a nanoparticle coating liquid prepared in Examples 3.1 to provide a nanoparticle-coated glass rod. This process was repeated to produce multiple copies of the nanoparticle-coated glass rod.

### Examples 4.22

Example 4.12 was repeated for a ligand-coated glass rod (4 mm diameter) from Example 2.7 using a nanoparticle coating liquid prepared in Examples 3.7 to provide a nanoparticle-coated glass rod. This process was repeated to produce multiple copies of the nanoparticle-coated glass rod.

### Examples 4.23

Example 4.12 was repeated for a ligand-coated glass rod (4 mm diameter) from Example 2.7 using a nanoparticle coating liquid prepared in Examples 3.8 to provide a nanoparticle-coated glass rod. This process was repeated to produce multiple copies of the nanoparticle-coated glass rod.

### Examples 4.24

Example 4.12 was repeated for a ligand-coated glass rod (4 mm diameter) from Example 2.7 using a nanoparticle coating liquid prepared in Examples 3.9 to provide a nanoparticle-coated glass rod. This process was repeated to produce multiple copies of the nanoparticle-coated glass rod.

### Examples 4.25

Example 4.12 was repeated for a ligand-coated glass rod (4 mm diameter) from Example 2.7 using a nanoparticle coating liquid prepared in Examples 3.10 to provide a nanoparticle-coated glass rod. This process was repeated to produce multiple copies of the nanoparticle-coated glass rod.

### Examples 4.26

Example 4.12 was repeated for a ligand-coated glass rod (5 mm diameter) from Example 2.8 using a nanoparticle coating liquid prepared in Examples 3.4 to provide a nanoparticle-coated glass rod. This process was repeated to produce multiple copies of the nanoparticle-coated glass rod.

### Examples 4.27

Example 4.12 was repeated for a ligand-coated glass rod (6 mm diameter) from Example 2.9 using a nanoparticle coating liquid prepared in Examples 3.1 to provide a nanoparticle-coated glass rod. This process was repeated to produce multiple copies of the nanoparticle-coated glass rod.

### Examples 4.28

A ligand-coated glass fiber filter from Example 2.10 was rinsed with water 3-4 times and dried with a nitrogen spray gun. The ligand-coated glass fiber filter was dipped into a nanoparticle coating liquid prepared in Example 3.10. Then, the ligand-coated glass fiber filter was gently lifted out of the nanoparticle coating liquid and placed on a petri dish for drying. After drying, the nanoparticle-coated glass rod was washed with water 3-4 times and dried with a nitrogen spray gun. As a result, a nanoparticle-coated glass fiber filter was obtained. The foregoing process was repeated to produce multiple copies of nanoparticle-coated fiber filters.

### Examples 4.29

Example 4.28 was repeated for a ligand-coated glass fiber filter from Example 2.11 in replacement of the ligand-coated glass rod using a nanoparticle coating liquid prepared in Examples 3.10 to provide a nanoparticle-coated glass fiber filter. This process was repeated to produce multiple copies of the nanoparticle-coated glass fiber filters.

### Examples 4.30

Ligand-coated glass beads (diameter smaller than 106 μm) from Example 2.12 were rinsed with water 3-4 times and dried with a nitrogen spray gun. The ligand-coated glass beads were picked with lab tweezers and individually dropped into a nanoparticle coating liquid prepared in Example 3.10 from above the nanoparticle coating liquid at a level high enough to make sure that the ligand-coated glass bead goes into the water passing the layer or array of metal nanoparticles. As the ligand-coated glass bead went into the water passing the metal nanoparticles, the bead was coated with metal nanoparticles. Then, the glass bead was picked up and subject to drying. After drying, the nanoparticle-coated glass bead was washed with water 3-4 times and dried with a nitrogen spray gun. As a result a nanoparticle-coated glass bead was obtained. The foregoing process was repeated to produce multiple copies of nanoparticle-coated glass beads.

### Examples 4.31

Example 4.30 was repeated for ligand-coated glass bead from Example 2.13 in replacement of the ligand-coated glass rod using a nanoparticle coating liquid prepared in Examples 3.10 to provide a nanoparticle-coated glass bead. This process was repeated to produce more nanoparticle-coated glass beads.

### Examples 4.32

Example 4.30 was repeated for a ligand-coated glass beads from Example 2.14 in replacement of the ligand-coated glass rod using a nanoparticle coating liquid prepared in Examples 3.10 to provide a nanoparticle-coated glass bead. This process was repeated to produce more nanoparticle-coated glass beads.

### Examples 4.33-4.34

Ligand-coated glass discs with through holes from Examples 2.15-2.16 are rinsed with water 3-4 times and dried with a nitrogen spray gun. The ligand-coated glass discs are picked with lab tweezers and individually dropped into a nanoparticle coating liquid prepared in Example 3.10 from above the nanoparticle coating liquid at a level high enough to make sure that the ligand-coated glass disc goes into the water passing the layer or array of metal nanoparticles. As the ligand-coated glass disc goes into the water passing the metal nanoparticles, the disc is coated with metal nanoparticles. Then, the glass disc is picked up and subject to drying. After drying, the nanoparticle-coated glass disc is washed with water 3-4 times and dried with a nitrogen spray gun. As a result a nanoparticle-coated glass disc is obtained. The foregoing process is repeated to produce multiple copies of nanoparticle-coated glass discs.

### Examples 4.35-4.38

Ligand-coated glass discs with surface-treated from Examples 2.17-2.20 are rinsed with water 3-4 times and dried with a nitrogen spray gun. The ligand-coated glass discs are picked with lab tweezers and individually dropped into a nanoparticle coating liquid prepared in Example 3.10 from above the nanoparticle coating liquid at a level high enough to make sure that the ligand-coated glass disc goes into the water passing the layer or array of metal nanoparticles. As the ligand-coated glass disc goes into the water passing the metal nanoparticles, the disc is coated with metal nanoparticles. Then, the glass disc is picked up and subject to drying. After drying, the nanoparticle-coated glass disc is washed with water 3-4 times and dried with a nitrogen spray gun. As a result, a nanoparticle-coated glass disc is obtained. The foregoing process is repeated to produce multiple copies of nanoparticle-coated glass discs.

### Removing Oxide Layer

### Example 5.0

37% hydrochloric acid (HCl), 30 hydrogen peroxide (H₂O₂), and water were mixed with the ratio of 3:3:94 to provide a cleaning solution.

### Examples 5.1-5.4

The nanoparticle-coated glass plates prepared in Examples 4.1-4.4 were immersed in the cleaning solution of Example 5.0 with the coated surface upward for 5-20 minutes. Subsequently, the nanoparticle-coated glass plates were washed with water 3-4 times and dried with a nitrogen spray gun. As a result, the nanoparticle-coated glass plates were ready for use as LSPR catalyst.

### Examples 5.5-5.32

The nanoparticle-coated glass rods, glass fiber filters and glass beads prepared in Examples 4.5-4.32 were immersed in the cleaning solution of Example 5.0 for 5-20 minutes. Subsequently, the nanoparticle-coated glass rods, glass fiber filters, and glass beads were washed with water 3-4 times and dried with a nitrogen spray gun. As a result, the nanoparticle-coated glass p rods, glass fiber filters, and glass beads were ready for use as LSPR catalyst.

### Images

### Examples 6.1-6.7

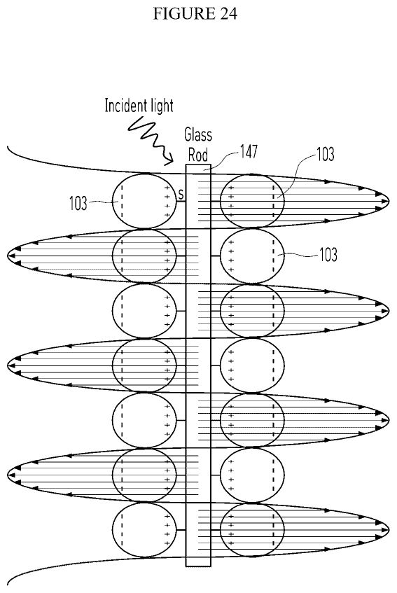

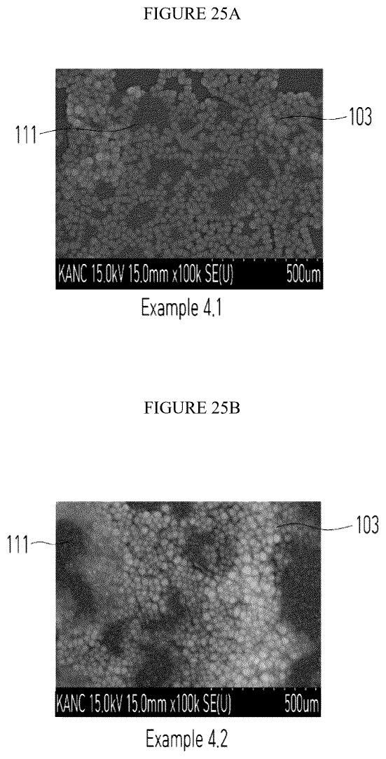

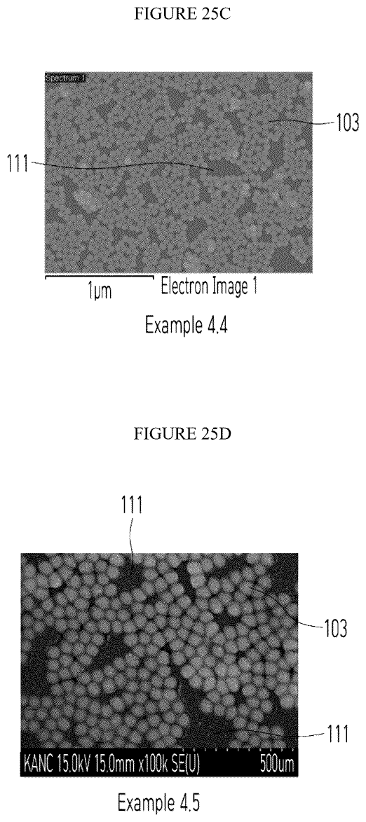

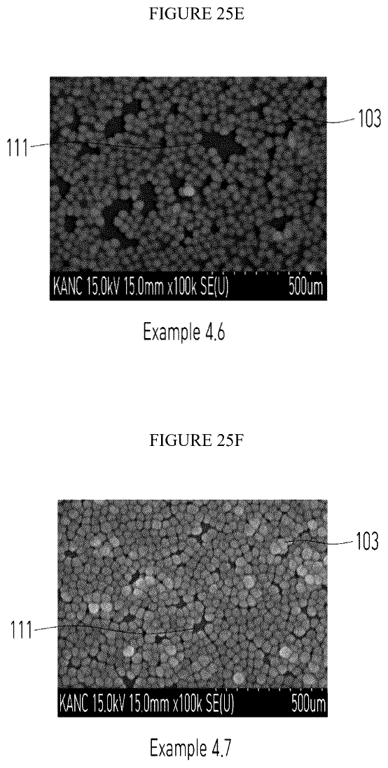

Photographs of the nanoparticles were obtained for the glass plates. The images of FIG. 25 are glass plates from Examples 4.1-4.7. The images confirm that an array of nanoparticles 103 were formed in a monolayer on the underlying glass surfaces.

### Ammonia Borane Decomposition

### Example 7.0

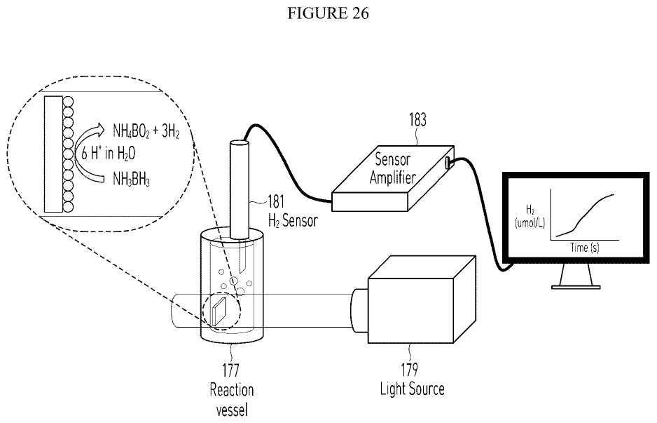

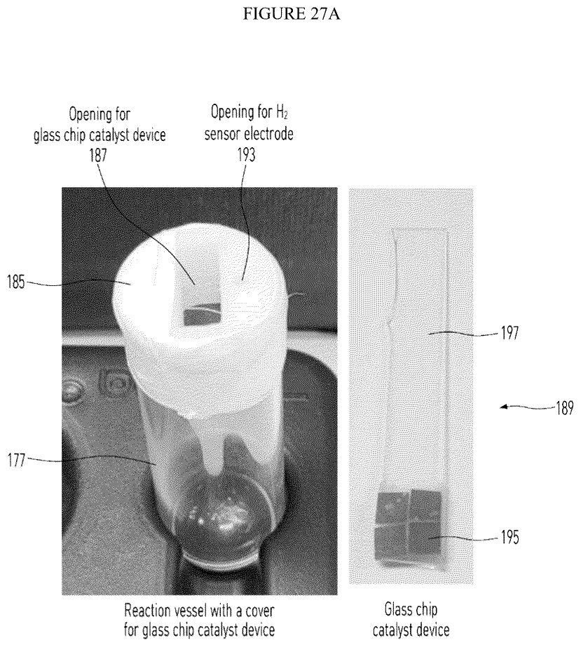

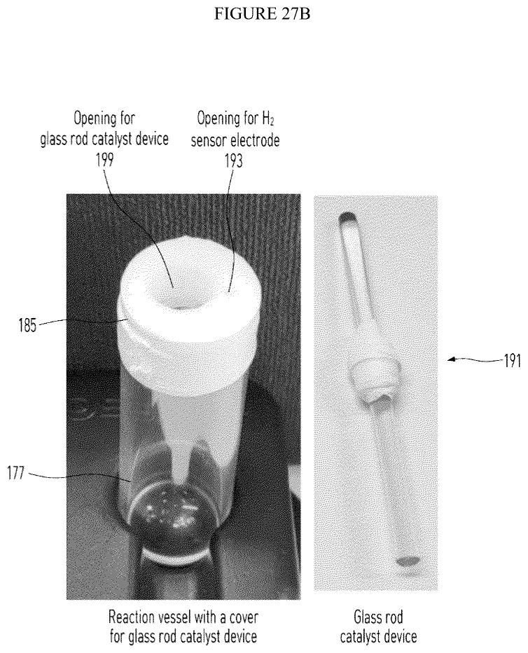

A liquid phase reaction system for ammonia borane decomposition and hydrogen measurement was built as illustrated in FIG. 26. The system included a transparent glass reaction vessel 177, a light source 179, a hydrogen sensor 181, and a sensor signal amplifier 183. The top of the reaction vessel was covered with a cover 185 as shown in FIGS. 27A and 27B. Referring to FIG. 27A, the cover 185 airtightly contacts the reaction vessel 177 and has a rectangular opening 187 for an LSPR catalyst device 189. Referring to FIG. 27B, the cover 185 airtightly contacts the reaction vessel 177 and a round opening 199 for an electrode for the hydrogen sensor 181. The light source 179 (LS-150 Xenon Arc from UniNanotech) was placed at 120 mm from the reaction vessel 177 to illuminate inside the reaction vessel where an LSPR catalyst device 189 or 191 is to be placed. The hydrogen sensor (H2-NPLR-006402 from Unisense) was made ready for measuring the concentration of hydrogen gas generated inside the reaction vessel.

### Example 7.1

6 ml of 0.02 M ammonia borane aqueous solution was added to the transparent glass reaction vessel 177 of the system as in FIG. 26. The electrode of the hydrogen sensor 181 was inserted into the reaction vessel through the round opening 193 of the cover, which was then airtightly sealed. The hydrogen sensor was turned on for measurement of hydrogen gas for 5 to 10 minutes. Four nanoparticle-coated glass plates 195 (5×5 mm) obtained in Example 4.1 were attached on an elongated glass plate 197 as shown in FIG. 27A. Then, the elongated glass plate (10×60 mm) were inserted into the reaction vessel via the opening 187 in the cover such that the nanoparticle-coated glass plates 195 (catalyst device 189) contact the solution contained in the reaction vessel. Then, the opening was airtightly sealed. The LSPR catalyst device 189 was oriented such the surfaces of the catalyst device were generally perpendicular to the incident light beams. The hydrogen sensor measured concentration of hydrogen generated in the reaction vessel for 5 minutes. Subsequently, the light source was turned on and hydrogen sensor measures the concentration of hydrogen for at least 30 minutes. During this process, the reaction vessel was maintained at a temperature within 25-30° at which the decomposition of ammonia borane is thermodynamically least likely.

### Example 7.2-7.11

Example 7.1 was repeated for nanoparticle-coated glass plates from Examples 4.2-11 respectively in replacement nanoparticle-coated glass plate from Example 7.1.

### Example 7.12

6 ml of 0.02 M ammonia borane aqueous solution was added to the transparent glass reaction vessel 177 of the system as in FIG. 26. The electrode of the hydrogen sensor was inserted into the reaction vessel through the round opening 193 of the cover 185, which was then airtightly sealed. The hydrogen sensor was turned on for measurement of hydrogen gas for 5 to 10 minutes. Subsequently, a nanoparticle-coated glass rod (glass rod catalyst device 191) from Example 4.12 was inserted into the reaction vessel via the opening 199 in the cover 185 of FIG. 27B, which was then airtightly sealed. The glass rod catalyst device was arranged inside the reaction vessel such the surfaces of the catalyst device were to receive the incident light beams. The hydrogen sensor measured concentration of hydrogen generated in the reaction vessel for 5 minutes. Subsequently, the light source was turned on and hydrogen sensor measures the concentration of hydrogen for at least 30 minutes. During this process, the reaction vessel was maintained at a temperature within 25-30° at which the decomposition of ammonia borane is thermodynamically least likely.

### Example 7.13-7.27

Example 7.12 was repeated for a nanoparticle-coated glass rod from Examples 4.12-27 respectively in replacement nanoparticle-coated glass plate from Example 7.12.

### Ammonia Decomposition

### Example 8.1

A flow reaction system 125 as illustrated in FIG. 14 is built with a glass rod catalyst device illustrated in FIG. 16A. The system is set to continuously supply ammonia gas into the flow reactor from the reactant supply and to constantly send light beams into the flow reactor from the light box. The system is controlled to perform 8 separate flow reactions for 1 hour each at different temperatures of about 25° C., about 50° C., about 75° C., about 100° C., about 125° C., about 150° C., about 175° C., about 200° C. For each separate flow reaction, reaction products are collected at the product collector. The hydrogen production performance is assessed for each flow reaction.

### Example 8.2

Example 8.1 is repeated using a glass rod catalyst device illustrated in FIG. 17A instead of FIG. 14.

### Example 8.3

Example 8.1 is repeated using a glass rod catalyst device illustrated in FIG. 18A instead of FIG. 14.

### Example 8.4

Example 8.1 is repeated using a glass rod catalyst device illustrated in FIG. 19A instead of FIG. 14.

### Example 8.5

Example 8.1 is repeated using a glass rod catalyst device illustrated in FIG. 20 instead of FIG. 14.

### Example 8.6

Example 8.1 is repeated using a glass rod catalyst device illustrated in FIG. 21A instead of FIG. 14.

### Example 8.7

A flow reaction system 125 as illustrated in FIG. 15 is built with a glass rod catalyst device 145 illustrated in FIG. 16A in each flow reactor. The system is set to continuously supply ammonia gas into the flow reactor from the reactant supply and to constantly send light beams into the flow reactor from the light box. The system is controlled to perform 8 separate flow reactions for 1 hour each at different temperatures of about 25° C., about 50° C., about 75° C., about 100° C., about 125° C., about 150° C., about 175° C., and about 200° C. For each separate flow reaction, reaction products are collected at the product collector. The hydrogen production performance is assessed for each flow reaction.

### Example 8.8

Example 8.7 is repeated using a glass rod catalyst device illustrated in FIG. 17A instead of FIG. 14.

### Example 8.9

Example 8.7 is repeated using a glass rod catalyst device illustrated in FIG. 18A instead of FIG. 14.

### Example 8.10

Example 8.7 is repeated using a glass rod catalyst device illustrated in FIG. 19A instead of FIG. 14.

### Example 8.11

Example 8.7 is repeated using a glass rod catalyst device illustrated in FIG. 20 instead of FIG. 14.

### Example 8.12

Example 8.7 is repeated using a glass rod catalyst device illustrated in FIG. 21A instead of FIG. 14.

### Example 8.13

A flow reaction system 125 as illustrated in FIG. 15 is built with a glass rod catalyst device 145 illustrated in FIG. 16A in each flow reactor. The system is set to continuously supply plasma-treated ammonia gas into the flow reactor from the reactant supply and to constantly send light beams into the flow reactor from the light box. The system is controlled to perform 8 separate flow reactions for 1 hour each at different temperatures of about 25° C., about 50° C., about 75° C., about 100° C., about 125° C., about 150° C., about 175° C., and about 200° C. For each separate flow reaction, reaction products are collected at the product collector. The hydrogen production performance is assessed for each flow reaction.

### Example 8.14

Example 8.13 is repeated using a glass rod catalyst device illustrated in FIG. 17A instead of FIG. 14.

### Example 8.15

Example 8.13 is repeated using a glass rod catalyst device illustrated in FIG. 18A instead of FIG. 14.

### Example 8.16

Example 8.13 is repeated using a glass rod catalyst device illustrated in FIG. 19A instead of FIG. 14.

### Example 8.17

Example 8.13 is repeated using a glass rod catalyst device illustrated in FIG. 20 instead of FIG. 14.

### Example 8.18

Example 8.13 is repeated using a glass rod catalyst device illustrated in FIG. 21A instead of FIG. 14.

### Example 8.19

A flow reaction system 125 as illustrated in FIG. 14 is built with a flow reactor 164 and multiple light sources 172 installed outside the flow reactor 164 as illustrated in FIG. 37A. The flow reactor 164 includes an elongated glass tube such that the light beams from the light source may enter the inner space of the flow reactor. A plurality of glass discs with through holes prepared in Example 4.33 are arranged inside the elongated glass tube with a space between adjacent ones of the glass discs as illustrated in FIG. 37A. The system is set to continuously supply ammonia gas into the flow reactor from the reactant supply and to constantly send light beams to the flow reactor. The system is controlled to perform 8 separate flow reactions for 1 hour each at different temperatures of about 25° C., about 50° C., about 75° C., about 100° C., about 125° C., about 150° C., about 175° C., about 200° C., about 250° C., about 300° C., about 350° C. and about 400° C. For each separate flow reaction, reaction products are collected at the product collector. The hydrogen production performance is assessed for each flow reaction.

### Example 8.20

Example 8.19 is repeated except that the flow reaction system does not include the light box.

### Example 8.21

A flow reaction system 125 as illustrated in FIG. 14 is built with a flow reactor 164 and multiple light sources 172 installed outside the flow reactor 164 as illustrated in FIG. 37B. The flow reactor 164 includes an elongated glass tube such that the light beams from the light source may enter the inner space of the flow reactor. A plurality of glass discs with through holes prepared in Example 4.34 are arranged inside the elongated glass tube with a space between adjacent ones of the glass discs as illustrated in FIG. 37A. The system is set to continuously supply ammonia gas into the flow reactor from the reactant supply and to constantly send light beams to the flow reactor. The system is controlled to perform 8 separate flow reactions for 1 hour each at different temperatures of about 25° C., about 50° C., about 75° C., about 100° C., about 125° C., about 150° C., about 175° C., about 200° C., about 250° C., about 300° C., about 350° C. and about 400° C. For each separate flow reaction, reaction products are collected at the product collector. The hydrogen production performance is assessed for each flow reaction.

### Example 8.22

Example 8.19 is repeated except that the flow reaction system does not include the light box.

### Example 8.23

A flow reaction system 125 as illustrated in FIG. 15 is built with flow reactors 164 and multiple light sources 172 installed outside the flow reactor 164 as illustrated in FIG. 37A. Each flow reactor 164 includes an elongated glass tube such that the light beams from the light source may enter the inner space of the flow reactor. A plurality of glass discs with through holes prepared in Example 4.33 are arranged inside the elongated glass tube with a space between adjacent ones of the glass discs as illustrated in FIG. 37A. The system is set to continuously supply ammonia gas into the flow reactor from the reactant supply and to constantly send light beams to the flow reactor. The system is controlled to perform 8 separate flow reactions for 1 hour each at different temperatures of about 25° C., about 50° C., about 75° C., about 100° C., about 125° C., about 150° C., about 175° C., about 200° C., about 250° C., about 300° C., about 350° C. and about 400° C. For each separate flow reaction, reaction products are collected at the product collector. The hydrogen production performance is assessed for each flow reaction.

### Example 8.24

Example 8.23 is repeated except that the flow reaction system does not include the light box.

### Example 8.25

A flow reaction system 125 as illustrated in FIG. 15 is built with flow reactors 164 and multiple light sources 172 installed outside the flow reactor 164 as illustrated in FIG. 37B. Each flow reactor 164 includes an elongated glass tube such that the light beams from the light source may enter the inner space of the flow reactor. A plurality of glass discs with through holes prepared in Example 4.34 are arranged inside the elongated glass tube with a space between adjacent ones of the glass discs as illustrated in FIG. 37A. The system is set to continuously supply ammonia gas into the flow reactor from the reactant supply and to constantly send light beams to the flow reactor. The system is controlled to perform 8 separate flow reactions for 1 hour each at different temperatures of about 25° C., about 50° C., about 75° C., about 100° C., about 125° C., about 150° C., about 175° C., about 200° C., about 250° C., about 300° C., about 350° C. and about 400° C. For each separate flow reaction, reaction products are collected at the product collector. The hydrogen production performance is assessed for each flow reaction.

### Example 8.26

Example 8.25 is repeated except that the flow reaction system does not include the light box.

Glass Bead LSPR Catalyst

### Example 9.1

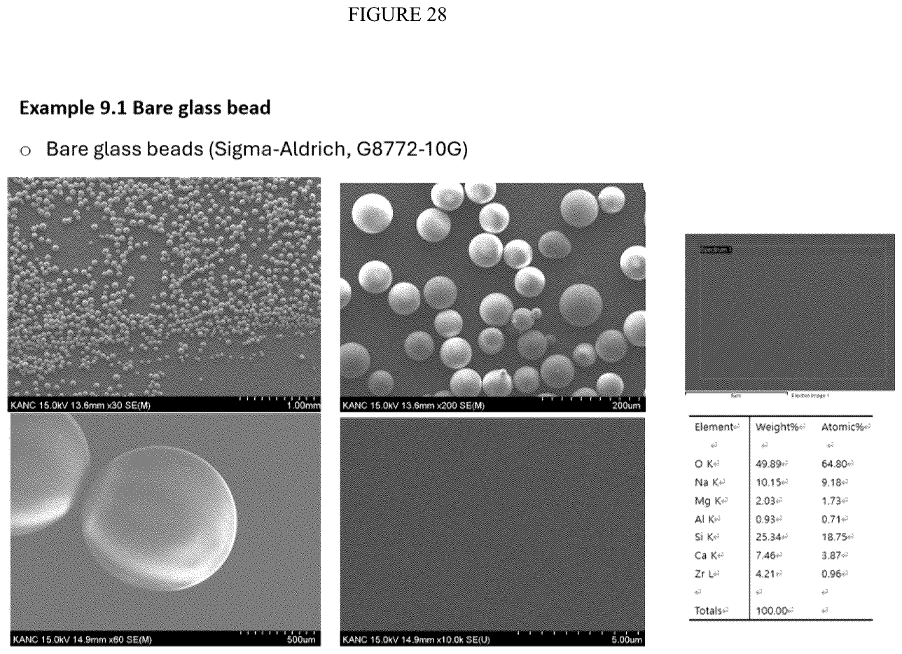

Glass beads (Sigma-Aldrich G8772-10G) were purchased. FIG. 28 includes SEM photographs of the glass beads.

### Example 9.2

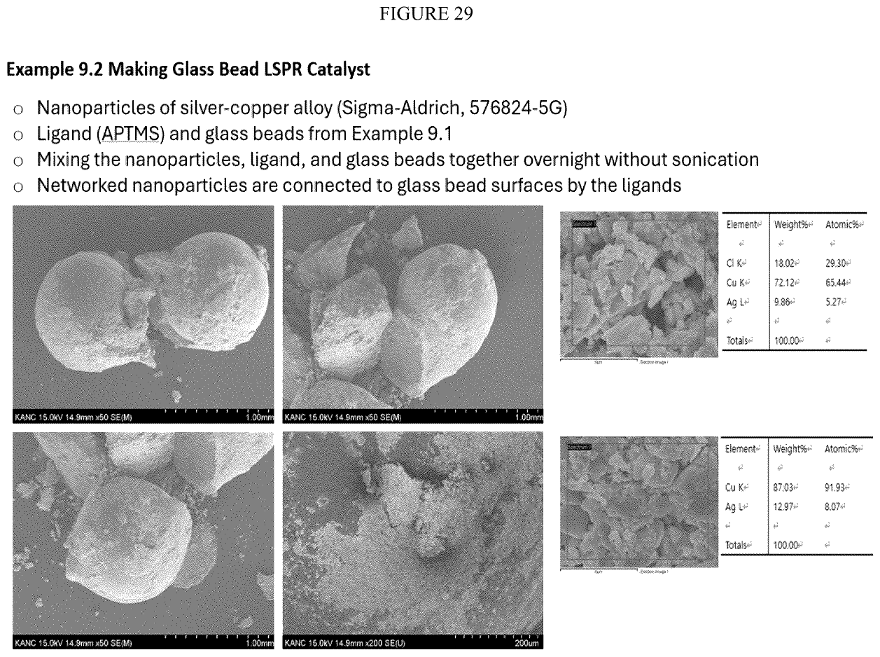

The glass beads from Example 9.1, Ag—Cu alloy nanoparticles (Sigma-Aldrich 576824-5G), and ligand (APTMS) were mixed in liquid phase overnight. Networked nanoparticles over glass bead surfaces were observed. FIG. 29 includes SEM photographs of the glass beads.

### Example 9.3

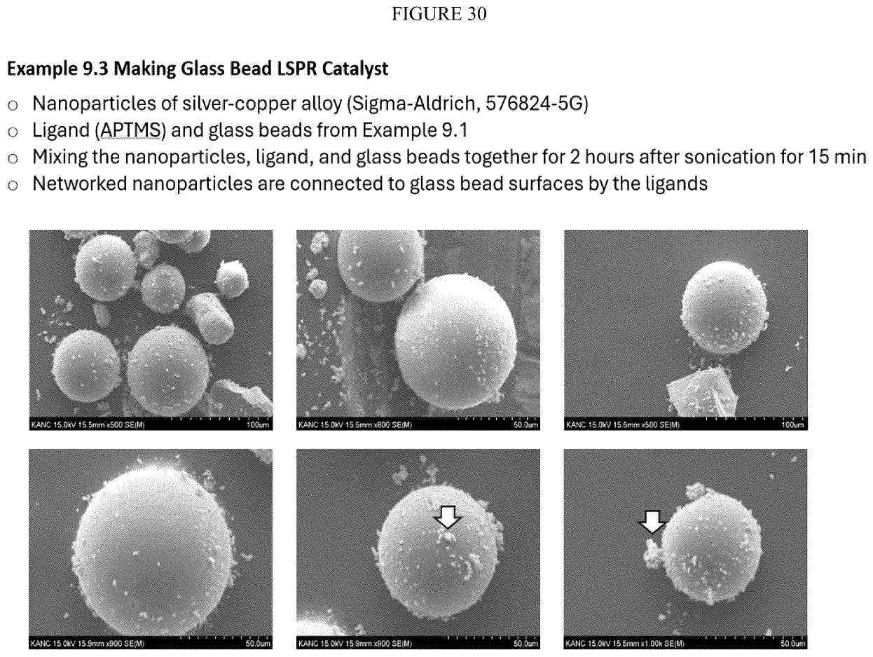

The glass beads from Example 9.1, Ag—Cu alloy nanoparticles (Sigma-Aldrich 576824-5G), and ligand (APTMS) were briefly mixed in liquid phase. Ultrasound (110 W) was applied to the liquid mixture for 2 hours at 60° C. without stirring. Networked nanoparticles over glass bead surfaces were observed. FIG. 30 includes SEM photographs of glass beads.

### Example 9.4

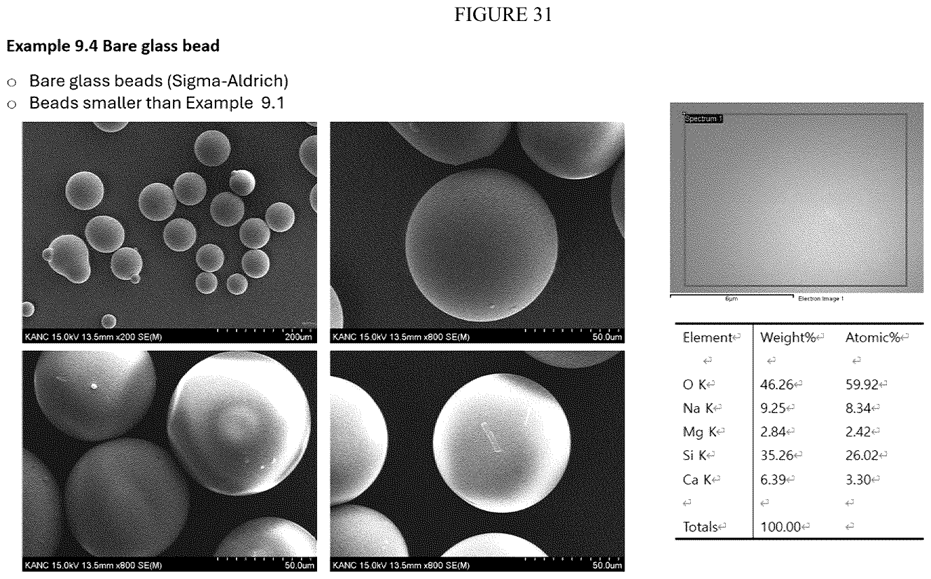

Glass beads (Sigma-Aldrich) with a diameter under 100 μm were obtained. FIG. 31 includes SEM photographs of glass beads.

### Example 9.5

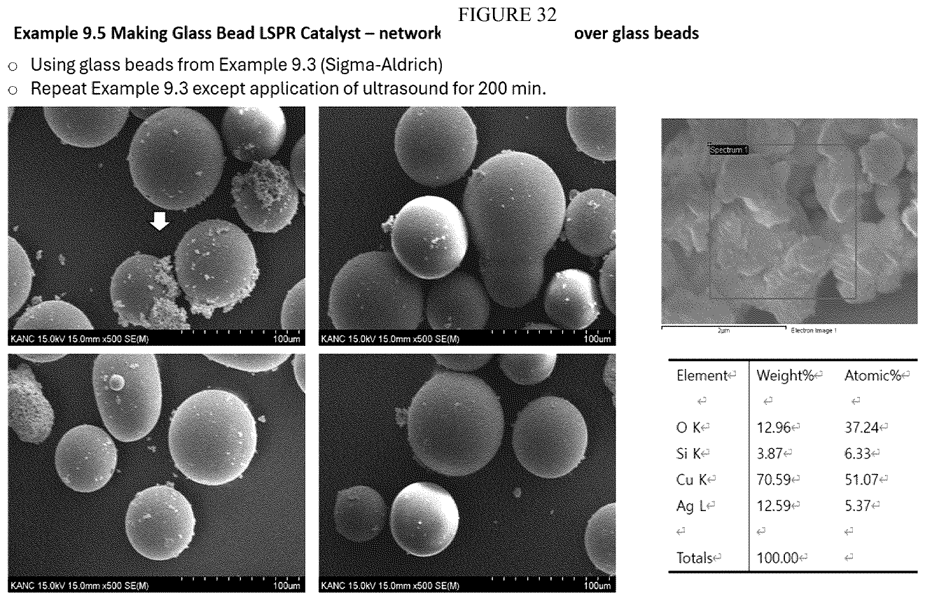

The glass beads from Example 9.4, Ag—Cu alloy nanoparticles (Sigma-Aldrich 576824-5G), and ligand (APTMS) were briefly mixed in liquid phase. Ultrasound (110 W) was applied to the liquid mixture for 200 minutes at 60° C. without stirring. Networked nanoparticles over glass bead surfaces were observed. FIG. 32 includes SEM photographs of the glass beads.

### Example 9.6

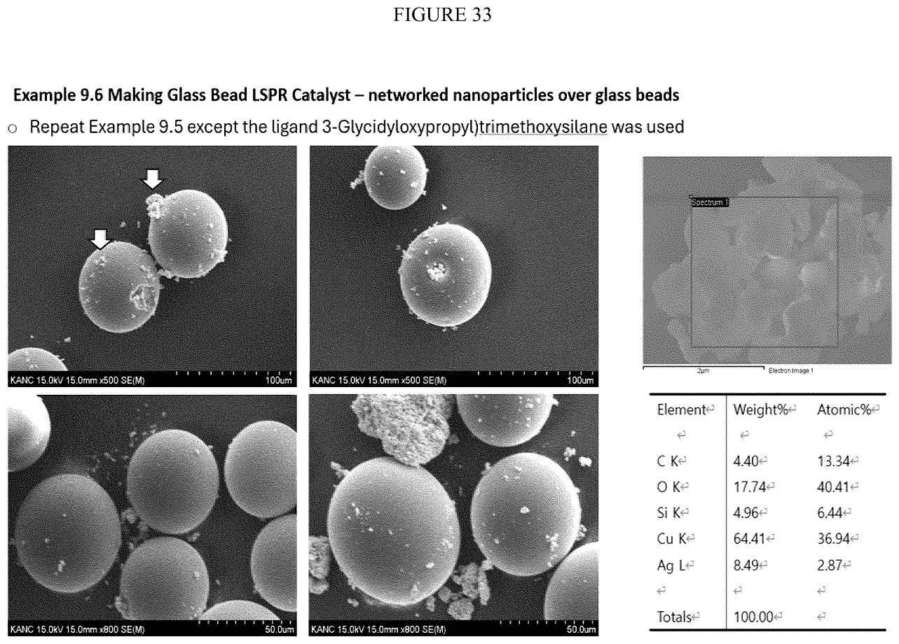

Example 9.5 was repeated except that ligand (3-Glycidyloxypropyl) trimethoxysilane was used as the ligand. FIG. 33 includes SEM photographs of the glass beads.

### Example 9.7

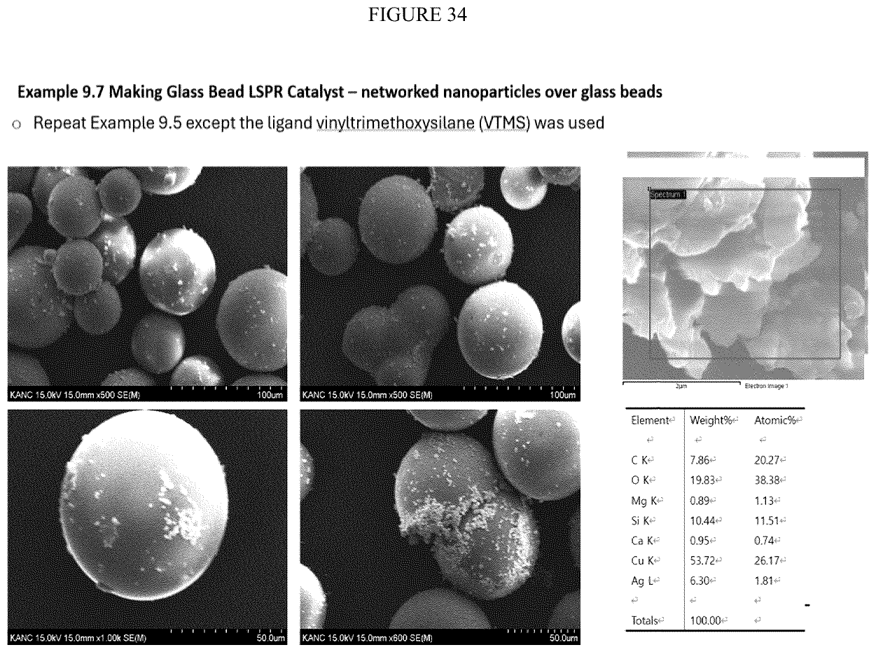

Example 9.5 was repeated except that ligand vinyltrimethoxysilane (VTMS) was used as the ligand. FIG. 34 includes SEM photographs of the glass beads.

What is claimed is:

1. A flow chemical reaction system, the system comprising:
a flow reactor comprising an elongated tube with an upstream end and a downstream end;
a reactant supply operably connected to the flow reactor and configured to supply ammonia gas into the elongated tube to flow inside the elongated tube in a flow direction from the upstream end toward the downstream end; and
glass disc catalyst devices arranged inside the elongated tube and spaced apart from each other in the flow direction;
wherein at least part of the glass disc catalyst devices individually comprises a glass disc with multiple through-holes formed therein such that the gas passes through at least part of the multiple through-holes of the individual glass disc catalyst device,
wherein at least part of the glass disc catalyst devices individually further comprises a metal nanoparticles bound to the glass disc thereof such that at least part of the metal nanoparticles are bound to surfaces of at least part of the multiple through-holes of the glass disc,
wherein the system further comprises at least one light source configured to irradiate light beams for illuminating the at least part of the glass disc catalyst devices, and
wherein the glass disc catalyst devices are arranged inside the elongated tube to allow the gas to pass through at least part of the through-holes formed therein such that the gas advances inside the elongated tube in the flow direction and passes by at least part of the metal nanoparticles that are bound to the glass discs and illuminated by at least part of the light beams, which causes surface plasmon resonance in at least part of the metal nanoparticles to facilitate ammonia cracking inside the elongated tube.

2. The system of claim 1, wherein the system is further configured to allow the gas to advance in the flow direction via gaps formed between the glass disc catalyst devices and inner surfaces of the elongated tube.

3. The system of claim 1, wherein the glass disc catalyst devices are arranged inside the elongated tube to allow the gas to pass through at least part of the through-holes formed therein such that the gas advances inside the elongated tube in the flow direction and passes by at least part of the metal nanoparticles bound to surfaces of the through-holes of the individual glass discs.

4. The system of claim 1, wherein the glass disc catalyst devices are arranged inside the elongated tube to allow the gas to pass through at least part of the through-holes formed therein such that the gas advances inside the elongated tube in the flow direction and passes by at least part of the metal nanoparticles bound to surfaces of the individual glass discs that are not of the through-holes thereof.

5. The system of claim 1, wherein at least part of the glass disc catalyst devices individually comprises a plurality of ligands fixed to the glass disc, wherein at least part of the metal nanoparticles is linked to the glass discs via at least part of the plurality of ligands.

6. The system of claim 1, wherein the glass disc has a plate-like shape comprising two generally flat surfaces facing away from each other with a thickness defined therebetween, wherein at least part of the multiple through-holes are formed in the glass disc connecting between the two generally flat surfaces, wherein the multiple through-holes comprise inner surfaces thereof other than the two generally flat surfaces, wherein at least part of the metal nanoparticles are bound to at least part of the inner surfaces such that the gas advancing inside the elongated tube to pass by at least part of the metal nanoparticles that are bound to the inner surfaces of the glass disc.

7. The system of claim 1, wherein the glass disc catalyst devices are spaced apart from each other in the flow direction with at least one spacer located between adjacent ones of the glass disc catalyst devices.

8. The system of claim 7, wherein the at least one spacer comprises a transparent cylinder inserted inside the elongated tube between two adjacent ones of the glass disc catalyst devices.

9. The system of claim 8, wherein the at least one spacer comprises one or more transparent particles attached to surfaces of the glass disc that separate two adjacent ones of the glass disc catalyst devices in the flow direction.

10. The system of claim 9, wherein the at least one spacer on each glass disc catalyst device is vertically aligned such that the gas flows in the flow direction through the multiple through-holes form on each glass disc without interruption.

11. The system of claim 1, wherein the reactant supply is connected to the upstream end of the flow reactor with an airtight adaptor or gasket, and
wherein the at least one light source comprises at least one first light source connected to the upstream end of the flow reactor with a transparent airtight seal through which the light beams are transmitted toward the upstream end.

12. The system of claim 1, wherein the at least one light source further comprises at least one second light source located outside the elongated tube for sending light beams into the flow reactor through a wall of the elongated tube such that the light beam is directed to each glass disc catalyst device with the metal nanoparticles.

13. The system of claim 1, wherein the system is configured to perform a chemical reaction of decomposition of ammonia (NH₃) for producing hydrogen (H₂).

14. The system of claim 1, wherein the at least part of the glass disc catalyst devices are configured in the system in a way that the gas passes through the individual glass disc catalyst device while the at least one light source irradiates the light beams for illuminating the at least part of the glass disc catalyst devices.

15. The system of claim 1, wherein the flow reactor is referred to as a first flow reactor, the upstream end is referred to as a first upstream end, the downstream end is referred to as a first downstream end, the at least one light source is referred to as a first light source, the flow direction is referred to as a first flow direction, the at least one catalyst device is referred to as a first catalyst device,
wherein the system further comprises:
a second flow reactor comprising a second upstream end and a second downstream end;
at least one catalyst device comprising a glass disc, a plurality of ligands, and a plurality of metal nanoparticles in the second flow reactor, wherein at least part of the metal nanoparticles is linked to the glass disc via at least part of the ligands;
a connecting adaptor connecting between the first downstream end and the second upstream end to form a fluid communication between the first flow reactor and the second flow reactor such that at least part of the reactant reaching the first downstream end flows into the second flow reactor through the second upstream end; and
a second light source configured to send light beams for illuminating the at least one catalyst device installed inside the second flow reactor;
wherein the at least one catalyst device is installed inside the second flow reactor such that the at least part of the reactant contacts the at least one catalyst device while flowing inside the second flow reactor.

16. The system of claim 15, wherein the plurality of ligands comprises a first ligand, a second ligand, and a third ligand,
wherein the first ligand comprises a first backbone, a first metal-bonding end connected to the first backbone, and a first other end connected to the first backbone, wherein the second ligand comprises a second backbone, a second metal-bonding end connected to the second backbone, and a second other end connected to the second backbone, wherein the third ligand comprises a third backbone, a third metal-bonding end connected to the third backbone, and a third other end connected to the third backbone,
wherein the plurality of metal nanoparticles comprises a first metal nanoparticle, a second metal nanoparticle, and a third metal nanoparticle, and
wherein the first metal-bonding end of the first ligand is bonded to the first metal nanoparticle, and wherein the first other end of the first ligand is bonded to the glass disc.

17. The system of claim 16, wherein the second metal-bonding end of the second ligand is bonded to the second metal nanoparticle and the second other end of the second ligand is bonded to the glass disc such that the second metal nanoparticle is linked to the glass disc via the second ligand, wherein the first ligand and the second ligand are an identical chemical entity.

18. The system of claim 16, wherein at least part of the metal nanoparticles forms an interconnected network of metal nanoparticles via at least part of the ligands, wherein at least one metal nanoparticles of the interconnected network is bonded to the glass disc via at least part of the ligands.

19. The system of claim 18, wherein the interconnected network extends horizontally along a surface of the glass disc and also vertically from the surface of the glass disc.

20. The system of claim 18, wherein the second metal-bonding end of the second ligand is bonded to the first metal nanoparticle, and the second other end of the second ligand is bonded to the second metal nanoparticle such that the second metal nanoparticle is linked to the first metal nanoparticle via the second ligand, wherein the first and second ligands are an identical chemical entity or different chemical entities.

21. The system of claim 18, wherein the third metal-bonding end of the third ligand is bonded to the second metal nanoparticle, and the third other end of the third ligand is bonded to the third metal nanoparticle such that the third metal nanoparticle is connected to the glass disc, wherein the first and third ligands are an identical chemical entity or different chemical entities.

22. The system of claim 18, wherein the second metal-bonding end of the second ligand is bonded to the first metal nanoparticle, wherein the third metal-bonding end of the third ligand is bonded to the second metal nanoparticle,
wherein the second other end of the second ligand and the third other end of the third ligand form a bonding or interact therebetween such that the first and second metal nanoparticles are interconnected via the second and third ligands,
wherein the first and second ligands are an identical chemical entity or different chemical entities, wherein the second and third ligands are an identical chemical entity or different chemical entities.

23. The system of claim 1, wherein the metal nanoparticles have an average diameter ranging between about 50 nm and about 100 nm.

24. The system of claim 1, wherein the glass disc catalyst devices comprise a plurality of ligands,
wherein at least part of the metal nanoparticles is linked to the glass disc via at least part of the ligands, and
wherein at least part of the ligands originates from at least one compound selected from the group consisting of:

| | | | |
|---|---|---|---|
| No | Name | Formula | 2D Structure |

trimethoxysilane

| | | | |
|---|---|---|---|
| 1 | (3-lodopropyl)trimethoxysilane | C6H15IO3Si | 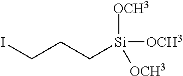 [SMILES: CO[Si](CCCI)(OC)OC] |
| 2 | (3-Chloropropyl)trimethoxysilane/CPTMS | C6H15ClO3Si | 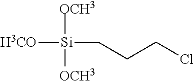 [SMILES: CO[Si](CCCCl)(OC)OC] |
| 3 | (N,N-Dimethylaminopropyl)trimethoxysilane | C8H21NO3Si | 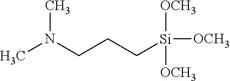 |
| 4 | (3-Aminopropyl)trimethoxysilane/APTMS | C6H17NO3Si | 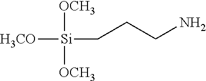 [SMILES: CO[Si](CCCN)(OC)OC] |
| 5 | (3-Mercaptopropyl)trimethoxysilane/MPS or MPTMS | C6H16O3SSi | 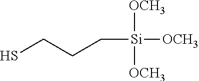 [SMILES: CO[Si](CCCS)(OC)OC] |
| 6 | [3-(2-Aminoethylamino)propyl]trimethoxysilane | C8H22N2O3Si | 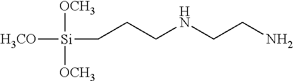 [SMILES: CO[Si](CCCNCCN)(OC)OC] |
| 7 | (3-Glycidyloxypropyl)trimethoxysilane/GPTMS | C9H20O5Si | 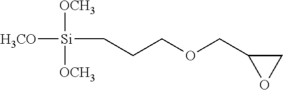 [SMILES: CO[Si](CCCOCC1CO1)(OC)OC] |
| 8 | Isooctyl trimethoxysilane | C11H26O3Si | 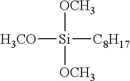 |
| 9 | (3-Bromopropyl)trimethoxysilane/BPTS | C6H15BrO3Si | 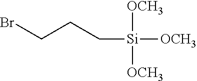 [SMILES: CO[Si](CCCBr)(OC)OC] |
| 10 | [3-(Diethylamino)propyl]trimethoxysilane | C10H25NO3Si | 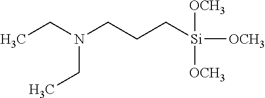 |
| 11 | (3-Glycidyl-¹³C3-oxypropyl) trimethoxysilane | ¹³C3C6H20O5Si | 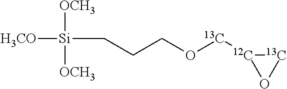 [SMILES: CO[Si](CCCO[13CH2][12CH]1[13CH2]O1)(OC)OC] |
| 12 | (3-Glycidyl-2-¹³C-oxypropyl)trimethoxysilane | ¹³CC8H20O5Si | 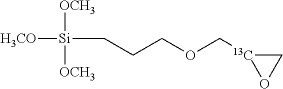 [SMILES: CO[Si](CCCOC[13CH]1CO1)(OC)OC] |
| 13 | 3-(Trimethoxysilyl)propyl acrylate | C9H18O5Si | 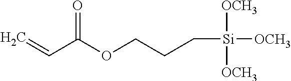 |
| 14 | Trimethoxy(2-phenylethyl)silane/TMPES | C11H18O3Si | 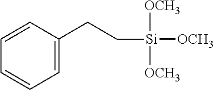 [SMILES: CO[Si](CCc1ccccc1)(OC)OC] |
| 15 | Trimethoxy(3,3,3-trifluoropropyl)silane | C6H13F3O3Si | 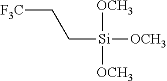 [SMILES: CO[Si](CCC(F)(F)F)(OC)OC] |
| 16 | 3-(Trimethoxysilyl)propyl methacrylate/TMSPMA | C10H20O5Si | 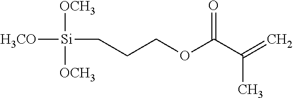 [SMILES: C=C(C)C(=O)OCCC[Si](OC)(OC)OC] |
| 17 | Trimethoxy[3-(methylamino)propyl]silane/ MAPTMS | C7H19NO3Si | 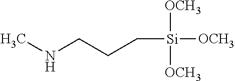 |
| 18 | N-[3-(Trimethoxysilyl)propyl]aniline/TMSPA | C12H21NO3Si | 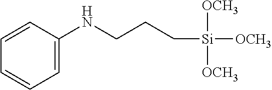 [SMILES: CO[Si](CCCNc1ccccc1)(OC)OC] |
| 19 | N-[3-(Trimethoxysilyl)propyl]ethylenediamine | C8H22N2O3Si | 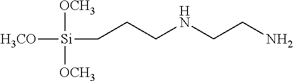 [SMILES: CO[Si](CCCNCCN)(OC)OC] |
| 20 | Trimethoxy[2-(7-oxabicyclo[4.1.0]hept-3- yl)ethyl]silane | C11H22O4Si | 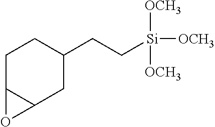 [SMILES: CO[Si](CCC1CCC2OC2C1)(OC)OC] |

Trimethoxysilyl

| | | | |
|---|---|---|---|
| 1 | Dimethyloctadecyl[3- (trimethoxysilyl)propyl]ammonium chloride solution/ DTSACI | C26H58NO3SiCl | 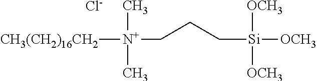 |
| 2 | 1,4-Bis(trimethoxysilyl)benzene | C12H22O6Si2 | 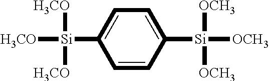 |
| 3 | 1-[3-(Trimethoxysilyl)propyl]urea | C7H18N2O4Si | 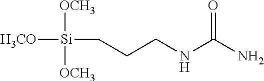 [SMILES: CO[Si](CCCNC(N)=O)(OC)OC] |
| 4 | Tris[3-(trimethoxysilyl)propyl] isocyanurate/TTPI | C21H45N3O12Si3 | 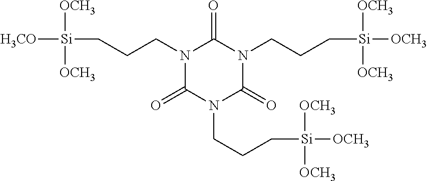 [SMILES: CO[Si](CCCn1c(=O)n(CCC[Si](OC)(OC)OC)c(=O)n(CCC[Si](OC)(OC)OC)c1=O)(OC)OC] |
| 5 | 3-(Trimethoxysilyl)propyl-N,N,N- trimethylammonium-¹⁵N chloride | C9H24CI15NO3Si | 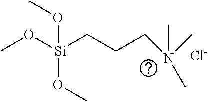 |
| 6 | Trimethoxyphenylsilane/TMPS | C9H14O3Si | 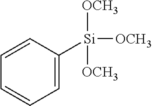 [SMILES: CO[Si](OC)(OC)c1ccccc1] |
| 7 | Vinyltrimethoxysilane/VTMS | C5H12O3Si | 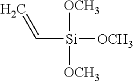 |
| 8 | 2-(Trimethylsilyloxy)ethyl methacrylate | C9H18O3Si | 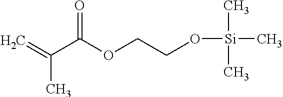 |

Triethoxysilane

| | | | |
|---|---|---|---|
| 1 | Triethoxysilane | C6H15O3Si | 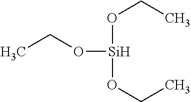 |
| 2 | (3-Chloropropyl)triethoxysilane | C9H21ClO3Si | 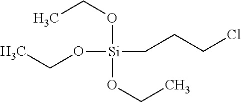 |
| 3 | (3-Mercaptopropyl)triethoxysilane/MPTS | C9H22O3SSi | 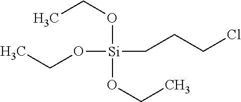 |
| 4 | (3-Aminopropyl)triethoxysilane/APTES | C9H23NO3Si | 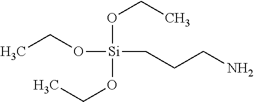 |
| 5 | (4-Chlorophenyl)triethoxysilane | C12H19ClO3Si | 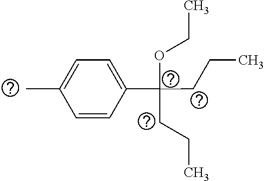 [SMILES: CCCC(CCC)(OCC)c1ccc(C)cc1] |
| 6 | Methyl-d3-triethoxysilane | CD3Si(OC2H5)3 | 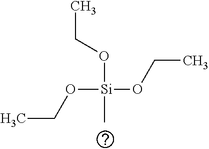 |
| 7 | (3-Glycidyloxypropyl)triethoxysilane/GPTES | C12H26O5Si | 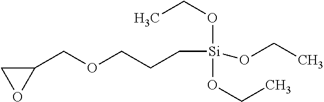 [SMILES: CCO[Si](CCCOCC1CO1)(OCC)OCC] |
| 8 | (1-NAPHTHYL)TRIETHOXYSILANE | C16H22O3Si | 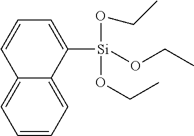 [SMILES: CCO[Si](OCC)(OCC)c1cccc2ccccc12] |
| 9 | 3-[Bis(2-hydroxyethyl)amino]propyl-triethoxysilane solution | C13H31NO5Si | 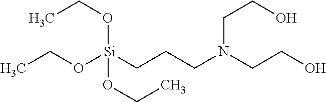 [SMILES: CCO[Si](CCCN(CCO)CCO)(OCC)OCC] |
| 10 | 3-(Triethoxysilyl)propionitrile/TESPN | C9H19NO3Si | 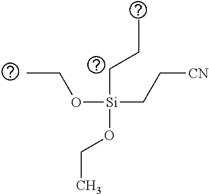 |
| 11 | Bis[3-(triethoxysilyl)propyl] tetrasulfide/TESPTS | C18H42O6S4Si2 | 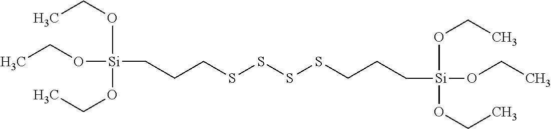 [SMILES: CCO[Si](CCCSSSSCCC[Si](OCC)(OCC)OCC)(OCC)OCC] |
| 12 | 3-(Triethoxysilyl)propyl isocyanate/TEPI | C10H21NO4Si | 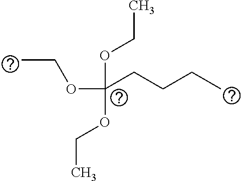 |
| 13 | 1,2-Bis(triethoxysilyl)ethane/BTESE | C14H34O6Si2 | 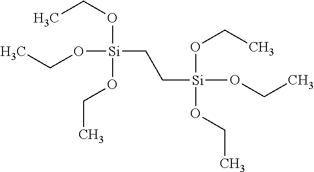 [SMILES: CCO[Si](CC[Si](OCC)(OCC)OCC)(OCC)OCC] |

Triethoxysilyl

| | | | |
|---|---|---|---|
| 1 | 4,4′-Bis(triethoxysilyl)-1,1'-biphenyl | C24H38O6Si2 | 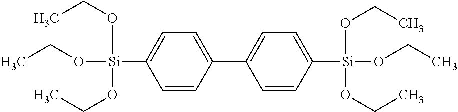 [SMILES: CCO[Si](OCC)(OCC)c1ccc(-c2ccc([Si](OCC)(OCC)OCC)cc2)cc1] |
| 2 | 1,4-Bis(triethoxysilyl)benzene | C18H34O6Si2 | 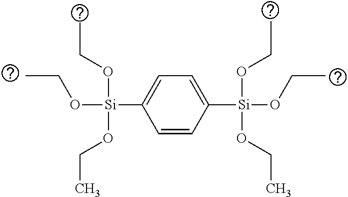 [SMILES: CCO[Si](OCC)(OCC)c1ccc([Si](OCC)(OCC)OCC)cc1] |
| 3 | Triethoxyvinylsilane/TEVS | C8H18O3Si | 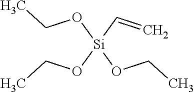 |
| 4 | 3-Cyanopropyltriethoxysilane/CPTS | C10H21NO3Si | 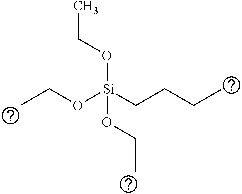 |
| 5 | Dodecyltriethoxysilane/DTES | C18H40O3Si | 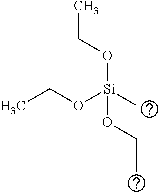 |
| 6 | Triethoxy-3-(2-imidazolin-1-yl)propylsilane | C12H26N2O3Si | 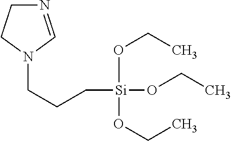 [SMILES: CCO[Si](CCCN1C=NCC1)(OCC)OCC] |

Phosphonic acid and Phosphonate

| | | | |
|---|---|---|---|
| 1 | Diethyl (1-cyanoethyl)phosphonate | C7H14NO3P | 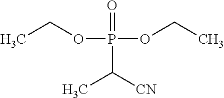 |
| 2 | Diethyl (bromodifluoromethyl)phosphonate | C5H10BrF2O3P | 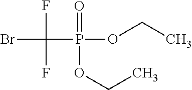 |
| 3 | Diethyl (hydroxymethyl)phosphonate | C5H13O4P | 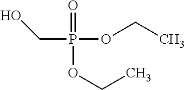 |
| 4 | Diethyl (phenylthiomethyl-¹³C)phosphonate | ¹³CC10H17O3PS | 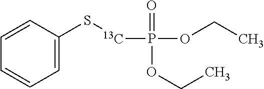 [SMILES: CCOP(=O)([13CH2]Sc1ccccc1)OCC] |
| 5 | Diethyl (methylthiomethyl)phosphonate | C6H15O3PS | 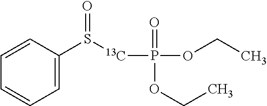 [SMILES: CCOP(=O)([13CH2]S(=O)c1ccccc1)OCC] |
| 6 | Diethyl (difluoromethyl)phosphonate | C5H11F2O3P | 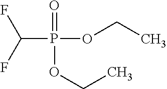 |
| 7 | Diethyl(3-bromopropyl)phosphonate | C7H16BrO3P | 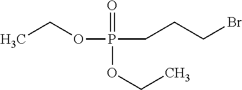 |
| 8 | Diethyl (2-oxopropyl)phosphonate | C7H15O4P | 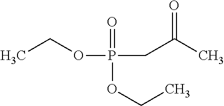 |
| 9 | Diethyl (phenylsulfinylmethyl-¹³C)phosphonate | ¹³CC10H17O4PS | 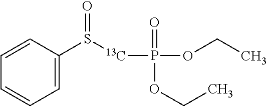 [SMILES: CCOP(=O)([13CH2]S(=O)c1ccccc1)OCC] |
| 10 | Dimethyl (1-diazo-2-oxopropyl)phosphonate solution | C5H9N2O4P | 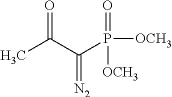 |
| 11 | (Aminomethyl)phosphonic acid | CH6NO3P | 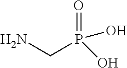 |
| 12 | DIPHENYL (TRIPHENYLPHOSPHORANYLIDENEMETHYL)PHOSPHO- NATE | C31H26O3P2 | 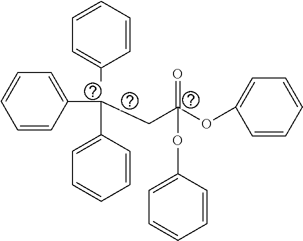 |
| 13 | Dimethyl [2-oxo-2-(cyclohexyl- d11)ethyl]phosphonate | C10D11H8O4P | 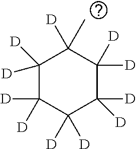 [SMILES: [2H]C1([2H])C([2H])([2H])C([2H])([2H])C([2H])(C)C([2H])([2H])C1([2H])[2H]] |
| 14 | Methylenebis(phosphonic dichloride) | CH2Cl4O2P2 | 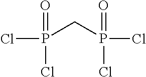 |
| 15 | DIBENZYL (ALPHA-ANILINOBENZYL)-PHOSPHONATE | C27H26NO3P | 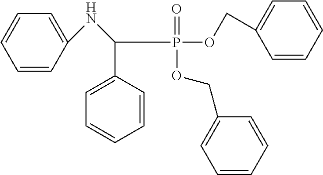 [SMILES: O=P(OCc1ccccc1)(OCc1ccccc1)C(Nc1ccccc1)c1ccccc1] |
| 16 | DIPHENYL(ALPHA-ANILINOBENZYL)PHOSPHONATE | C25H22NO3P | 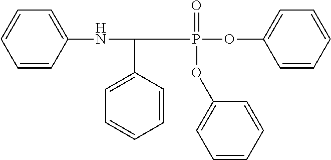 [SMILES: O=P(Oc1ccccc1)(Oc1ccccc1)C(Nc1ccccc1)c1ccccc1] |
| 17 | DIETHYL (METHOXY(METHOXYCARBONYL)METHYL)PHOSPHO- NATE | C8H17O6P | 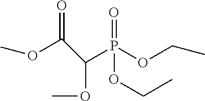 |
| 18 | DIISOBUTYL (N,N- DIETHYLCARBAMOYL)PHOSPHONATE | C13H28NO4P | 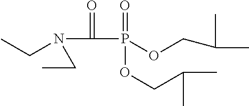 [SMILES: CCN(CC)C(=O)P(=O)(OCC(C)C)OCC(C)C] |
| 19 | DIISOPROPYL (N,N- DIBENZYLCARBAMOYLMETHYL)PHOSPHONATE | C22H30NO4P | 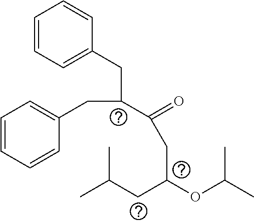 [SMILES: CC(C)CC(CC(=O)C(Cc1ccccc1)Cc1ccccc1)OC(C)C] |
| 20 | DIISOPROPYL (N,N- DIETHYLCARBAMOYL)PHOSPHONATE | C11H24NO4P | 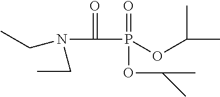 [SMILES: CCN(CC)C(=O)P(=O)(OC(C)C)OC(C)C] |
| 21 | DIOCTYL (N,N-DIETHYLCARBAMOYL)PHOSPHONATE | C21H44NO4P | 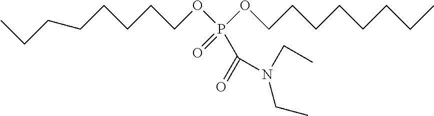 [SMILES: CCCCCCCCOP(=O)(OCCCCCCCC)C(=O)N(CC)CC] |
| 22 | DIOCTYL (N,N- DIMETHYLCARBAMOYLMETHYL)PHOSPHONATE | C20H42NO4P | 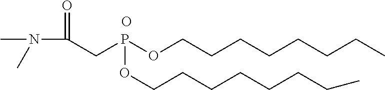 |
| 23 | Diethyl [difluoro(trimethylsilyl)methyl]phosphonate | C8H19F2O3PSi | 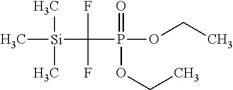 |
| 24 | Diethyl (2-oxo-2-phenylethyl)phosphonate | C12H17O4P | 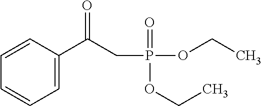 [SMILES: CCOP(=O)(CC(=O)c1ccccc1)OCC] |
| 25 | DIETHYL (3-METHOXYCARBONYL-2- PROPENYL)PHOSPHONATE | C9H17O5P | 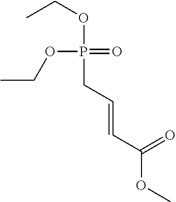 |
| 26 | DIPHENYL (ALPHA-ANILINO-2- PYRIDYLMETHYL)PHOSPHONATE | C24H21N2O3P | 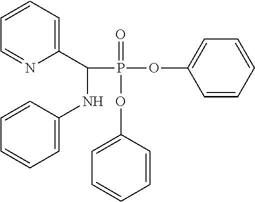 [SMILES: O=P(Oc1ccccc1)(Oc1ccccc1)C(Nc1ccccc1)c1ccccn1] |
| 27 | Phosphonic acid-1803 | H318O3P | 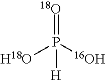 |
| 28 | BIS(2-ETHYLHEXYL) (N,N- DIISOPROPYLCARBAMOYLMETHYL)PHOSPHONATE | C24H50NO4P | 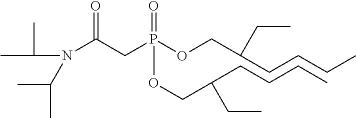 [SMILES: CCCCC(CC)COP(=O)(CC(=O)N(C(C)C)C(C)C)OCC(CC)CCCC] |
| 29 | BIS(2,2,4-TRIMETHYLPENTYL) (N,N- DIETHYLCARBAMOYLMETHYL)PHOSPHONATE | C22H46NO4P | 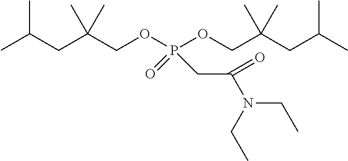 [SMILES: CCN(CC)C(=O)CP(=O)(OCC(C)(C)CC(C)C)OCC(C)(C)CC(C)C] |
| 30 | DI-SEC-BUTYL (N,N- DIETHYLCARBAMOYLMETHYL)PHOSPHONATE | C14H30NO4P | 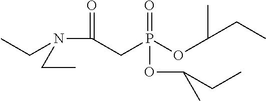 [SMILES: CCC(C)OP(=O)(CC(=O)N(CC)CC)OC(C)CC] |
| 31 | DIBUTYL (1-(N,N- DIETHYLCARBAMOYL)ETHYL)PHOSPHONATE | C15H32NO4P | 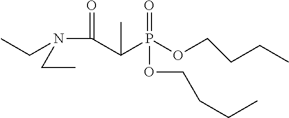 [SMILES: CCCCOP(=O)(OCCCC)C(C)C(=O)N(CC)CC] |
| 32 | (12-Phosphonododecyl)phosphonic acid | C12H28O6P2 | 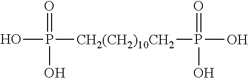 |
| 33 | (3-Bromopropyl)phosphonic acid | C3H8BrO3P | 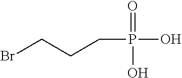 |
| 34 | 1,4-Phenylenebis(phosphonic acid) | C6H8O6P2 | 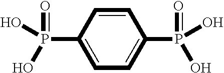 |
| 35 | Methyl phosphonic acid-¹³C | ¹³CH5O3P | 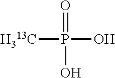 |
| 36 | (DICHLOROMETHYL)PHOSPHONIC DICHLORIDE | CHCl4OP | 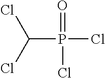 |
| 37 | Ethyl phosphonic acid-(methyl-¹³C) | C13CH7O3P | 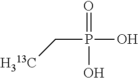 |
| 38 | (1-AMINOPROPYL)PHOSPHONIC ACID | C3H10NO3P | 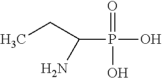 |
| 39 | (2-ISOPROPYLPHENYL)PHOSPHONIC ACID | C9H13O3P | 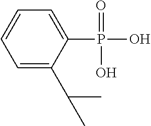 |
| 40 | (2-METHOXYPHENYL)PHOSPHONIC ACID | C7H9O4P | 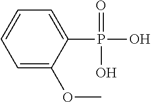 |
| 41 | (2,3-XYLYL)PHOSPHONIC ACID | C8H11O3P | 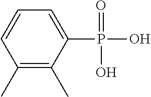 |
| 42 | (2,4-XYLYL)PHOSPHONIC ACID | C8H11O3P | 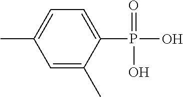 |
| 43 | (2,5-XYLYL)PHOSPHONIC ACID | C8H11O3P | 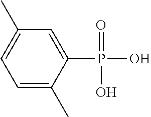 |
| 44 | (3-NITROPHENYL)PHOSPHONIC ACID | C6H6NO5P | 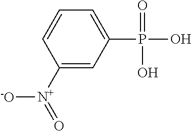 |
| 45 | (3,5-XYLYL)PHOSPHONIC ACID | C8H11O3P | 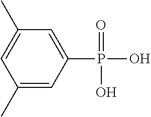 |
| 46 | (4-BROMOPHENYL)PHOSPHONIC ACID | C6H6BrO3P | 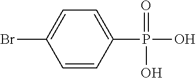 [SMILES: O=P(O)(O)c1ccc(Br)cc1] |
| 47 | (4-CHLOROPHENYL)PHOSPHONIC ACID | C6H6ClO3P | 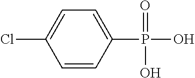 [SMILES: O=P(O)(O)c1ccc(Cl)cc1] |
| 48 | (4-ETHYLPHENYL)PHOSPHONIC ACID | C8H11O3P | 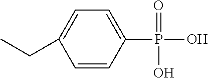 |
| 49 | (M-TOLYL)PHOSPHONIC ACID | C7H9O3P | 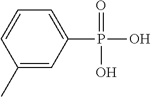 |
| 50 | [1,1′-Biphenyl]-4,4′-diylbis(phosphonic acid) | C12H12O6P2 | 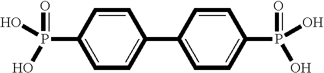 |
| 51 | Dibenzyl phosphite | C14H14O3P+ | 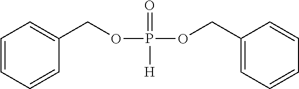 [SMILES: O=[PH](OCc1ccccc1)OCc1ccccc1] |
| 52 | (1R)-(+)-(1-Amino-2-methylpropyl)phosphonic acid | C4H12NO3P | 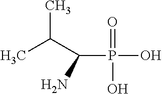 |
| 53 | 11-(2-Bromoisobutyrate)-undecyl-1-phosphonic acid | C15H30BrO5P | 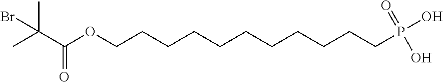 [SMILES: CC(C)(Br)C(=O)OCCCCCCCCCCCP(=O)(O)O] |
| 54 | N,N′-2-methylpiperazinebis(methylene phosphonic acid) | C7H18N2O6P2 | 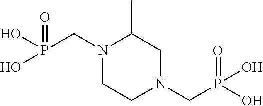 [SMILES: CC1CN(CP(=O)(O)O)CCN1CP(=O)(O)O] |
| 55 | (NICOTINAMIDOMETHYL)PHOSPHONIC ACID, DISODIUM SALT | C7H7N2Na2O4P | 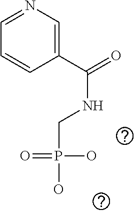 [SMILES: O=C(NCP(=O)(O)O)c1cccnc1] |
| 56 | (NICOTINAMIDOMETHYL)PHOSPHONIC ACID, IRON(II) SALT | C14H16FeN4O8P2 | 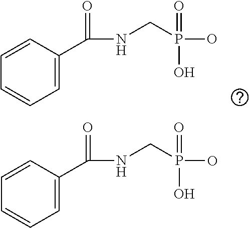 [SMILES: O=C(NCP(=O)(O)O)c1ccccc1 ; O=C(NCP(=O)(O)O)c1ccccc1] |
| 57 | (AMINOMETHYL)-PHOSPHONIC ACID, IRON (II) SALT | C2H10FeN2O6P2 | 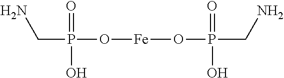 |
| 58 | Di-tert-butyl phosphite | C8H19O3P | 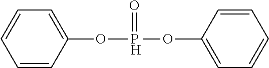 |
| 59 | Diphenyl phosphite | (C6H5O)2P(O)H | 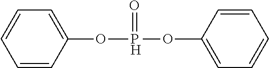 |
| 60 | (1-AMINO-1-PHOSPHONO-OCTYL)-PHOSPHONIC ACID | C8H21NO6P2 | 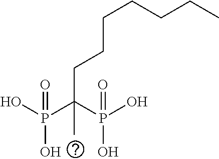 [SMILES: CCCCCCCC(C)(P(=O)(O)O)P(=O)(O)O] |
| 61 | Phenylphosphonic acid | C6H5P(O)(OH)2 | 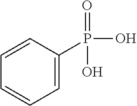 |
| 62 | 4-Aminobutylphosphonic acid | C4H12NO3P | 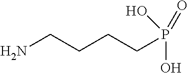 |
| 63 | 2-Aminoethylphosphonic acid/2-AEP | H2NCH2CH2P(O)(OH)2 | 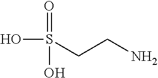 |
| 64 | 3-Aminopropylphosphonic acid | H2N(CH2)3P(O)(OH)2 | 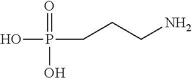 |
| 65 | 4-Aminobenzylphosphonic acid | C7H10NO3P | 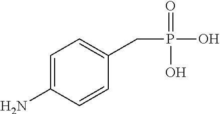 [SMILES: Nc1ccc(CP(=O)(O)O)cc1] |
| 66 | 4-Methylumbelliferyl phosphate | C10H906P | 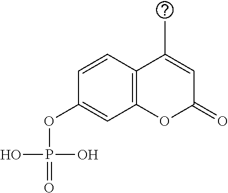 [SMILES: Cc1cc(=O)oc2cc(OP(=O)(O)O)ccc12] |
| 67 | 12-Mercaptododecylphosphonic acid | C12H27O3PS | 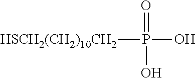 |
| 68 | 11-Phosphonoundecyl acrylate | C14H27O5P | 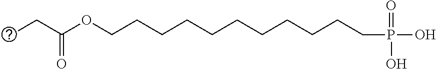 [SMILES: CCC(=O)OCCCCCCCCCCCP(=O)(O)O] |
| 69 | 11-Hydroxyundecylphosphonic acid | C11H25O4P | 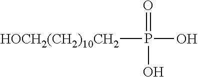 |
| 70 | 12-Pentafluorophenoxydodecylphosphonic acid | C18H26F5O4P | 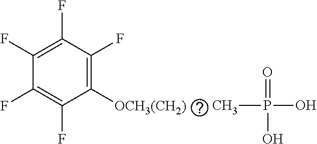 |
| 71 | Adefovir/PMEA | C8H12N5O4P | 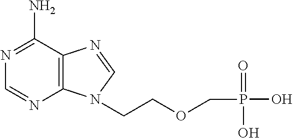 [SMILES: Nc1ncnc2c1ncn2CCOCP(=O)(O)O] |

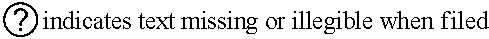

25. A method of running a chemical reaction, the method comprises:
providing the flow chemical reaction system of claim 1;
supplying ammonia (NH₃) gas from the reactant supply into the flow reactor through the upstream end such that the ammonia gas flows inside the flow reactor in the flow direction from the upstream end toward the downstream end; and
sending light beams from the light source into the flow reactor such that the light beams illuminate the at least one catalyst device inside the flow reactor,
wherein illuminating at least one catalyst devices causes surface plasmon resonance with at least part of the metal nanoparticles, which facilitates decomposing ammonia molecules for production of hydrogen (H₂).

26. The method of claim 25, further comprising heating the flow reactor for running the chemical reaction within a temperature range from about 200° and about 500°.
